(19) United States
(12) Patent Application Publication
(10) Pub. No.: US 2021/0020320 A1
(43) Pub. Date: Jan. 21, 2021

(54) System, Apparatus, Method and Energy Product-by-Process for Resonantly-Catalyzing Nuclear Fusion Energy Release, and the Underlying Scientific Foundation

(71) Applicant: Jay R. Yablon, Schenectady, NY (US)

(72) Inventor: Jay R. Yablon, Schenectady, NY (US)

(21) Appl. No.: 16/888,940

(22) Filed: Jun. 1, 2020

Related U.S. Application Data
(63) Continuation of application No. 14/655,879, filed on Jun. 26, 2015, now abandoned.
(60) Provisional application No. 61/747,488, filed on Dec. 31, 2012.

(51) Int. Cl. G21B 1/11; G21C 3/56; G21B 3/00

(52) U.S. Cl. CPC G21B 1/11; Y02E 30/10; G21B 3/00; G21C 3/56

(57) ABSTRACT

A system and related apparatus, method and energy product-by-process for resonantly-catalyzing the release of nuclear fusion energy, comprising: a nuclear fuel; a high-frequency gamma radiation source producing gamma radiation proximate at least one of the resonant frequencies corresponding to mᵤ, m_{d}, \sqrt{mᵤm_{d}}, (mᵤ+m_{d})/2, mᵤ/(2π)^{3/2}, m_{d}/(2π)^{3/2}, \sqrt{mᵤm_{d}}/(2π)^{3/2}, integer harmonic multiples of said resonant frequencies, and sums of said resonant frequencies and said integer harmonic multiples, wherein mᵤ is the current rest mass of the up quark and m_{d} is the current rest mass of the down quark; and said gamma radiation source configured in relation to said nuclear fuel so as to subject said nuclear fuel to said gamma radiation.

### CROSS REFERENCE TO RELATED APPLICATIONS AND INFORMATION DISCLOSURE OF RELATED PUBLICATIONS

This application is a continuation-in-part of pending application U.S. Ser. No. 14/655,879 filed Jun. 26, 2015. Said U.S. Ser. No. 14/655,879 is a national stage application of expired application PCT/US13/78409 filed Dec. 31, 2013. Said PCT/US13/78409 claims benefit of expired provisional application U.S. 61/747,488 filed Dec. 31, 2012. This provisional application 61/747,488 was later published in preprint form through several revisions at [15], and then by a peer-reviewed journal at [16]. U.S. 61/747,488 as well as these documents [15] and [16] included scientific findings regarding the binding and fusion energies of the ²H, ³H, ³He and ⁴He nuclides, and technological disclosures of how so-called “resonant fusion” discovered and disclosed by applicant in U.S. 61/747,488 can be used to catalyze the ₁¹H+₁¹H→₁²H+e⁺+ν+Energy, ₁²H+₁¹H→₂³He+Energy and ₂³He+₂³He→₂⁴He+₁¹H+₁¹H+Energy nuclear fusion reactions which are the component reactions of the solar fusion cycle. These same findings were later summarized in consolidated form in [17].

### BACKGROUND OF THE INVENTION

In two subsequent preprints applicant also developed scientific findings regarding binding energies and fusion reactions for a number of heavier nuclides. In [18], the scientific findings of U.S. 61/747,488 were expanded to encompass ⁶Li, ⁷Li, ⁷Be and ⁸Be, and in [19] these scientific findings were further expanded to encompass ¹⁰B, ⁹Be, ¹⁰Be, ¹¹B, ¹¹C, ¹²C and ¹⁴N. This application incorporates the scientific findings of [18] and [19], and then for the first time, applies the technological disclosures of applicant's “resonant fusion” technology to specific fusion reactions involving all of these heavier nuclides ⁶Li, ⁷Li, ⁷Be, ⁸Be, ¹⁰B, ⁹Be, ¹⁰Be, ¹¹B, ¹¹C, ¹²C and ¹⁴N.

All papers referenced in the reference list following section 14, are hereby incorporated by reference.

1. Introduction: Summary Review of the Thesis that Baryons are Yang-Mills Magnetic Monopoles with Binding Energies Based on their Current Quark Masses

In an earlier paper [1], and in a more recent preprint [26] refining and expanding [1], the author developed the thesis that magnetic monopole densities which come into existence in a non-Abelian Yang-Mills gauge theory of non-commuting vector gauge boson fields G^{μ} are synonymous with baryon densities. That is, baryons, including the protons and neutrons which form the vast preponderance of matter in the universe, are Yang-Mills magnetic monopoles. Conversely, magnetic monopoles, long pursued since the time of Maxwell, have always been hiding in plain sight, in Yang-Mills incarnation, as baryons, and especially, as protons and neutrons.

Maxwell's equations themselves provide the theoretical foundation for this thesis, because if one starts with the classical electric charge and magnetic monopole field equations (respectively, (2.1) and (2.2) of [1]):

J^{ν}=∂_{μ}F^{μν}=∂_{μ}D^{[μ}G^{ν]}=(g^{μν}∂_{σ}D^{σ}−∂^{μ}D^{ν})G_{μ} (1.1)

P^{σμν}=∂^{σ}F^{μν}+∂^{μ}F^{νσ}+∂^{ν}F^{σμ}, (1.2)

(D^{μ}≡∂^{μ}−iG^{μ}) and combines the magnetic charge Equation (1.2) with a Yang-Mills (non-Abelian) field strength tensor F^{μν} which, like G^{μ} is an N×N matrix for a simple gauge group SU(N) ((2.3) of [1]):

F^{μν}=∂^{μ}G^{ν}−∂^{ν}G^{μ}−i[G^{μ},G^{ν}]=D^{μ}G^{ν}−D^{ν}G^{μ}=D^{[μ}G^{ν]} (1.3)

one immediately comes upon the non-vanishing magnetic monopole ((2.4) of [1]):

P^{σμν}=−i(∂^{σ}[G^{μ},G^{ν}]+∂^{μ}[G^{ν},G^{σ}]+∂^{ν}[G^{σ},G^{μ}]). (1.4)

The question then becomes whether such magnetic monopoles (1.4) actually do exist in the material universe, and if so, in what form. The thesis developed in [1] is not only that these magnetic monopoles do exist, but that they permeate the material universe in the form of baryons, especially as the protons and neutrons observed everywhere and anywhere that matter exists.

Of course, t'Hooft [2] and Polyakov [3] realized several decades ago that non-Abelian gauge theories lead to non-vanishing magnetic monopoles. But their monopoles have very high energies which make them not suitable for being baryons such as protons and neutrons. Following t'Hooft, the author in [1] does make use of the t'Hooft monopole Lagrangian from (2.1) of [2] to calculate the energies of these magnetic monopoles (1.4). But whereas t'Hooft introduces an ansatz about the radial behavior of the gauge bosons G^{μ}, the author instead makes use of a Gaussian ansatz borrowed from Equation (14) of Ohanian's [4] for the radial behavior of fermions. Moreover, the fermions for which this ansatz is employed enter on the very solid foundation of taking the inverse G_{ν}≡I_{σν}J^{σ} of Maxell's charge Equation (1.1) (essentially calculating the configuration space inverse (g^{μν}∂_{σ}D^{σ}−∂^{μ}D^{ν})⁻¹), and then combining this with the relationship J^{μ}=ψ̅γ^{μ}ψ that emerges from satisfying the charge conservation (continuity) equation ∂_{μ}J^{μ}=0 in Dirac theory. Specifically, it was found that in the low-perturbation limit, magnetic monopoles (1.4) can be re-expressed as a three-fermion system ((3.12) of [1]):

$${P}^{σμ v} = - 2 ( {\partial }^{σ} \frac{{\overline{ψ}}_{( 1 )} {σ}^{{μ}_{⋁} v} {ψ}_{( 1 )}}{“ {ρ}_{( 1 )} - {m}_{( 1 )} ”} + {\partial }^{μ} \frac{{\overline{ψ}}_{( 2 )} {σ}^{{μ}_{⋁} v} {ψ}_{( 2 )}}{“ {ρ}_{( 2 )} - {m}_{( 2 )} ”} + {\partial }^{v} \frac{{\overline{ψ}}_{( 3 )} {σ}^{{μ}_{⋁} v} {ψ}_{( 3 )}}{“ {ρ}_{( 3 )} - {m}_{( 3 )} ”} ) . \qquad ( 1.5 )$$

Above, ψ₍ᵢ₎; i=1, 2, 3 are three distinct Dirac spinor wavefunctions which emerge following three distinct substitutions of G_{ν}=I_{σν}J^{σ}=I_{σν}ψ̅γ^{σ}ψ—which captures the inverse of Maxwell's charge Equation (1.1) combined with Dirac theory—into the (1.4) magnetic monopole which utilizes the Yang-Mills field strength (1.3) in combination with Maxwell's magnetic monopole Equation (1.2). The detailed derivation of (1.5) from (1.4) also makes use of Sections 6.2, 6.14 and 5.5 of [5] pertaining to Compton scattering and the fermion completeness relation, and carefully accounts for mass degrees of freedom as between fermions and bosons. The quoted denominators “ [symbol] ₍ᵢ₎−m_{(i)” and “quasi commutators”}

$${σ}^{{μ}_{⋁} v} ≡ \frac{i}{2} [ {γ}_{⋁}^{u} {γ}^{v} ]$$

in the above make use of a compact notation developed and explained in Section 3 of [1], see specifically (3.9) and (3.10) therein.

Then, via Fermi-Dirac Exclusion, the author employed the QCD color group SU(3)_{C} to require that each of the three ψ₍ᵢ₎ be SU(3)_{C} vectors in distinct quantum color eigenstates R, G, B, which then leads in (5.5) of [1] to a magnetic monopole:

$$Tr {P}^{σμ v} = - 2 ( \frac{{\overline{ψ}}_{R} {σ}^{{μ}_{⋁} v} {ψ}_{R}}{“ {ρ}_{R} - {m}_{R} ”} + {\partial }^{μ} \frac{{\overline{ψ}}_{G} {σ}^{{v}_{⋁} σ} {ψ}_{G}}{“ {ρ}_{G} - {m}_{G} ”} + {\partial }^{v} \frac{{\overline{ψ}}_{B} {σ}^{{σ}_{⋁} μ} {ψ}_{B}}{“ {ρ}_{B} - {m}_{B} ”} ) . \qquad ( 1.6 )$$

This is similar to (1.5) but for the emergence of the trace. Associating each color with the spacetime index in the related ∂^{σ} operator, i.e., σ˜R, μ˜G and ν˜B, and keeping in mind that Tr P^{σμν} is antisymmetric in all spacetime indexes, we express this antisymmetry with wedge products as σ\hat{ }μ\hat{ }ν˜R\hat{ }G\hat{ }B. So the natural antisymmetry of a magnetic monopole P^{σμν} leads straight to the required antisymmetric color singlet wavefunction R[G,B]+G[B,R]+B[R,G] for a baryon. Indeed, in hindsight, this antisymmetry together with three vector indexes to accommodate three vector current densities and the three additive terms in the P^{σμν} of (1.2) should have been a tip-off that magnetic monopoles would naturally make good baryons. Further, upon integration over a closed surface via Gauss'/Stokes' theorem, magnetic monopole (1.6) is shown to emit and absorb color singlets with the symmetric color wavefunction R̅R+G̅G+B̅B expected of a meson. And, in Section 1 of [1], it was shown how magnetic monopoles naturally contain their gauge fields in non-Abelian gauge theory via the differential forms relationship dd=0 for precisely the same reasons rooted in spacetime geometry that magnetic monopoles do not exist at all in Abelian gauge theory. Thus, QCD itself deductively emerges from the thesis that baryons are Yang-Mills magnetic monopoles, and we began to associate monopole (1.6) with a baryon.

It was then shown in Sections 6 through 8 of [1] that these SU(3) monopoles may be made topologically stable by symmetry breaking from larger SU(4) gauge groups which yield the baryon and electric charge quantum numbers of a proton and neutron. Specifically, the topological stability of these magnetic monopoles was established in Sections 6 and 8 of [1] based on Cheng and Li [6] at 472-473 and Weinberg [7] at 442. The proton and neutron are developed as particular types of magnetic monopole in Section 7 of [1] making use of SU(4) gauge groups for baryon minus lepton number B-L based on Volovok's [8], Section 12.2.2. The spontaneous symmetry breaking of these SU(4) gauge groups is then fashioned on Georgi-Glashow's SU(5) GUT model [9] reviewed in detail in Section 8 of [1].

By then employing the earlier-referenced “Gaussian ansatz” from Ohanian's [4], namely ((9.9) of [1]):

$$ψ ( r ) = u ( p ) {( {πλ}^{2} )}^{- \frac{3}{4}} exp ( - \frac{1}{2} \frac{{( r - {r}_{0} )}^{2}}{{λ}^{2}} ) \qquad ( 1.7 )$$

for the radial behavior of the fermion wavefunctions, together with the t'Hooft monopole Lagrangian from (2.1) of [2] (see (9.2) of [1]) it became possible to analytically calculate the energies of these Yang-Mills magnetic monopoles (1.6) following their development into topologically stable protons and neutrons.

Specifically, in Sections 11 and 12 of [1], the author used the pure gauge field terms [symbol] _{gauge} of the t'Hooft monopole Lagrangian to specify the energy of the Yang-Mills magnetic monopoles, exclusive of the vacuum Φ, via (11.7) of [1]:

E=−∫∫∫ [symbol] _{gauge}d³x=½Tr∫∫∫F_{μν}F^{μν}d³x. (1.8)

We then made use in (1.8) of field strength tensors for protons and neutrons developed via Gauss'/Stokes' theorem from (1.6) in (11.3) and (11.4) of [1], respectively:

$$\begin{matrix}Tr {F}_{P}^{μ v} = - i ( \frac{{\overline{ψ}}_{d} [ {γ}_{⋁}^{μ} {γ}^{v} ] {ψ}_{d}}{“ {ρ}_{d} - {m}_{d} ”} + 2 \frac{{\overline{ψ}}_{u} [ {γ}_{⋁}^{μ} {γ}^{v} ] {ψ}_{u}}{“ {ρ}_{u} - {m}_{u} ”} ) & ( 1.9 ) \\ Tr {F}_{N}^{μ v} = - i ( \frac{{\overline{ψ}}_{u} [ {γ}_{⋁}^{μ} {γ}^{v} ] {ψ}_{u}}{“ {ρ}_{u} - {m}_{u} ”} + 2 \frac{{\overline{ψ}}_{d} [ {γ}_{⋁}^{μ} {γ}^{v} ] {ψ}_{d}}{“ {ρ}_{d} - {m}_{d} ”} ) & ( 1.10 )\end{matrix}$$

where ψᵤ and ψ_{d} are Dirac wavefunctions for up and down quarks, to deduce three relationships which yielded remarkable concurrence with empirical data.

First, we found in (11.22) of [1] that the electron mass is related to up and down quark masses according to:

$${m}_{e} = 0.510998928 MeV = 3 ( {m}_{d} - {m}_{u} ) \text{/} {( 2 π )}^{\frac{3}{2}} , \qquad ( 1.11 )$$

where the divisor

$${( 2 π )}^{\frac{3}{2}}$$

results as a natural consequence of the three-dimensional integration (1.8) when the Gaussian ansatz for fermions is specified as in (1.7), and where the wavelengths in (1.7) are taken to be related to the quark masses via the de Broglie relation λ=ℏ/mc.

Second and third, we found in (12.12) and (12.13) of [1] that if one postulates the current mass of the up quark to be equal to the deuteron (²H nucleus) binding energy based on 1) empirical concurrence within experimental errors and 2) regarding nucleons to be resonant cavities with binding energies determined in relation to their up and down current quark masses, then the proton and neutron each possess respective intrinsic, latent binding energies B (i.e., energies intrinsically available for nuclear binding):

$$\begin{matrix}{B}_{P} = 2 {m}_{u} + {m}_{d} - ( {m}_{d} + 4 \sqrt{{m}_{u} {m}_{d}} + 4 {m}_{u} ) \text{/} {( 2 π )}^{\frac{3}{2}} = 7.640679 MeV & ( 1.12 ) \\ {B}_{N} = 2 {m}_{d} + {m}_{u} - ( {m}_{u} + 4 \sqrt{{m}_{u} {m}_{d}} + 4 {m}_{d} ) \text{/} {( 2 π )}^{\frac{3}{2}} = 9.812358 MeV . & ( 1.13 )\end{matrix}$$

So for a nucleus with an equal number of protons and neutrons, the average binding energy per nucleon is predicted to be 8.726519 MeV. Not only does this explain why a typical nucleus beyond the very lightest (which we shall be studying in detail here) has a binding energy in exactly this vicinity (see FIG. 1), but when this is applied to ⁵⁶Fe with 26 protons and 30 neutrons—which has the distinction of using a higher percentage of this available binding energy than any other nuclide—we see that the latent available binding energy is predicted to be ((12.14) of [1]):

B(Fe⁵⁶)=26×7.640679 MeV+30×9.812358 MeV=493.028394 MeV (1.14)

This contrasts remarkably with the observed ⁵⁶Fe binding energy of 492.253892 MeV. That is, precisely 99.8429093% of the available binding energy predicted by this model of nucleons as Yang-Mills magnetic monopoles goes into binding together the ⁵⁶Fe nucleus, with a small 0.1570907% balance reserved for confining quarks within each nucleon. This means while quarks are very much freer in the nucleons of ⁵⁶Fe than in free nucleons (which also appears to explain the “first EMC effect” [10]), their confinement is never fully overcome. Confinement bends but never breaks. Quarks step back from the brink of becoming de-confined in ⁵⁶Fe as one moves to even heavier nuclides, and remain confined no matter what the nuclide. Iron-56 thus sits at the theoretical crossroads of fission, fusion and confinement.

This thesis that protons and neutrons are resonant cavities which emit and absorb energies that directly manifest their current quark masses will be central to the development of this paper. The foregoing (1.12) through (1.14) provide strong preliminary confirmation of this thesis, as well as of the underlying thesis that baryons are Yang-Mills magnetic monopoles. In this paper, we shall show how the observed binding energies of the 1s nuclides, namely of ²H, ³H, ³He and ⁴He, as well as the observed neutron minus proton mass difference, provide further compelling confirmation of the thesis that baryons are Yang-Mills magnetic monopoles which bind at energies which directly reflect the current quark masses they contain.

In simple summation: with a non-Abelian Yang-Mills field strength (1.3), Yang Mills magnetic monopole baryons result from simply combining Maxwell's classical electric (1.1) and magnetic (1.2) charge equations together into a single equation, making use of Dirac's J^{μ}=ψ̅γ^{μ}ψ based on charge continuity, and imposing Fermi-Dirac SU(3)_{C} Exclusion on the fermions of the resulting three-fermion monopole system. No further ingredients or assumptions are required, and all of these ingredients being so-combined in novel fashion are among the undisputed, uncontroversial bedrock foundations of modern physics. The Gaussian ansatz (1.7) enables the energy (1.8) to be analytically calculated, the mass relation (1.11) naturally emerges, and once we further apply the resonant cavity thesis, the resulting energies turn out to match up remarkably well with nuclear binding energies.

In even simpler summation: Maxwell's Equations (1.1), (1.2) themselves, combined together into one equation using non-Abelian gauge fields (1.3), taken together with Dirac theory and Fermi-Dirac Exclusion, are the governing equations of nuclear physics, insofar as nuclear physics centers around the study of protons and neutrons and how they bind and interact, and given that we were able to show in [1] that protons and neutrons are particular types of Yang-Mills magnetic monopoles. This theory is thus extremely conservative, based on combining together unquestionable foundational physics principles.

In essence, the purpose of this paper is to further develop the results from [1] into a theory of nuclear binding which we confirm by predicting the binding energies of the 1s nuclides as well as the neutron minus proton mass difference with very high precision, each on the order of parts per million. This in turn leads to resonant fusion technology.

### SUMMARY OF THE INVENTION

In an earlier paper, the author employed the thesis that baryons are Yang-Mills magnetic monopoles and that proton and neutron binding energies are determined based on their up and down current quark masses to predict a relationship among the electron and up and down quark masses within experimental errors and to obtain a very accurate relationship for nuclear binding energies generally and for the binding of ⁵⁶Fe in particular. The free proton and neutron were understood to each contain intrinsic binding energies which confine their quarks, wherein some or most (never all) of this energy is released for binding when they are fused into composite nuclides. The purpose of this paper is to further advance this thesis by seeing whether it can explain the specific empirical binding energies of the light 1s nuclides, namely, ²H, ³H, ³He and ⁴He, with high precision. As the method to achieve this, we show how these is binding energies are in fact the components of inner and outer tensor products of Yang-Mills matrices which are implicit in the expressions for these intrinsic binding energies. The result is that the binding energies for the ⁴He, ³He and ³H nucleons are respectively, independently, explained to less than four parts in one million, four parts in 100,000, and seven parts in one million, all in AMU. Further, we are able to exactly relate the neutron minus proton mass difference to a function of the up and down current quark masses, which in turn enables us to explain the ²H binding energy most precisely of all, to just over 8 parts in ten million. These energies have never before been theoretically explained with such accuracy, which leads to the conclusion that the underlying thesis provides the strongest theoretical explanation to date of what baryons are, and of how protons and neutrons confine their quarks and bind together into composite nuclides. As is also reviewed in Section 9, these results may lay the foundation for more easily catalyzing nuclear fusion energy release. Sections 13 and 14 expand this to the catalyzing of fusion energy release for reactions involving ⁶Li, ⁷Li, ⁷Be, ⁸Be, ¹⁰B, ⁹Be, ¹⁰Be, ¹¹B, ¹¹C, ¹²C and ¹⁴N.

### BRIEF DESCRIPTION OF THE DRAWINGS

FIG. 1 is a well-known graph which shows the empirical binding energy per nucleon of various nuclides.

FIG. 2 is a table showing the empirical nuclear weights (_{Z}^{A}M) of the 1s nuclides, in AMU.

FIG. 3 is a table showing the empirical binding energies (_{Z}^{A}B₀) of the 1s nuclides, in AMU.

FIG. 4 is a table showing the theoretically available binding energies (_{Z}^{A}B) of the 1s nuclides, in AMU.

FIG. 5 is a table showing the used-to-available binding energies (_{Z}^{A}B₀/_{Z}^{A}B (%)) of the 1s nuclides as a percentage (%).

FIG. 6 is a table showing the unused latent binding energies (_{Z}^{A}U) of the 1s nuclides, in AMU.

FIG. 7 is a table showing the empirical binding energies (_{Z}^{A}B₀) of selected 1s and 2s nuclides, in AMU.

FIG. 8 is a table showing a comparison of the alpha-subtracted 2s binding energies, with the 1s binding energies, in AMU.

FIG. 9 is a table showing the theoretical binding energies (_{Z}^{A}B₀) of the 1s nuclides.

FIG. 10 is a table showing the predicted binding energies (_{Z}^{A}B₀) of the 1s nuclides, in AMU

FIG. 11 is a table showing the predicted minus observed binding energies (_{Z}^{A}B₀) of the 1s nuclides, in AMU.

FIG. 12 is a graph showing retrodicted per-nucleon binding energies (B) per nucleon (A=Z+N) for 1s and 2s shells.

FIG. 13 is a schematic plan view illustrating the relative configuration of the gamma radiation source, the nuclear fuel, and the gamma radiation used in connection with the invention, including the distinctly-specified gamma radiation energy/frequency proximities utilized in the practice of the invention.

### DETAILED DESCRIPTION

2. Structured Outline of the Contents of this Patent Application

In deriving the empirically-accurate binding energy relationships (1.12) through (1.14) there is an aspect of (1.8) which, when carefully considered, requires us to amend the Lagrangian in (1.8) in a slight but important way. This amendment, developed in Section 3, will reveal that the latent binding energies (1.12) and (1.13) actually employ the inner and outer tensor products of two 3×3 SU(3) matrices, one for protons, and one for neutrons. These matrices, and their inner and outer products, will be critical to the methodological development thereafter.

In section 4 we lay the foundation for being able to derive the binding energies of the 1s nuclides using the earlier-discussed postulate that the mass of the up quark is equal to the deuteron (²H nucleus) binding energy, and the thesis extrapolated from this that the binding energies of nuclides generally are direct functions of the current quark masses which their nucleons contain. Specifically, in (4.9) through (4.11) infra, we develop two tensor outer products and their components which will be critical ingredients for expressing is binding energies as functions of up and down current quark masses.

Section 5 shows how this binding energy thesis leads directly to a theoretical expression for the ⁴He alpha binding energy which matches empirical data to less than 3 parts in 1 million AMU. Exploring the meaning of this result, we see that this binding energy together with that of the ²H deuteron are actually components of a (3×3)×(3×3) fourth rank Yang Mills tensor of which the ²H and ⁴He binding energies merely two samples. Thus, we are motivated to think about binding energies generally as components of Yang-Mills tensors. So the method for characterizing binding energies is one of trying to match up empirical binding energies with various expressions which emerge from, or are components of, these Yang-Mills tensors. In Section 6, we similarly obtain a theoretical expression for ³He helion binding to just under 4 parts in 100,000 AMU as well as its characterization in terms of these Yang-Mills tensors.

Developing a similar expression for the ³H triton to what ends up being just over three parts in one million AMU turns out to be less straightforward than for any of ²H, ³He and ⁴He, and requires us to work with mass excess rather than binding energy. However, a bonus is that in the process, we are also motivated to derive an expression for the neutron minus proton mass difference accurate to just over 7 parts in ten million AMU. To maintain clarity and focus on the underlying research ideas, these results are summarized in Section 7, while their detailed derivation is presented in the Appendix.

Section 8 aggregates the results of Sections 5 through 7, and couches them all in terms of mass excess rather than binding energy. In this form, it becomes more straightforward to study nuclear fusion processes involving these 1s nuclides.

Section 9 makes use of the mass excess results from Section 8, and shows how these can be combined to express the approximately 26.73 MeV of energy known to be released during the solar fusion cycle 4·₁¹H+2e⁻→₂⁴He+2ν+Energy entirely in terms of the up, down and electron fermion masses. This highlights not only the accuracy of the results for ²H, ³H, ³He and ⁴He binding energies and the neutron minus proton mass difference, but it establishes the approach one would use to do the same for other types of nuclear fusion, and for fission reactions. And, it vividly confirms the thesis that fusion and fission and binding energies are directly based on the masses of the quarks which are contained in protons and neutrons, regarded as resonant cavities.

But perhaps the most important consequence of the development in Section 9 is technological, because the possibility is developed via this “resonant cavity” analysis that by bathing a fuel store of hydrogen (or another suitable nuclear fuel) in gamma radiation at certain specified, discrete frequencies which are also defined functions of the up and down quark masses, one can catalyze nuclear fusion and perhaps develop more effective ways to practically exploit the promise of nuclear fusion energy release.

In Section 10, we take a closer look at experimental errors that still do reside in the results for ³H, ³He and ⁴He binding and the neutron minus proton mass difference, generally at parts per 10⁵, 10⁶ or 10⁷ AMU. We explain why the original postulate identifying the up quark mass exactly with the ²H deuteron binding energy should be modified into the substitute postulate that the theoretical neutron minus proton mass difference is an exact relationship, and why the equality of the up quark mass and the deuteron binding energy is simply a very close approximation (to just over 8 parts in ten million) rather than an exact relationship. We then are required to adjust (recalibrate) all of the prior numeric mass and energy calculations accordingly, by about parts per million. As a by-product, the up and down quark masses become known with the same degree of experimental precision as the electron rest mass and the neutron minus proton mass difference, to ten decimal places in AMU.

Section 11 concludes by summarizing and consolidating these results for ²H, ³H, ³He and ⁴He and the neutron minus proton mass difference, laying out most compactly in FIG. 11, how the thesis that baryons are Yang-Mills magnetic monopoles which fuse at binding energies reflective of their current quark masses can be used to predict the binding energies of the ⁴He alpha to less than four parts in one million, of the ³He helion to less than four parts in 100,000, and of the ³H triton to less than seven parts in one million, all in AMU. And of special import, by exactly relating the neutron minus proton mass difference to a function of the up and down quark masses, we are enabled to predict the binding energy for the ²H deuteron most precisely of all, to just over 8 parts in ten million.

Section 12 shows how all of the foregoing results can be equivalently and independently derived using mass matrices based on the Koide mass formula [20], [21]. Section 13 uses this insight to extend the development of resonant nuclear fusion to reactions involving ⁶Li, ⁷Li, ⁷Be and ⁸Be. Section 13 proceeds apace to further extend this insight to fusion reactions involving ¹⁰B, ⁹Be, ¹⁰Be, ¹¹B, ¹¹C, ¹²C and ¹⁴N.

What renders this work novel is 1) that the is light nuclide binding energies and the neutron minus proton mass difference do not appear to have ever before been theoretically explained with such accuracy; 2) the degree to which this accuracy confirms that baryons are Yang-Mills magnetic monopoles with binding energies which are components of a Yang-Mills tensor and which are directly related to current quark masses contained in these baryons; 3) the finding that nuclear physics appears to be grounded in unquestionable conservative physics principles, governed by simply combining Maxwell's two classical equations into one equation using Yang-Mills gauge fields in view of Dirac theory and Fermi-Dirac Exclusion for fermions; and 4) the prospect of perhaps improving nuclear fusion technology by applying suitably-chosen resonances of gamma radiation for catalysis.

### 3. The Lagrangian of Nuclear Binding Energies

The t'Hooft magnetic monopole Lagrangian used in (1.8), because of suppression of the Yang-Mills matrix indexes, actually has an ambiguous mathematical meaning, and can be either an ordinary (inner product) matrix multiplication, or a tensor (outer) product. The outer product is the most general bilinear operation that can be performed on F_{μν}F^{μν}, while the inner product represents a contraction of the outer product which reduces the Yang-Mills rank by 2. When carefully considered, this provides an opportunity for developing a nuclear Lagrangian based on the t'Hooft's original development [2] of Yang-Mills magnetic monopoles.

If we know that ¼F_{aμν}Fₐ^{μν}=½F_{μν}F^{μν} as we do from the terms in (11.7) of [1] omitted from (1.8) above,

and given that TrⁱT^{j}=½δ^{ij}, then with explicit indexes A, B, C, D=1, 2, 3 for the 3×3 Yang-Mills matrices of the SU(3)_{C′} isospin-modified color group developed in Section 8 of [1], an explicit appearance of Yang-Mills indexes would cause (1.8) to be written as:

E=−∫∫∫ [symbol] _{gauge}d³x=½Tr∫∫∫F_{μν}F^{μν}d³x=½Tr∫∫∫F_{μνAB}F_{BD}^{μν}d³x=½Tr∫∫∫F_{AB}·F_{BD}d³x=½∫∫∫F_{AB}·F_{BA}d³x (3.1)

where F·F≡F_{μν}F^{μν} suppresses spacetime indexes to focus attention on contractions of Yang-Mills indexes. In the fourth and fifth terms above, there is a contraction over the inner “B” index, which means that F_{AB}·F_{BD} is an inner product formed with ordinary matrix multiplication, and is a contraction over inner indexes of the fourth rank (3×3×3×3) outer product F_{μν}⊗F^{μν}=F_{AB}·F_{CD} down to rank two. In the sixth, final term, we write Tr F_{AB}·F_{BD}=F_{AB}·F_{BA} via a second “A” index contraction.

We point this out because (1.12) through (1.14) which successfully match empirical nuclear binding data, embody not only (3.1), but also an outer product F_{AB}·F_{CD}, that is, (carefully contrast Yang-Mills indexes between the final terms in (3.1), (3.2)):

E=−∫∫∫ [symbol] _{gauge}d³x=½Tr∫∫∫F_{μν}⊗F^{μν}d³x=½Tr∫∫∫F_{μνAB}F_{CD}^{μν}d³x=½Tr∫∫∫F_{AB}·F_{CD}d³x=½∫∫∫F_{AA}·F_{BB}d³x (3.2)

here, in the final terms, we use Tr F_{AB}·F_{CD}=F_{AA}·F_{BB}, as opposed to Tr F_{AB}·F_{BD}=F_{AB}·F_{BA}. This highlights the notational ambiguity in (1.8) as well as the difference between the outer ⊗ and inner matrix products.

Now, in general, the trace of a product of two square matrices is not the product of traces. The only circumstance in which “trace of a product” equals “product of traces” is when one forms a tensor outer product using:

Tr(A⊗B)=Tr(A)Tr(B). (3.3)

Specifically, to obtain the terms m_{d}+4\sqrt{mᵤm_{d}}+4mᵤ and mᵤ+4\sqrt{mᵤm_{d}}+4m_{d} in (1.12) and (1.13) (and also (12.4) and (12.5) of [1] which erroneously applied (3.2), (3.3) rather than (3.1) because of this ambiguity), we must use (3.2), while to obtain 2mᵤ+m_{d} and 2m_{d}+mᵤ in (1.12) and (1.13), we instead must use (3.1). So (1.12) and (1.13) are formed by a linear combination of both inner and outer products. And because (1.12) and (1.13) predict binding energies per nucleon in the range of 8.7 MeV and yield an extremely close match to ⁵⁶Fe binding energies, nature herself appears to be telling us that we need to combine inner and outer products in this way in order to match up with empirical data. This, in turn, gives us important feedback for how to construct our Lagrangian to match the empirical data.

To see this most vividly, we start with (11.8) and (11.9) from [1]:

$$\begin{matrix}{E}_{P} = - \frac{1}{2} \int \int \int ( \frac{{\overline{ψ}}_{d} [ {γ}_{⋁}^{μ} {γ}^{v} ] {ψ}_{d}}{“ {ρ}_{d} - {m}_{d} ”} + 2 \frac{{\overline{ψ}}_{u} [ {γ}_{⋁}^{μ} {γ}^{v} ] {ψ}_{u}}{“ {ρ}_{u} - {m}_{u} ”} ) \times ( \frac{{\overline{ψ}}_{d} [ {γ}_{μ ⋁} {γ}_{v} ] {ψ}_{d}}{“ {ρ}_{d} - {m}_{d} ”} + 2 \frac{{\overline{ψ}}_{u} [ {γ}_{μ ⋁} {γ}_{v} ] {ψ}_{u}}{“ {ρ}_{u} - {m}_{u} ”} ) {d}^{3} x & ( 3.4 ) \\ {E}_{N} = - \frac{1}{2} \int \int \int ( \frac{{\overline{ψ}}_{u} [ {γ}_{⋁}^{μ} {γ}^{v} ] {ψ}_{u}}{“ {ρ}_{u} - {m}_{u} ”} + 2 \frac{{\overline{ψ}}_{d} [ {γ}_{⋁}^{μ} {γ}^{v} ] {ψ}_{d}}{“ {ρ}_{d} - {m}_{d} ”} ) \times ( \frac{{\overline{ψ}}_{u} [ {γ}_{μ ⋁} {γ}_{v} ] {ψ}_{u}}{“ {ρ}_{u} - {m}_{u} ”} + 2 \frac{{\overline{ψ}}_{d} [ {γ}_{μ ⋁} {γ}_{v} ] {ψ}_{d}}{“ {ρ}_{d} - {m}_{d} ”} ) {d}^{3} x . & ( 3.5 )\end{matrix}$$

Using these in (3.1) and (3.2) following the development in Section 11 and (12.12) and (12.13) of [1], we can reproduce Equations (1.12) and (1.13) for the empirically-accurate latent binding energies of a proton and neutron using linear combinations of inner and outer Yang-Mills matrix products, respectively, as follows:

$$\begin{matrix}{B}_{P} = Σ {E}_{P} - {E}_{P} = \frac{1}{2} Tr \int \int \int ( {( 2 π )}^{\frac{3}{2}} {F}_{P μ v} {F}_{P}^{μ v} - {F}_{P μ v} ⊗ {F}_{P}^{μ v} ) {d}^{3} x = \frac{1}{2} Tr \int \int \int ( {( 2 π )}^{\frac{3}{2}} {F}_{P A B} \cdot {F}_{P B D} - {F}_{P A B} \cdot {F}_{P C D} ) {d}^{3} x = \frac{1}{2} \int \int \int ( {( 2 π )}^{\frac{3}{2}} {F}_{P A B} \cdot {F}_{P B A} - {F}_{P A A} \cdot {F}_{P B B} ) {d}^{3} x = 2 {m}_{u} + {m}_{d} - \frac{1}{{( 2 π )}^{\frac{3}{2}}} ( {m}_{d} + 4 \sqrt{{m}_{u} {m}_{d}} + 4 {m}_{u} ) = Tr [ ( \begin{matrix}\sqrt{{m}_{d}} & 0 & 0 \\ 0 & \sqrt{{m}_{u}} & 0 \\ 0 & 0 & \sqrt{{m}_{u}}\end{matrix} ) ( \begin{matrix}\sqrt{{m}_{d}} & 0 & 0 \\ 0 & \sqrt{{m}_{u}} & 0 \\ 0 & 0 & \sqrt{{m}_{u}}\end{matrix} ) - \frac{1}{{( 2 π )}^{\frac{3}{2}}} ( \begin{matrix}\sqrt{{m}_{d}} & 0 & 0 \\ 0 & \sqrt{{m}_{u}} & 0 \\ 0 & 0 & \sqrt{{m}_{u}}\end{matrix} ) ⊗ ( \begin{matrix}\sqrt{{m}_{d}} & 0 & 0 \\ 0 & \sqrt{{m}_{u}} & 0 \\ 0 & 0 & \sqrt{{m}_{u}}\end{matrix} ) ] = 9.356376 MeV - 1.715697 MeV = 7.640679 MeV & ( 3.6 ) \\ {B}_{N} = Σ {E}_{N} - {E}_{N} = \frac{1}{2} Tr \int \int \int ( {( 2 π )}^{\frac{3}{2}} {F}_{N μ v} {F}_{N}^{μ v} - {F}_{N μ v} ⊗ {F}_{N}^{μ v} ) {d}^{3} x = \frac{1}{2} Tr \int \int \int ( {( 2 π )}^{\frac{3}{2}} {F}_{NAB} \cdot {F}_{NBD} - {F}_{NAB} \cdot {F}_{NCD} ) {d}^{3} x = \frac{1}{2} \int \int \int ( {( 2 π )}^{\frac{3}{2}} {F}_{NAB} \cdot {F}_{NBA} - {F}_{NAA} \cdot {F}_{NBB} ) {d}^{3} x = 2 {m}_{u} + {m}_{d} - \frac{1}{{( 2 π )}^{\frac{3}{2}}} ( {m}_{d} + 4 \sqrt{{m}_{u} {m}_{d}} + 4 {m}_{u} ) = Tr [ ( \begin{matrix}\sqrt{{m}_{u}} & 0 & 0 \\ 0 & \sqrt{{m}_{d}} & 0 \\ 0 & 0 & \sqrt{{m}_{d}}\end{matrix} ) ( \begin{matrix}\sqrt{{m}_{u}} & 0 & 0 \\ 0 & \sqrt{{m}_{d}} & 0 \\ 0 & 0 & \sqrt{{m}_{d}}\end{matrix} ) - \frac{1}{{( 2 π )}^{\frac{3}{2}}} ( \begin{matrix}\sqrt{{m}_{u}} & 0 & 0 \\ 0 & \sqrt{{m}_{d}} & 0 \\ 0 & 0 & \sqrt{{m}_{d}}\end{matrix} ) ⊗ ( \begin{matrix}\sqrt{{m}_{u}} & 0 & 0 \\ 0 & \sqrt{{m}_{d}} & 0 \\ 0 & 0 & \sqrt{{m}_{d}}\end{matrix} ) ] = 12.039054 MeV - 2.226696 MeV = 9.812358 MeV . & ( 3.7 )\end{matrix}$$

These now provide matrix expressions for intrinsic, latent binding energies of the proton and neutron, contracted down to scalar energy numbers which specify these binding energies and match the empirical data very well. And it is from these, that we learn how to amend the Lagrangian in (1.8) to lay a foundation for considering nuclear binding energies in general.

Contrasting (3.6) and (3.7) with (3.1) and (3.2), we see that in order to match up with the empirical data, the general form of a Lagrangian for the latent binding energy of a nucleon, rather than (1.8), needs to be:

$${binding}_{} = \frac{1}{2} Tr ( {( 2 π )}^{\frac{3}{2}} {F}_{μ v} {F}^{μ v} - {F}_{μ v} ⊗ {F}^{μ v} ) = \frac{1}{2} Tr ( {( 2 π )}^{\frac{3}{2}} {F}_{A B} \cdot {F}_{B D} - {F}_{A B} \cdot {F}_{C D} ) = \frac{1}{2} ( {( 2 π )}^{\frac{3}{2}} {F}_{A B} \cdot {F}_{B A} - {F}_{A A} \cdot {F}_{B B} ) . \qquad ( 3.8 )$$

Using this, we now start to amend the t'Hooft Lagrangian (9.2) of [1], reproduced below:

[symbol]

=−¼F_{μν}^{a}Fₐ^{μν}−½D_{μ}ϕₐD^{μ}ϕ^{a}−½μ²ϕₐϕ^{a}−−⅛λ(ϕₐϕ^{a})².

First, we apply TrTⁱT^{j}=½δ^{ij}, F^{μν}=TⁱFᵢ^{μν} and Φ=T^{a}ϕₐ to rewrite (3.9) in the Yang-Mills matrix form:

$$\begin{matrix}= - \frac{1}{2} Tr ( {F}_{μ v} {F}^{μ v } ) - T r ( {D}_{μ} Φ {D}^{μ} Φ ) - {μ}^{2} Tr ( ΦΦ ) - \frac{1}{2} {λ ( Tr ( ΦΦ ) )}^{2} \\ = - \frac{1}{2} Tr ( {F}_{μ vAB} {F}_{B D}^{μ v} ) - T r ( {( {D}_{μ} Φ )}_{A B} {( {D}^{μ} Φ )}_{B D} ) - \\ {μ}^{2} T r ( {Φ}_{A B} {Φ}_{B D} ) - \frac{1}{2} {λ ( Tr ( {Φ}_{A B} {Φ}_{B D} ) )}^{2} \\ = - \frac{1}{2} {F}_{μ vAB} {F}_{B A}^{μ v} - {( {D}_{μ} Φ )}_{A B} {( {D}^{μ} Φ )}_{B A} - \\ {μ}^{2} {Φ}_{A B} {Φ}_{B A} - \frac{1}{2} {λ ( {Φ}_{A B} {Φ}_{B A} )}^{2}\end{matrix} \qquad ( 3.10 )$$

with (9.4) of [1] also written in compacted matrix form:

(D_{μ}Φ)_{AB}=∂_{μ}Φ_{AB}−i([G_{μ},Φ])_{AB}. (3.11)

Now, we compare (3.10) closely with (3.8), especially comparing −½F_{μνAB}F_{BA}^{μν} in (3.10) with

$$\frac{1}{2} {( 2 π )}^{\frac{3}{2}} {F}_{A B} \cdot {F}_{B A}$$

in (3.8). Based on this, we reconstruct the t'Hooft Lagrangian so the pure gauge terms specify the latent nuclear binding energies, that is, we choose to make

$$\frac{1}{2} ( {( 2 π )}^{\frac{3}{2}} {F}_{A B} \cdot {F}_{B A} - {F}_{A A} \cdot {F}_{B B} )$$

the pure gauge Lagrangian term, because we know from (3.6) and (3.7) that this yields latent binding energies very much in accord with those empirically observed in nuclear physics. Thus, we take (3.10), introduce a factor of

$$- {( 2 π )}^{\frac{3}{2}}$$

in front of all the ordinary matrix products, subtract off a term F_{AA}·F_{BB}, introduce similarly-contracted terms everywhere else, and so fashion the Lagrangian:

$$= {( 2 π )}^{\frac{3}{2}} [ \frac{1}{2} {F}_{μ vAB} {F}_{B A}^{μ v} + {( {D}_{μ} Φ )}_{A B} {( {D}^{μ} Φ )}_{B A} + {μ}^{2} {Φ}_{A B} {Φ}_{B A} + \frac{1}{2} {λ ( {Φ}_{A B} {Φ}_{B A} )}^{2} ] - \frac{1}{2} {F}_{μ vAA} {F}_{B B}^{μ v} - {( {D}_{μ} Φ )}_{A A} {( {D}^{μ} Φ )}_{B B} - {μ}^{2} {Φ}_{A A} {Φ}_{B B} - \frac{1}{2} {λ ( {Φ}_{A A} {Φ}_{B B} )}^{2} . \qquad ( 3.12 )$$

It is readily seen that the pure gauge terms F_{μν}F^{μν} in the above are identical to (3.8), which means these terms now represent the empirically-observed latent nuclear binding energies. However, in constructing this Lagrangian, we carry the same index structure and (2π)^{3/2} coefficients forward to all remaining terms and thus extend this understanding to the vacuum terms.

The benefit of all of this can be seen by now considering a nucleus with Z protons and N neutrons, which therefore has A=Z+N nucleons. With (3.6) and (3.7), we may write the intrinsic, available, latent binding energy _{Z}^{A}B of any such nuclide as:

$${}_{Z}^{A} B = \frac{1}{2} Z \cdot \int \int \int ( {( 2 π )}^{\frac{3}{2}} {F}_{P A B} \cdot {F}_{P B A} - {F}_{P A A} \cdot {F}_{P B B} ) {d}^{3} x + \frac{1}{2} N \cdot \int \int \int ( {( 2 π )}^{\frac{3}{2}} {F}_{N A B} \cdot {F}_{N B A} - {F}_{N A A} \cdot {F}_{N B B} ) {d}^{3} x = Z \cdot 7.640679 MeV + N \cdot 9.812358 MeV . \qquad ( 3.13 )$$

This simply restates the results found in Sections 11 and 12 of [1] in more formal terms. But, it ties formal theoretical expressions based on a Lagrangian [symbol] ∝−½Tr(F·F) and an energy E=−∫∫∫ [symbol] d³x to a very practical formula for deriving real, numeric, empirically-accurate nuclear binding energies. A good example is (1.14) for ₂₆⁵⁶B, the latent binding energy of ⁵⁶Fe.

On the foregoing basis, we now show how to derive not only the latent, available binding energies (designated B) via (3.13), but also the observed binding energies (which will be designated throughout as B₀ with a “0” subscript) for several basic light nuclides. Specifically, we now lay the foundation for deriving ₁³B₀ for the ³H triton, ₂³B₀ for the ³He helion, and most importantly given that it is a fundamental building block of the larger nuclei and many decay process, ₂⁴B₀ for the ⁴He alpha, all extremely closely to the empirical data.

### 4. Foundation for Deriving Observed Binding Energies of the is Nuclides

Our goal is to derive the observed, empirical binding energies for all nuclides with Z≤2; N≤2 on a totally theoretical basis. We thereby embark on the undertaking set forth at the end of [1], to understand in detail, how collections of Yang-Mills magnetic monopoles—which monopole collections we now understand to be nuclei when the monopoles are protons and neutrons—organize and structure themselves.

The empirical nuclear weights (masses _{Z}^{A}M) of the 1s nuclides are set forth in FIG. 2 (again, A=Z+N). Because we wish to do very precise calculations, and because nuclide masses are known much more precisely in u (atomic mass units, AMU) than in MeV due to the “relatively poorly known electronic charge” [11], we shall work in AMU. When helpful for illustration, we shall convert over to MeV via 1u=931.494061(21) MeV/c², but only after a calculation is complete. The data for these nuclides (and the electron mass below) is from [11] and/or [12], and is generally known to ten-digit precision in AMU with experimental errors at the eleventh and twelfth digits. For other nuclides not listed at these sources, we make use of a very helpful online compilation of atomic weights and isotopes at [13]. Vertical columns list isotopes, horizontal rows list isotones, and diagonal lines link isobars of like-A. The nuclides with border frames are stable nuclides. The mass of the neutron is M(n)=₀¹M=1.008664916000u and the mass of the proton is M(p)=₁¹M=1.007276466812u.

The observed binding energies B₀ are readily calculated from the above via _{Z}^{A}B₀=Z·₁¹M+N·₀¹M−_{Z}^{A}M using the proton and neutron masses M(p)=₁¹M and M(n)=₀¹M, and are summarized in FIG. 3 (again, the observed binding energies will be denoted throughout as B₀ with a “0” subscript, while latent, theoretically-available binding energies denoted simply B will omit this subscript).

Now let's get down to business. We already showed in (12.9) of [1] and discussed in the introduction here, that by identifying the mass of the up quark with the deuteron binding energy via the postulate that mᵤ·B₀ (²H)=2.224566 MeV, we not only can establish very precise masses for the up and down quarks but also can explain the confluence of confinement and fission and fusion at ⁵⁶Fe in a very profound way, wherein 99.8429093% of the available binding energy goes into binding the ⁵⁶Fe nucleus and only the remaining 0.1570907% is unused for nucleon binding and so instead confines quarks. And, we extrapolated this to the thesis to be further confirmed here, that nucleons in general are resonant cavities fusing at energies reflective of their current quark masses.

So we now write this postulate identifying (defining) the up quark mass mᵤ with the observed deuteron binding energy ₁²B₀, in notations to be employed here, in AMU, as:

mᵤ≡₁²B₀=0.002388170100u. (4.1)

In AMU, the electron mass, which we shall also need, is:

mₑ=0.000548579909u. (4.2)

We then use (1.11) (see also (12.10) of [1]) with (4.1) and (4.2) to obtain the down quark mass:

$${m}_{d} = {( 2 π )}^{\frac{3}{2}} {m}_{e} / 3 + {m}_{u} = 0.005268143299 u . \qquad ( 4.3 )$$

It will also be helpful in the discussion following to use:

\sqrt{mᵤm_{d}}=0.003547001876u (4.4)

see, e.g., (1.12) and (1.13) in which this first arises.

We then use the foregoing in (1.12) and (1.13) to calculate the latent, available binding energy of the proton and neutron, designated B without the “0” subscript:

$$\begin{matrix}B ( p ) = {}_{1}^{1} B = 2 {m}_{u} + {m}_{d} - ( {m}_{d} + 4 \sqrt{{m}_{u} {m}_{d}} + 4 {m}_{u} ) / {( 2 π )}^{\frac{3}{2}} = 0.008202607 \; 332 u & ( 4.5 ) \\ B ( n ) = {}_{0}^{1} B = 2 {m}_{d} + {m}_{u} - ( {m}_{u} + 4 \sqrt{{m}_{u} {m}_{d}} + 4 {m}_{d} ) / {( 2 π )}^{\frac{3}{2}} = 0.010534000 \; 622 u . & ( 4.6 )\end{matrix}$$

Via (3.13), (4.5) and (4.6) may then be used to calculate generally, the latent, available binding energy:

$${}_{Z}^{A} B = Z \cdot ( 2 {m}_{u} + {m}_{d} - \frac{{m}_{d} + 4 \sqrt{{m}_{u} {m}_{d}} + 4 {m}_{u}}{{( 2 π )}^{\frac{3}{2}}} ) + N \cdot ( 2 {m}_{d} + {m}_{u} - \frac{{m}_{u} + 4 \sqrt{{m}_{u} {m}_{d}} + 4 {m}_{d}}{{( 2 π )}^{\frac{3}{2}}} ) = Z \cdot 0.008202607332 u + N \cdot 0.010534000622 u \qquad ( 4.7 )$$

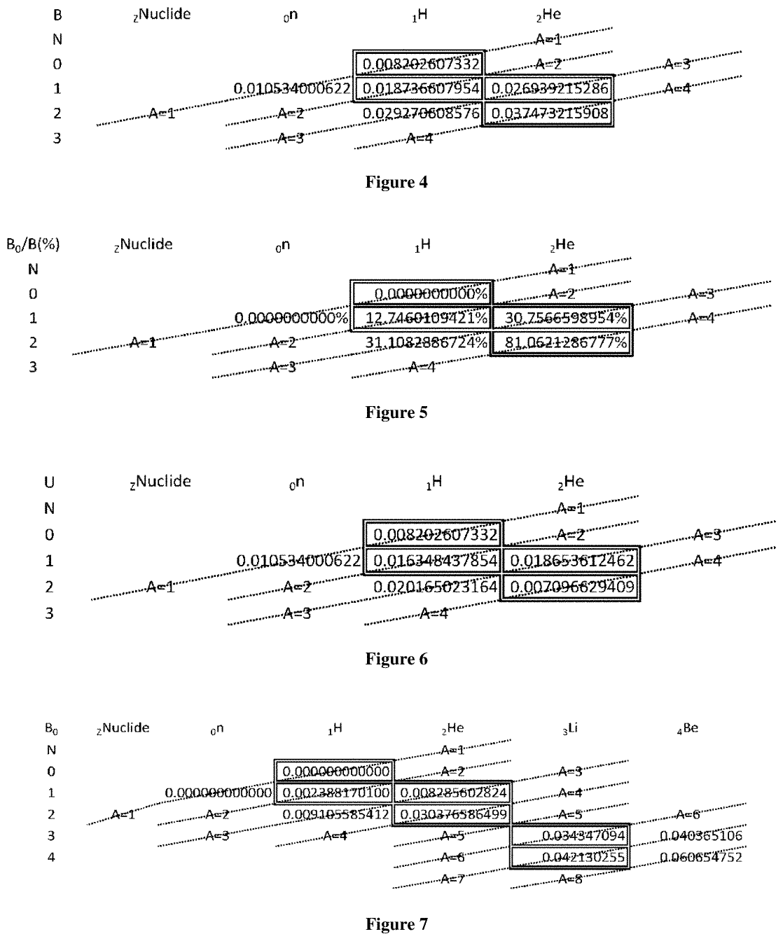

for any nuclide of given Z, N. For the nuclides in FIGS. 2 and 3, this theoretically-available, latent binding energy B, is predicted to be: see FIG. 4.

Taking the ratio of the empirical values in FIG. 3 over the theoretical values in FIG. 4 and expressing these as percentages then yields: see FIG. 5.

So we see, for example, that the ⁴He alpha nucleus uses about 81.06% of its total available latent binding energy to bind itself together, with the remaining 18.94% retained to confine the quarks inside each nucleon. The deuteron releases about 12.74% of it latent binding energy for nuclear binding, while the isobars with A=3 release about 31% of this latent energy for nuclear binding with the balance reserved for quark confinement. The free proton and neutron, of course, retain 100% of this latent energy to bind their quarks and release nothing. So one may think of the latent binding energy as an energy that “see-saws” between confining quarks and binding together nucleons into nuclides, with the exact percentage of latent energy reserved for quark confinement versus released for nuclear binding dependent on the particular nuclide in question.

As a point of comparison, we return to ⁵⁶Fe which has the highest percentage of used-to-available binding energy of any nuclide. Its nuclear weight ₂₆⁵⁶M=55.92067442u (cf. FIG. 2), its empirical, observed binding energy ₂₆⁵⁶B₀=0.52846119u (cf. FIG. 3), its latent binding energy ₂₆⁵⁶B=0.52928781u (cf. FIG. 4), and its used-to-available percentage ₂₆⁵⁶B₀/₂₆⁵⁶B (%)=99.843825% (cf. FIG. 5). No nuclide has a higher such percentage than ⁵⁶Fe. While ⁶²Ni has a larger empirical binding energy per-nucleon, its used-to-available percentage is lower, because the calculation in (4.7) literally and figuratively weights the neutrons more heavily than the protons by a ratio of:

$$\frac{B ( n )}{B ( p )} = \frac{{}_{0}^{1} B}{{}_{1}^{1} B} = \frac{0.0105 \; 34000622 u}{0.008 \; 202607332 u} = 1.284225880325 . \qquad ( 4.8 )$$

The above ratio explains the long-observed phenomenon why heavier nuclides tend to have a greater number of neutrons than protons: For heavier nuclides, because the neutrons carry an energy available for binding which is about 28.42% larger than that of the proton, neutrons will in general find it easier to bind into a heavy nucleus by a factor of 28.42%. Simply put: neutrons bring more available binding energy to the table than protons and so are more welcome at the table. The nuclides running from ³¹Ga to ⁴⁸Cd tend to have stable isotopes with neutron-to-proton number ratios (N/Z) roughly in the range of (4.8). Additionally, and likely for the same reason, this is the range in which, beginning with ⁴¹Nb and ⁴²Mo, and as the N/Z ratio grows even larger than (4.8), one begins to see nuclides which become theoretically unstable with regard to spontaneous fission.

Next, we subtract FIG. 3 from FIG. 4, to obtain the unused (U) binding energy _{Z}^{A}U=_{Z}^{A}B−_{Z}^{A} B₀ for each nuclide. These unused binding energies represent the amount of the latent binding energies reserved for and channeled into intra-nucleon quark confinement, rather than released and used for inter-nucleon binding. Of course, for the proton and neutron, all of this energy is unused; it is fully reserved and channeled into confining the quarks. These unused, reserved-for-confinement energies are: see FIG. 6.

Finally, to lay the groundwork for predicting the observed binding energies B₀ in FIG. 3, let us refer to (3.6) and (3.7), remove the trace, and specify two (3×3)×(3×3) outer product matrices, one for the proton, E_{P ABCD}, and one for the neutron, E_{N ABCD}, according to:

$$\begin{matrix}{( 2 π )}^{\frac{3}{2}} {E}_{P A B C D} = \frac{1}{2} {( 2 π )}^{\frac{3}{2}} \int \int \int {F}_{P A B} \cdot {F}_{P C D} {d}^{3} x = ( \begin{matrix}\sqrt{{m}_{d}} & 0 & 0 \\ 0 & \sqrt{{m}_{u}} & 0 \\ 0 & 0 & \sqrt{{m}_{u}}\end{matrix} ) ⊗ ( \begin{matrix}\sqrt{{m}_{d}} & 0 & 0 \\ 0 & \sqrt{{m}_{u}} & 0 \\ 0 & 0 & \sqrt{{m}_{u}}\end{matrix} ) & ( 4.9 ) \\ {( 2 π )}^{\frac{3}{2}} {E}_{N A B C D} = \frac{1}{2} {( 2 π )}^{\frac{3}{2}} \int \int \int {F}_{N A B} \cdot {F}_{N C D} {d}^{3} x = [ ( \begin{matrix}\sqrt{{m}_{u}} & 0 & 0 \\ 0 & \sqrt{{m}_{d}} & 0 \\ 0 & 0 & \sqrt{{m}_{d}}\end{matrix} ) ⊗ ( \begin{matrix}\sqrt{{m}_{u}} & 0 & 0 \\ 0 & \sqrt{{m}_{d}} & 0 \\ 0 & 0 & \sqrt{{m}_{d}}\end{matrix} ) ] . & ( 4.10 )\end{matrix}$$

From the above, one can readily obtain the eighteen non-zero diagonal outer product components (nine for the proton and nine for the neutron), with E_{P ABCD}=E_{N ABCD}=0 otherwise:

$${E}_{N 1111} = {E}_{P 2222} = {E}_{P 3333} = {E}_{P 2233} = {E}_{P 3322} = \frac{{m}_{u}}{{( 2 π )}^{\frac{3}{2}}} \\ {E}_{P 1111} = {E}_{N 2222} = {E}_{N 3333} = {E}_{N 2233} = {E}_{N 3322} = \frac{{m}_{d}}{{( 2 π )}^{\frac{3}{2}}} \\ {E}_{P 1122} = {E}_{P 1133} = {E}_{P 2211} = {E}_{P 3311} = {E}_{N 1122} = {E}_{N 1133} = {E}_{N 2211} = {E}_{N 3311} = \frac{\sqrt{{m}_{u} {m}_{d}}}{{( 2 π )}^{\frac{3}{2}}} . \qquad ( 4.11 )$$

This is why (4.1), (4.3) and (4.4) will be of interest in the development following. With the “toolkit” (4.9) to (4.11) we now have all ingredients needed to closely deduce the empirical binding energies in FIG. 3 on totally theoretical grounds. We start with the alpha, ⁴He.

### 5. Prediction of the Alpha Nuclide Binding Energy to 3 Parts in One Million, and how Binding Energies are Yang-Mills Tensor Components

The alpha particle is the ⁴He nucleus. It is highly stable, with fully saturated 1s shells for protons and neutrons, and is central to many aspects of nuclear physics including the decay of nuclides into more stable states via so-called alpha decay. In this way, it is a bedrock building block of nuclear physics.

The unused binding energy in FIG. 6 for the alpha is ₂⁴U=0.007096629409u. Looking over the toolkit (4.11),

we see 2\sqrt{mᵤm_{d}}=0.007094003752u, so ₂⁴U is very close to being twice the value of \sqrt{mᵤm_{d}} in (4.4). In fact, these energies are equal to about 2.26 parts per million! Might this be an indication that the alpha uses all its latent binding energy less 2\sqrt{mᵤm_{d}} for nuclear binding, with the 2\sqrt{mᵤm_{d}} balance reserved on the other side of the “see saw” to confine quarks within each of its four nucleons? First, let's look at the numbers, then examine theoretical reasons why this may make sense.

If in fact this numerical coincidence is not just a coincidence but has real physical meaning, this would mean the empirical binding energy ₂⁴B₀ of the alpha is predicted to be (4.7) for ₂⁴B, less 2\sqrt{mᵤm_{d}}, that is:

$${}_{2}^{4}{B}{}_{0 Predicted}^{} = 2 \cdot ( 2 {m}_{u} + {m}_{d} - \frac{{m}_{d} + 4 \sqrt{{m}_{u} {m}_{d}} + 4 {m}_{u}}{{( 2 π )}^{\frac{3}{2}}} ) + 2 \cdot ( 2 {m}_{d} + {m}_{u} - \frac{{m}_{u} + 4 \sqrt{{m}_{u} {m}_{d}} + 4 {m}_{d}}{{( 2 π )}^{\frac{3}{2}}} ) - 2 \sqrt{{m}_{u} {m}_{d}} = 0.0 \; 30379212155 u \qquad ( 5.1 )$$

where we calculate using mᵤ, m_{d} from (4.1), (4.3), and \sqrt{mᵤm_{d}} from (4.4). In contrast, the empirical ₂⁴B₀=0.030376586499u in FIG. 3. The difference:

₂⁴B_{0Predicted}−₂⁴B₀=0.030379212155u−0.030376586499u=0.000002625656u (5.2)

is extremely small, with these two values, as noted just above for the reserved energy, differing from one another by less than 3 parts in 1 million AMU! So, let us regard (5.1) to be a correct prediction of the alpha binding energy to 3 parts per million. Now, let's discuss the theoretical reasons why this makes sense.

In [1], a key postulate was to identify the mass of the down quark with the deuteron binding energy, see (4.1) here in which we again reviewed that identification. Beyond the numerical concurrence, a theoretical explanation is that in some fashion the nucleons are resonant cavities, so the energies they release (or reserve) during fusion will be very closely tied to the masses/wavelengths of the contents of these cavities. But, of course, these “cavities” contain up quarks and down quarks, and their masses are given in (4.1) and (4.3) together with the \sqrt{mᵤm_{d}} construct in (4.4), and so these will specify preferred “harmonics” to determine the precise energies which these cavities resonantly release for nuclear binding, or hold in reserve for quark confinement.

We also see that components of the outer products

$${( 2 π )}^{\frac{3}{2}} {E}_{ABCD} = \frac{1}{2} {( 2 π )}^{\frac{3}{2}} \int \int \int {F}_{AB} \cdot {F}_{CD} {d}^{3} x$$

in (4.9) and (4.10) take on one of three non-zero values: mᵤ, m_{d}, or \sqrt{mᵤm_{d}}, see (4.11). So, in trying to make a theoretical fit to empirical binding data we require that empirical binding energies be calculated only from these outer products E_{ABCD}=½∫∫∫F_{Ab}·F_{CD}d³x (4.9), (4.10) using only some combination of 1) the components of these outer products and 2) index contractions of these outer products. So the ingredients we shall use to do this numerical fitting will be restricted to 1) the latent nuclide binding energies calculated from (4.7); 2) the three energies mᵤ, m_{d}, \sqrt{mᵤm_{d}} of (4.11) and quantized multiples thereof; and 3) any of the foregoing with a

$${( 2 π )}^{\frac{3}{2}}$$

coefficient or divisor, as suitable; we also permit 4) the rest mass of the electron mₑ which is related to the up and down masses via (1.11). The method of this fitting is trial and error, at least for now, and involves essentially poring over the empirical nuclear binding energy data and seeing if it can be arrived at closely using only the foregoing ingredients.

For the alpha, (5.1) meets all these criteria. In fact, rewritten with (3.6), (3.7) and (4.9) through (4.11), we find (5.1) can be expressed entirely in terms of the outer product E_{ABCD}=½∫∫∫F_{AB}·F_{CD}d³x as just discussed, as:

$${}_{2}^{4}{B}{}_{0 Predicted}^{ } = 2 \cdot ( {( 2 π )}^{\frac{3}{2}} {E}_{PABBA} - {E}_{PAABB} ) + 2 \cdot ( {( 2 π )}^{\frac{3}{2}} {E}_{NABBA} - {E}_{NAABB} ) - {( 2 π )}^{\frac{3}{2}} ( {E}_{P 1122} + {E}_{N 1122} ) = 2 \cdot ( 2 {m}_{u} + {m}_{d} - \frac{{m}_{d} + 4 \sqrt{{m}_{u} {m}_{d}} + 4 {m}_{u}}{{( 2 π )}^{\frac{3}{2}}} ) + 2 \cdot ( 2 {m}_{d} + {m}_{u} - \frac{{m}_{u} + 4 \sqrt{{m}_{u} {m}_{d}} + 4 {m}_{d}}{{( 2 π )}^{\frac{3}{2}}} ) - 2 \sqrt{{m}_{u} {m}_{d}} . \qquad ( 5.3 )$$

This totally theoretical Yang-Mills tensor expression yields the alpha binding energy to 2.26 parts per million.

In this form, (5.3) tells us that the alpha binding energy is actually the 11 22 component of a (3×3)×(3×3) outer product E_{ABCD}, in linear combination with traces of E_{ABCD}. That is, this binding energy is a component of a Yang-Mills tensor!

This is reminiscent, for example, of the Maxwell Tensor −4πT^{μν}=F^{μα}F_{α}^{ν} −¼η^{μν}F^{αβ}F_{αβ}, which provides a suitable analogy. The on-diagonal components of the Maxwell tensor contain both a component term and a trace term just like (5.3). For example, for the 00 term −4πT⁰⁰=F^{0α}F_{α}⁰−¼F^{αβ}F_{αβ}, we analogize F^{0α}F_{α}⁰ to the E₁₁₂₂ and F^{αβ}F_{αβ} to the

$${( 2 π )}^{\frac{3}{2}} {E}_{ABBA} - {E}_{AABB}$$

in (5.3). The off-diagonal components of the Maxwell tensor, however, do not include a trace term. For example, for the 01 term in Maxwell, if we consider −4πT⁰¹=F^{0α}F_{α}¹−η⁰¹¼F^{αβ}F_{αβ}=F^{0α}F_{α}¹+0, the Minkowski metric η^{μν} filters out the trace. This latter, off-diagonal analogy allows us to represent (4.1) for the deuteron as a tensor component without a trace term, for example, as (see (4.11)):

$${}_{1}^{2}{B}{}_{0 Predicted}^{ } = {m}_{u} = {( 2 π )}^{\frac{3}{2}} {E}_{N 1111} + 0. \qquad ( 5.4 )$$

So we now start to think about individual observed nuclear binding energies as components of a fourth rank Yang Mills tensor of which (5.3) and (5.4) are merely two samples. Thus, as we proceed to examine many different nuclides, we will want to see what patterns may be discerned for how each nuclide fits into this tensor.

Physically, the alpha particle contains two protons and two neutrons, in terms of quarks, six up quarks and six down quarks. It is seen that the up quarks enter (5.3) in a completely symmetric fashion relative to the down quarks, i.e., that (5.3) is invariant under the interchange mᵤ↔m_{d}. The factor of 2 in front of \sqrt{mᵤm_{d}} of course means that two components of the outer product are also involved. So we have preliminarily associated 2\sqrt{mᵤm_{d}}=E_{P1122}+E_{N1122} so that the neutron pair and the proton pair each contribute 1\sqrt{mᵤm_{d}} to (5.3), and (5.3) thereby remains absolutely symmetric not only under u↔d, but also under p↔n interchange.

We do note that there is some flexibility in these assignments of energy numbers to tensor components, because each of mᵤ, m_{d}, \sqrt{mᵤm_{d}} in the (4.11) toolkit is associated with several different components of the outer product. So the choice of E₁₁₂₂ in (5.3) (while requiring p↔n symmetry) and of E_{N1111} in (5.4) is flexible versus the other available possibilities in (4.11), and should be revisited once we study other nuclides not yet considered and seek to understand the more general Yang-Mills tensor structure of which the individual nuclide binding energies are components.

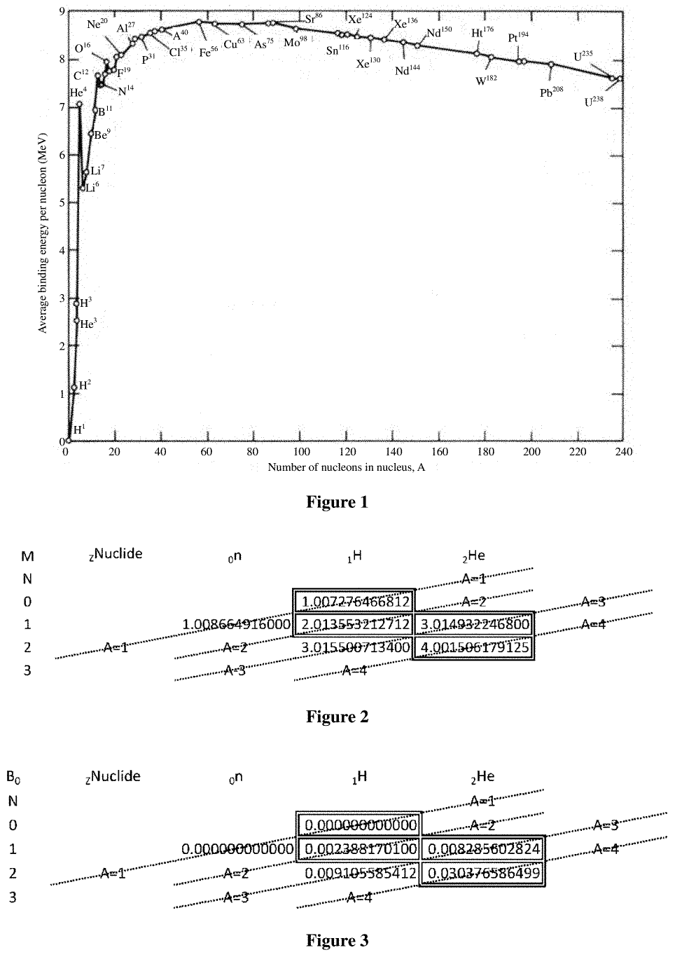

One other physical observation is also very noteworthy, and to facilitate this discussion we include the well-known “per-nucleon” binding graph as FIG. 1. One perplexing mystery of nuclear physics is why there is such a large “chasm” between binding energies for the ²H, ³H and ³He nuclides, and the biding energy of the ⁴He nuclide which we have now predicted to within parts per million. Contrasting (5.3) for ⁴He with (5.4) for ²H, we see that for the latter deuteron, we “start at the bottom” with ₁¹B₀=0 for ¹H (the free proton), and then “add” ₁²B₀=0+mᵤ worth of energy to bind the proton and the neutron together into ²H. Conversely, for the alpha we “start at the top” with the total latent binding energy ₂⁴B=0.037473215908u, and then subtract off 2\sqrt{mᵤm_{d}}, to match the empirical data with ₂⁴B₀=0.037473215908u−2\sqrt{mᵤm_{d}}. But as we learned in Section 12 of [1] and have reiterated here, any time we do not use some of the latent energy for nuclear binding, that unused energy remains behind in reserve to confine the quarks in a type of nuclear see-saw.

So what we learn is that for the alpha particle, a total of 2\sqrt{mᵤm_{d}}=0.007094004u is held in reserve to confine the quarks, while the majority balance is released to bind the nucleons to one another. In contrast, for the deuteron, a total of mᵤ≡₁²B₀=0.002388170100u is released for inter-nucleon binding while the majority balance is held in reserve to confine the quarks.

Now to the point: for some nuclides (e.g. the deuteron) the question is: how much energy is released from quark confinement to bind nucleons? This is a “bottom to top” nuclide. For other nuclides (e.g., the alpha) the question is: how much energy is reserved out of the theoretical maximum available, to confine quarks. This is a “top to bottom” nuclide. For top to bottom nuclides, there is a scalar trace in the Yang-Mills tensors. For bottom to top nuclides there is not. Using the Maxwell tensor analogy, one may suppose that somewhere there is a Kronecker delta δ_{B}^{A} and/or δ_{CD}^{AB} which filters out the trace from “off-diagonal” terms and leaves the trace intact for “on-diagonal” terms. In this way, the “bottom to top” nuclides are “off-diagonal” tensor components and the “top to bottom” nuclides are “on diagonal” components. In either case, however, the “resonance” for nuclear binding is established by the components of the E_{N ABCD}, which are mᵤ, m_{d}, \sqrt{mᵤm_{d}} in some combination and/or integer multiple. And, as regards FIG. 1, the chasm between the lighter nuclides and ⁴He is explained on the basis that each of ²H, ³H and ³He are “bottom to top” “off-diagonal” nuclides, while ⁴He, which happens to fill the 1s shells, is the lightest “top to bottom” “on-diagonal” nuclide. ²H, ³H and ³He start at the bottom of the nuclear see-saw and move up; ⁴He starts at the top of the see-saw and moves down.

To amplify this point, in FIG. 7 we peek ahead at some heavier nuclides, namely, ₃Li and ₄Be. Using a nuclear shell model similar to that used for electron structure, all nucleons in the ⁴He alpha are in 1s shells. The two protons are spin up and down each with 1s, as are the two neutrons. As soon as we add one more nucleon, by Exclusion, we must jump up to the 2s shell, which admits four more nucleons and can reach up to ₄⁸Be before we must make an incursion into the 2p shell.

We note immediately from the above-which has been noticed by others before—that the binding energy ₄⁸B₀=0.060654752u of ⁸Be is almost twice as large as that of the alpha particle, to just under one part in ten thousand AMU. Specifically:

2·₂⁴B₀−₄⁸B₀=2×0.030376586499u−0.060654752u=0.000098421u. (5.5)

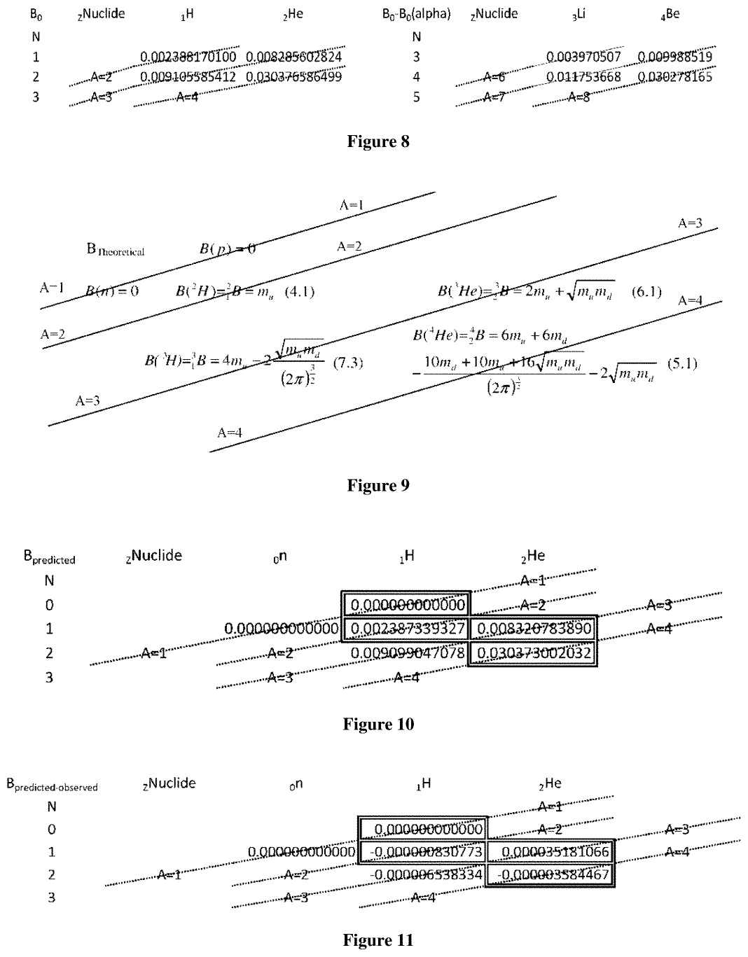

This is part of why ⁸Be is unstable and invariably decays almost immediately into two alpha particles (⁹Be is the stable Be isotope). But of particular interest here, is to subtract off the alpha ₂⁴B₀=0.030376586499u from each of the Li and Be isotopes, and compare them side by side with the non-zero binding energies from H and He. The result of this exercise is in FIG. 8.

Equation (5.5) is represented above by the fact that ₄⁸B₀−₂⁴B₀≅₂⁴B. The table on the left is a “1s square” and the table on the right is a “2s square.” But they are both “s-squares.” What is of interest is that the remaining three nuclides in the 2s square are not dissimilar in pattern from the other three nuclides in the is square. This means that three of the four nuclides in the 2s square start “at the bottom” “off-diagonal” just as in 1s, and the fourth, ⁸Be, starts “on diagonal” “at the top.” But, in the 2s square, the “bottom” is the alpha particle's ₂⁴B₀=0.030376586499u. So the filled 1s shell provides a “platform” below the 2s shell; a non-zero minimum energy underpinning binding in the 2s square. And it appears at least from the 1s and 2s examples that nuclides with full shells are “diagonal” tensor components and all others are off diagonal. The see-saw for 2s is elevated so its bottom is at the top of the is see-saw.

It is also important to note that as we consider much heavier nuclides—and ⁵⁶Fe is the best example—even more of the energy that binds quarks together is released from all the nucleons. For ⁵⁶Fe, calculating from the discussion prior to (4.8), the unused U binding energy contributed by all 56 nucleons totals only 0.00082662u. But in FIG. 6 we saw that 0.00709663u of the ⁴He binding energy is unused. Much of this, therefore, is clearly used by the time one arrives at ⁵⁶Fe. So, almost all the binding energy that is reserved for quark confinement for lighter nuclides becomes released to bind together heavier nuclides, with peak utilization at ⁵⁶Fe. That is, by the time an ⁵⁶Fe nuclide has been fused together, much of the binding energy previously reserved in the 1s and 2s shells to confine quarks has been released, and this contributes to overall binding for the heavier nuclides. One may thus think of the unused binding energy in lighter nuclides as a “reservoir” of energy that will be called upon for binding together heavier nuclides. For nuclides heavier than ⁵⁶Fe, the used-to-available percentage, cf. FIG. 1, tacks downwards again, and more energy is channeled back into quark confinement and less into nuclear binding. So while quark confinement is “bent” to the limit at ⁵⁶Fe, with almost all latent binding energies see-sawed into nucleon binding rather than quark confinement, quark confinement can never be “broken.”

Finally, before turning to ³He in the next section, let us comment briefly on experimental errors. The prediction of ₂⁴B_{0Predicted}=0.030379212155u for the alpha in (5.1), in contrast to ₂⁴B₀=0.030376586499u from the empirical data, is an exact match in AMU through the fifth decimal place, but is still not within experimental errors. Specifically, the alpha mass listed in [12] and shown in FIG. 2 is 4.001506179125(62)u, which is accurate to ten decimal places in AMU. Similarly, the proton mass 1.007276466812(90)u and the neutron mass 1.00866491600(43)u used to calculate ₂⁴B₀ are accurate to ten and nine decimal places respectively in AMU. So the match between ₂⁴B_{0Predicted} and the empirical ₂⁴B₀ to under 3 parts per million is still not within the experimental errors beyond five decimal places, because this energy is known to at least nine decimal places in AMU. Consequently, (5.1) must be regarded as a very close, but still approximate relationship for the observed alpha binding energy. Additionally, because (5.1) is based on (4.1), wherein the mass of the up quark is identified with mᵤ≡₁²B₀=0.002388170100u which is the deuteron binding energy, the question must be considered whether this identification (4.1), while very close, is also still approximate.

Specifically, it is possible to make (5.1) for the alpha into an exact relationship, within experimental errors, if we reduce the up quark mass by exactly ε=0.000000351251415u (in the seventh decimal place), such that:

mᵤ=0.002387818849u≅₁²B₀=0.002388170100u (5.6)

That is, we can make (5.1) for the alpha into an exact relationship if we make (4.1) for the up quark into an approximate relationship, or vice versa, but not both. So, should we do this?

A further clue is provided by (5.5), whereby the empirical ₄⁸B₀/₂⁴B₀≅2 is a close, but still approximate relationship. This close but not exact ratio is not a comparison between a theoretical prediction and empirical observation; it is a comparison between two empirical data points. So this seems to suggest, as one adds more nucleons to a system and makes empirical predictions such as (5.1) based on the up and down quark masses, that higher order corrections (at the sixth decimal place in AMU for alpha and the fifth decimal place in AMU for ₄⁸B₀) will still be needed. So because two-body systems such as the deuteron can generally be modeled nearly-exactly, and because a deuteron will suffer less from “large A=Z+N corrections” than any other nuclide, it makes sense absent evidence to the contrary to regard (4.1) identifying the up quark mass with the deuteron binding energy to be an exact relationship, and to regard (5.1) for the alpha to be an approximate relationship that still requires some tiny correction in the sixth decimal place. Similarly, as we develop other relationships which, in light of experimental errors, are also close but still approximate, we shall take the view that these relationships too, especially given (5.5), will require higher order corrections. Thus, for the moment, we leave (4.1) intact as an exact relationship.

In section 10, however, we shall show why (4.1) is actually not an exact relationship but is only approximate to about 8 parts per ten million AMU. But this will be due not to the closeness of the predicted-versus-observed energies for the alpha particle, but due to our being able to develop a theoretical expression for the difference M(n)−M(p) between the observed masses of the free neutron and the free proton to better than one part per million AMU.

### 6. Prediction of the Helion Nuclide Binding Energy to 4 Parts in 100,000

Now, we turn to the ₂³He nucleus, also referred to as the helion. In contrast with the alpha and the deuteron already examined which are integer-spin bosons, this nucleon is a half-integer spin fermion. Knowing as pointed out after (5.4) that we will “start at the bottom” of the see-saw for this nuclide, and knowing that our toolkit for constructing binding energy predictions is mᵤ, m_{d}, \sqrt{mᵤm_{d}}, it turns out after some trial and error exercises strictly with these energies that we can make a fairly close prediction by setting:

B₀(³He)_{Predicted}=₂³B_{0Predicted}≅2mᵤ+\sqrt{mᵤm_{d}}=0.008323342076u. (6.1)

The empirical energy from FIG. 3, in comparison, is ₂³B₀=0.008285602824u, so that:

₂³B_{0Predicted}−₂³B₀=0.008323342076u−0.008285602824u=0.000037739252u. (6.2)

While not quite as close as (5.2) for the alpha particle, this is still a very close match to just under 4 parts in 100,000 AMU. But does this make sense in light of the outer products (4.9), (4.10)?

If we wish to write (6.1) in the manner of (5.3) and (5.4) in terms of the components of an outer tensor product E_{ABBA}, then referring to (4.9), we find that:

$${}_{2}^{3}{B}{}_{0 Predicted}^{ } = {( 2 π )}^{\frac{3}{2}} {E}_{P 33 AA} = 2 {m}_{u} + \sqrt{{m}_{u} {m}_{d}} = \sqrt{{m}_{u}} ( \sqrt{{m}_{d}} + 2 \sqrt{{m}_{u}} ) . \qquad ( 6.3 )$$

So the expression 2mᵤ+\sqrt{mᵤm_{d}} in (6.1) in fact has a very natural formulation which utilizes the trace \sqrt{m_{d}}+2\sqrt{mᵤ} (AA index summation) of one of the matrices in (4.9), times a \sqrt{mᵤ} taken from the 33 (or possibly 22) diagonal component of the other matrix in (4.9). The use in (6.3) of E_{P} from (4.9) rather than of E_{N} from (4.10), draws from the fact that we need the AA trace to be \sqrt{m_{d}}+2\sqrt{mᵤ}, and not \sqrt{mᵤ}+2\sqrt{m_{d}} as would otherwise occur if we used (4.10). So here, the empirical data clearly causes us to use E_{P} from the proton matrix in (4.9) rather than E_{N} from the neutron matrix in (4.10). We also note that physically, ³He has one more proton than neutron. This is a third data point in the Yang-Mills tensor for nuclear binding.

### 7. Prediction of the Triton Nuclide Binding Energy to 3 Parts in One Million, and the Neutron Minus Proton Mass Difference to 7 Parts in Ten Million

Now we turn to the ₁³H triton nuclide, which as shown in FIG. 3, has a binding energy ₁³B₀=0.009105585412u, and as discussed following (5.4), is a “bottom to top” nuclide. As with the alpha and the helion, we use the energies from components of the outer products E_{ABCD}, see again (4.9) to (4.11). However, following careful trial and error consideration of all possible combinations, there is no readily-apparent combination of mᵤ, m_{d}, \sqrt{mᵤm_{d}} together with mₑ and factors of

$${( 2 π )}^{\frac{3}{2}}$$

which yield a close match to well under 1 percent, to ₁³B₀=0.009105585412u, which is the observed ₁³H binding energy.

But all is not lost, and much more is found: When studying nuclear data, there are two interrelated ways to formulate that data. First, is to look at binding energies as we have done so far. Second, is to look at mass excess. The latter formulation, mass excess, is very helpful when studying nuclear fusion and fission processes, and as we shall now see, it is this approach that enables us to match up the empirical binding data for the triton to the mᵤ, m_{d}, \sqrt{mᵤm_{d}}, mₑ and factors of

$${( 2 π )}^{\frac{3}{2}}$$

that we have already successfully employed for the deuteron, alpha, and helion. As a tremendous bonus, we will be able to derive a strictly theoretical expression for the observed, empirical difference:

M(n)−M(p)=₀¹M−₁¹M=0.001388449188u (7.1)

between the free, unbound neutron mass M(n)=1.008664916000u and the free, unbound proton mass M(p)=1.007276466812u, see FIG. 2.

The derivation of the ³He binding energy and the neutron minus proton mass difference is somewhat involved, and so is detailed in the Appendix. But the results are as follows: For the neutron minus proton mass difference, in (A15), also using (1.11), we obtain:

$${[ M ( n ) - M ( p ) ]}_{Predicted} = {m}_{u} - {m}_{e} - 2 \sqrt{{m}_{μ} {m}_{d}} \text{/} {( 2 π )}^{\frac{3}{2}} = {m}_{u} - ( 3 {m}_{d} + 2 \sqrt{{m}_{μ} {m}_{d}} - 3 {m}_{u} ) \text{/} {( 2 π )}^{\frac{3}{2}} = 0.001389166099 u \qquad ( 7.2 )$$

which differs from the empirical (7.1) by a mere 0.000000716911u, or just over seven parts per ten million! And for the ³He binding energy in (A17), we use the above to help obtain:

$${{B}_{0} ( {}^{3} H )}_{Predicted} = {}_{1}^{3}{B}{}_{0 Predicted}^{ } = 4 {m}_{u} - 2 \sqrt{{m}_{μ} {m}_{d}} \text{/} {( 2 π )}^{\frac{3}{2}} = 0.009102256308 u \qquad ( 7.3 )$$

which differs from ₁³B₀=0.009105585412u, the empirical value in FIG. 3, by merely 0.000003329104u, or just over 3 parts per million.

A theoretical tensor expression for (7.3) using components of an outer product E_{ABBA} as in (5.3), (5.4) and (6.3), may be written as:

$${}_{1}^{3}{B}{}_{0 Predicted}^{ } = {( 2 π )}^{\frac{3}{2}} ( {E}_{P 2222} + {E}_{P 2233} + {E}_{P 3322} + {E}_{P 3333} ) - {E}_{P 1122} - {E}_{P 1133} = 4 {m}_{u} - 2 \sqrt{{m}_{μ} {m}_{d}} \text{/} {( 2 π )}^{\frac{3}{2}} \qquad ( 7.4 )$$

As earlier noted following (5.4), there will be some flexibility in these tensor component assignments until we develop a wider swathe of binding energies beyond the “1s square” and start to discern the wider patterns.

With the foregoing, we have now reached our goal of deducing precise theoretical expressions for all of the is binding energies, solely as a function of elementaryfermion masses. In the process, we have also deduced a like-expression for the neutron-proton mass difference!

From here, after consolidating our binding energy results and expressing them as mass excess in Section 8, we examine the solar fusion cycle in Section 9, including possible technological implications of these results for catalyzing nuclear fusion. In Section 10 we again focus on experimental errors as we did at the end of Section 5, and explain why (7.2) should be taken as an exact theoretical relationship with the quark masses and binding energies then slightly recalibrated.

8. Mass Excess Predictions

Let us now aggregate some of the results so far, as well as those in the Appendix. First of all, let us draw on (A4), and use (A14) and the neutron minus proton mass difference (7.2) to rewrite (A4) as:

$${}_{1}^{3}{M}{}_{Predicted}^{ } = M ( p ) + 2 M ( n ) - 4 {m}_{u} + 2 \sqrt{{m}_{μ} {m}_{d}} \text{/} {( 2 π )}^{\frac{3}{2}} . \qquad ( 8.1 )$$

Specifically, we have refashioned (A4) to include one proton mass and two neutron masses, because the ₁³H triton nuclide in fact contains one proton and two neutrons. Thus,

$$- 4 {m}_{u} + 2 \sqrt{{m}_{μ} {m}_{d}} \text{/} {( 2 π )}^{\frac{3}{2}}$$

represents a theoretical value of the mass excess of two free neutrons and one free proton with M(p)+2M(n) over the mass they possess when fused into a triton, expressed via a negative number as a fusion mass loss. This is equal in magnitude and opposite in sign to binding energy (7.3).

Similarly for helium nuclei, first we use (A5) to write:

₂³B₀=2·₁¹M+₀¹M−₂³M=2M(p)+M(n)−₂³M. (8.2)

We then place ₂³M on the left and use (6.1) to write:

₂³M=2M(p)+M(n)−2mᵤ−\sqrt{mᵤm_{d}}. (8.3)

Here, −2mᵤ−\sqrt{mᵤm_{d}} is the fusion mass loss for the helion, also equal and opposite to binding energy (6.1).

Next, we again use (A₅) to write:

₂⁴B₀=2·₁¹M+2·₀¹M−₂⁴M=2·M(p)+2·M(n)−₂⁴M. (8.4)

Combining this with (5.1) then yields:

$${}_{2}^{4} M = 2 M ( p ) + 2 M ( n ) - 6 {m}_{u} - 6 {m}_{d} + ( 10 {m}_{d} + 10 {m}_{u} + 16 \sqrt{{m}_{u} {m}_{d}} ) \text{/} {( 2 π )}^{\frac{3}{2}} + 2 \sqrt{{m}_{u} {m}_{d}} . \qquad ( 8.5 )$$

The fusion mass loss for the alpha—much larger than for the other nuclides we have examined—is given by the lengthier terms after 2M(p)+2M(n). Again, this is equal and opposite to the alpha binding energy in (5.1), with terms consolidated above.

Finally, from (4.1), via (A₅), it is easy to deduce for the deuteron, that:

₁²M≡M(p)+M(n)−mᵤ, (8.6)

with a mass loss represented simply by −mᵤ, again, equal and opposite the binding energy (4.1).

### 9. A Theoretical Review of the Solar Fusion Cycle, and a Possible Approach to Catalyzing Fusion Energy Release

As a practical exercise, let us now use all of the foregoing results to theoretically examine the solar fusion cycle. The first step in this cycle is (A10) for the fusion of two protons into a deuteron. It is from (A10) that we determine that an energy (A11) is released in this fusion, which energy, in light of (A13), now becomes:

$$Energy ( {}_{1}^{1} H + {}_{1}^{1} H \to {}_{1}^{2} H + {e}^{+} + v + Energy ) = 2 \sqrt{{m}_{μ} {m}_{d}} \text{/} {( 2 π )}^{\frac{3}{2}} = 0.000451141003 u . \qquad ( 9.1 )$$

This equates to 0.420235 MeV which is a well-known energy in solar fusion as is noted in the Appendix. The positron annihilates with an electron e⁺+e⁻→γ+γ to produce an additional 2mₑ worth of energy as well.

The second reaction in the solar fusion cycle is:

₁²H+₁¹H→₂³He+Energy (9.2)

wherein deuterons produced in (9.1) fuse with protons to produce helions. We write this in terms of masses as:

Energy=₁²M+₁¹M−₂³M. (9.3)

The proton mass is ₁¹M, and these other two masses have already been found, respectively, in (8.6) and (8.3). Thus, (9.3) may be reduced to:

Energy(₁²H+₁¹H→₂³He+Energy)=mᵤ+\sqrt{mᵤm_{d}}=0.005935171976u (9.4)

which equates to 5.528577 MeV, also a well-known energy in the study of solar fusion.

The final step in this cycle fuses two helions together to yield alpha particles plus protons, which protons then are available to repeat the cycle starting at (9.1):

₂³He+₂³He→₂⁴He+₁¹H+₁¹H+Energy. (9.5)

The mass equivalent of this relationship is as follows:

Energy=₁²M+₂³M−₂⁴M−₁¹M−₁¹M. (9.6)

Here we again make use of ₁¹M=M(p), together with (8.3) and (8.5) to write:

$$Energy ( {}_{2}^{3} He + {}_{2}^{3} He \to {}_{2}^{4} He + {}_{1}^{1} H + {}_{1}^{1} H + Energy ) = 2 {m}_{u} + 6 {m}_{d} - 4 \sqrt{{m}_{u} {m}_{d}} - ( 10 {m}_{d} + 10 {m}_{u} + 16 \sqrt{{m}_{u} {m}_{d}} ) \text{/} {( 2 π )}^{\frac{3}{2}} = 0.013732528003 u . \qquad ( 9.7 )$$

This equates to 12.791768 MeV, which is also a well-known energy from solar fusion studies.

Now, as is well known (see, e.g. [14]), the reaction (9.4) must occur twice to produce the two ₂³He which are input to (9.7), and the reaction (9.1) must occur twice to produce the two ₁²H which are in turn input to (9.4). So pulling this all together from (9.1), (9.4), (9.7) and e⁺+e⁻→γ+γ, we may express the entire solar fusion cycle in (9.8) below. In the top line below, we show in detail each energy release from largest to smallest, followed by the electron and neutrino emissions. In the second line we segregate in separate parenthesis, each contribution shown in the top line, including the neutrino mass which is virtually zero. In the third line, we consolidate terms. In the final line we use (1.11) to eliminate the electron rest mass:

$$Energy ( 4 \cdot {}_{1}^{1} H + 2 {e}^{-} \to {}_{2}^{4} He + γ ( 12.79 MeV ) + 2 γ ( 5.52 MeV ) + 2 γ ( 0.42 MeV ) + 4 γ ( e ) + 2 v ) = ( 2 {m}_{u} + 6 {m}_{d} - 4 \sqrt{{m}_{u} {m}_{d}} - \frac{10 {m}_{d} + 10 {m}_{u} + 6 \sqrt{{m}_{u} {m}_{d}}}{{( 2 π )}^{\frac{3}{2}}} ) + 2 ( {m}_{u} + \sqrt{{m}_{u} {m}_{d}} ) + 2 ( 2 \frac{\sqrt{{m}_{μ} {m}_{d}}}{{( 2 π )}^{\frac{3}{2}}} ) + 4 ( {m}_{e} ) + 2 ( {m}_{v} ) = 4 {m}_{u} + 6 {m}_{d} + 4 {m}_{e} - 2 \sqrt{{m}_{u} {m}_{d}} - ( 10 {m}_{d} + 10 {m}_{u} + 12 \sqrt{{m}_{u} {m}_{d}} ) \text{/} {( 2 π )}^{\frac{3}{2}} = 4 {m}_{u} + 6 {m}_{d} - 2 \sqrt{{m}_{u} {m}_{d}} + ( 2 {m}_{d} - 22 {m}_{u} - 12 \sqrt{{m}_{u} {m}_{d}} ) \text{/} {( 2 π )}^{\frac{3}{2}} = 26.733389 MeV . \qquad ( 9.8 )$$

The above shows at least two things. First, the total energy of approximately 26.73 MeV known to be released during solar fusion is expressed entirely in terms of a theoretical combination of the up and down (and optionally electron) masses, with nothing else added! This portends the ability to do the same for other types of fusion and fission, once the analysis of this paper is extended to larger nuclides Z>2, N>2.

Secondly, because the results throughout this paper seem to validate modeling nucleons as resonant cavities with energies released or retained based on the masses of their quark contents, this tells us how to catalyze “resonant fusion” which may make fusion technology more practical, because (9.8) tells us the precise resonances that go into releasing the total 26.73 MeV of energy in the above. In particular, if one wanted to create an artificial “sun in a box,” one would be inclined to amass a fuel store of hydrogen, and subject that hydrogen fuel store to gamma radiation at or near the specified discrete energies that appear in (9.8), so as to facilitate resonant cavity vibrations at or near the energies required for fusion to occur. Specifically, one would bathe the hydrogen fuel store with gamma radiation at one or more of the following energies/frequencies in combination, some without, and some with, the Gaussian

$${( 2 π )}^{\frac{3}{2}}$$

divisor (we convert to

$$wavelengths via 1 F = 1 \text{/} ( 197 MeV ) ) \text{:}$$

$$\begin{matrix}6 {m}_{d} = 29.44 MeV = 6.69 F \\ {m}_{u} = 2.22 MeV = 88.56 F \\ 2 {m}_{u} ( harmonic ) = 4.45 MeV = 44.28 F \\ 4 {m}_{u} ( harmonic ) = 8.90 MeV = 22.14 F \\ \sqrt{{m}_{u} {m}_{d}} = 3.30 MeV = 59.62 F \\ 2 \sqrt{{m}_{u} {m}_{d}} ( harmonic ) = 6.61 MeV = 29.81 F \\ 4 \sqrt{{m}_{u} {m}_{d}} ( harmonic ) = 13.22 MeV = 14.91 F & ( 9.9 ) \\ 2 {m}_{d} \text{/} {( 2 π )}^{\frac{3}{2}} = 0.62 MeV = 316.15 F \\ 10 {m}_{d} \text{/} {( 2 π )}^{\frac{3}{2}} = 3.12 MeV = 63.23 F \\ 10 {m}_{u} \text{/} {( 2 π )}^{\frac{3}{2}} = 1.41 MeV = 139.47 F \\ 22 {m}_{u} \text{/} {( 2 π )}^{\frac{3}{2}} = 3.10 MeV = 63.40 F \\ 2 \sqrt{{m}_{u} {m}_{d}} \text{/} {( 2 π )}^{\frac{3}{2}} = 0.42 MeV = 469.53 F \\ 4 \sqrt{{m}_{u} {m}_{d}} \text{/} {( 2 π )}^{\frac{3}{2}} ( harmonic ) = 0.84 MeV = 234.77 F \\ 12 \sqrt{{m}_{u} {m}_{d}} \text{/} {( 2 π )}^{\frac{3}{2}} ( harmonic ) = 2.52 MeV = 78.26 F \\ 16 \sqrt{{m}_{u} {m}_{d}} \text{/} {( 2 π )}^{\frac{3}{2}} ( harmonic ) = 3.36 MeV = 58.69 F & ( 9.10 )\end{matrix}$$

In the above, we have explicitly shown each basic frequency/energy which appears in the second, third or fourth lines of (9.8) as well as harmonics that appear in (9.8). Also, one should consider frequencies based on the electron mass and its wavelength.

So, what do we learn? If the nucleons are regarded as resonant cavities and the energies at which they fuse depend on the masses of their current quarks as is made very evident by (9.8), and given the particular energies and harmonics highlighted in (9.9) and (9.10), the idea for harmonic fusion is to subject a hydrogen fuel store to high-frequency gamma radiation proximate at least one of the resonant frequencies/energies/wavelengths (9.9), (9.10), with the view that these harmonic oscillations will catalyze fusion by perhaps reducing the amount of heat is required. In present-day approaches, fusion reactions are triggered using heat generated from a fission reaction, and one goal would be to reduce or eliminate this need for such high heat and especially the need for any fissile trigger. That is, we at least posit the possibility—subject to laboratory testing to confirm feasibility—that applying the harmonics (9.9), (9.10) to a hydrogen fuel store can catalyze fusion better than known methods, with less heat and ideally little or no fission trigger required.

Of course, these energies in (9.9), (9.10) are very high, and aside from the need to produce this radiation via known methods such as, but not limited to, Compton backscattering and any other methods which are known at present or may become known in the future for producing gamma radiation, it would also be necessary to provide substantial shielding against the health effects of such radiation. The highest energy/smallest wavelength component, ⁶m_{d}=29.44 MeV=6.69F, is extremely energetic and would be very difficult to shield (and to produce), but this resonance arises from (9.8) which is for the final ₂³He+₂³He+→₂⁴He+₁¹H+₁¹H+Energy portion of the solar fusion cycle. If one were to forego this portion of the fusion cycle and focus only on catalyzing ₁¹H+₁¹H→₁²H+e⁺+ν+Energy to fuse protons into deuterons, then the only needed resonance is

$$2 \sqrt{{m}_{u} {m}_{d}} \text{/} {( 2 π )}^{\frac{3}{2}} = 0.42 MeV = 469.53 F .$$

Not only is this easiest to produce because its energy is the lowest of all the harmonics in (9.9) and (9.10), but it is the easiest to shield and the least harmful to humans.

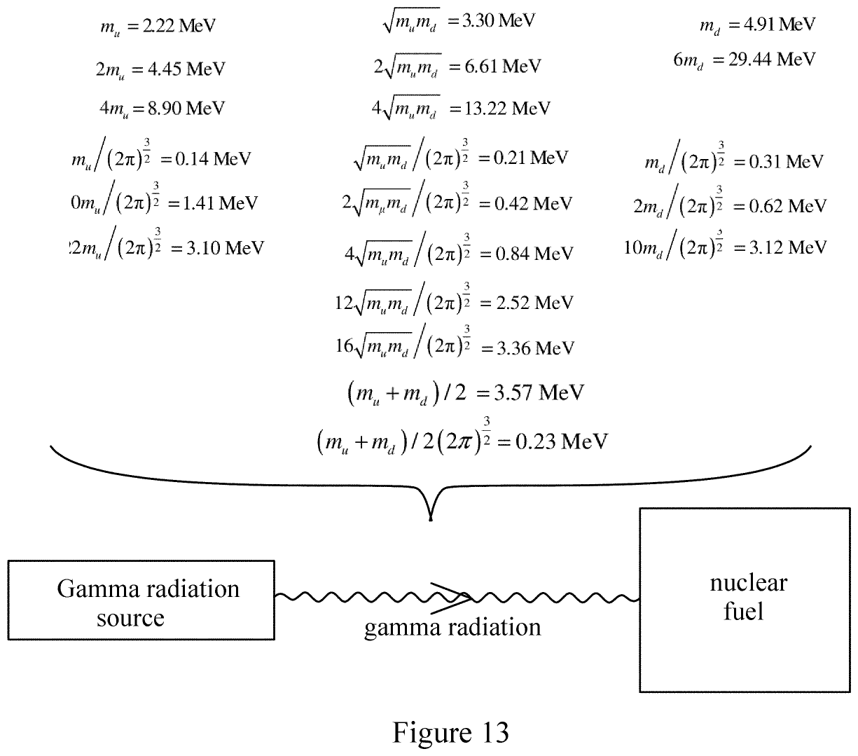

Certainly, a safe, reliable and effective method and associated hardware for producing energy via fusing protons into deuterons via reaction (9.1), and perhaps further fusing protons and deuterons into helions as in (9.4), by introducing at least one of the harmonics (9.9), (9.10) and illustrated by FIG. 13 into a hydrogen fuel store perhaps in combination with other known fusion methods, while insufficient to create the “artificial sun” modeled above if one foregoes the final alpha production in (9.7), would nonetheless represent a welcome, practical addition to sources of energy available for all forms of peaceful human endeavor.

### 10. Recalibration of Masses and Binding Energies Via an Exact Relationship for the Neutron Minus Proton Mass Difference

At the end of Section 5, we briefly commented on experimental errors. As between the alpha particle and the deuteron, we determined it was more sensible to associate the binding energy of the deuteron precisely with the mass of the up quark, thus making the theoretically-predicted alpha binding energy a close but not exact match to its empirically observed value, rather than vice versa. But the prediction in (7.2) for the neutron minus proton mass difference to just over 7 parts in ten million is a very different matter. This is even more precise by half an order of magnitude than the alpha mass prediction, and given the fundamental nature of the relationship for M(n)−M(p) which is central to beta-decay, we now argue why (7.2) should be taken as an exact relationship with all other relationships recalibrated accordingly, so that now the up quark mass will still be very close to the deuteron binding energy, but will no longer be exactly equal to this energy.

First of all, as just noted, the M(n)−M(p) mass difference is the most precisely predicted relationship of all the relationships developed above, to under one part per million AMU. Second, we have seen that all the other nuclear binding energies we have predicted are close approximations, but not exact, and would expect that this inexactitude will grow larger as we consider even heavier nuclides, see, for example, Be as discussed in FIGS. 7 and 8. So, rhetorically speaking, why should the deuteron be so “special,” as opposed to any other nuclide, such that it gets to have an “exact” relation to some combination of elementary fermion masses while all the other nuclides do not? Yes, the deuteron should come closest to the theoretical prediction (namely the up mass) of all nuclides, because it is the smallest composite nuclide. Closer than all other nuclides, but still not exact. After all, even the A=2 deuteron should suffer from “large A=Z+N” effects even if only to the very slightest degree of parts per ten million. Surely it should suffer these effects more than the A=1 proton or neutron.

Third, if this is so, then we gain a new footing to be able to consider how the larger nuclides differ from the theoretical ideal, because even for this simplest A=2 deuteron nuclide, we will already have a precisely-known deviation of the empirical data from the theoretical prediction, which we may perhaps be able to extrapolate to larger nuclides for which this deviation certainly becomes enhanced. That is, the deviations between predicted and empirical binding data for all nuclides becomes itself a new data set to be studied and hopefully explained, thus perhaps providing a foundation to theoretically eliminate even this remaining deviation.

Fourth, in a basic sense, the deuteron, which is one proton fused to one neutron, has a mass which is a measure of “neutron plus proton,” while M(n)−M(p) is a measure of “neutron minus proton.” So we are really faced with a question of what gets to be exact and what must be only approximate: n+p, or n−p? Seen in this light, M(n)−M(p) measures an energy feature of neutrons and protons in their native, unbound states, as separate and distinct entities, and thus characterizes these elemental nucleons in their purest form. In the deuteron, by contrast, we have a two-body system which is less-pure. So if we must choose between one or the other, we should choose M(n)−M(p) to be exact relationship, with the chips falling where they may for all other relationships, including the deuteron binding energy. Now, the deuteron binding energy is relegated to the same “approximate” status as that of all other compound poly-nuclides, and only the proton and neutron as distinct mono-nuclides get to enjoy “exact” status.

Let us therefore do exactly that. Specifically, for the reasons given above, we now abandon our original postulate that the up quark mass is exactly equal to the deuteron binding energy, and in its place we substitute the postulate that (7.2) is an exact relationship, period. That is, we now define, by substitute postulate, that the exact relationship which drives all others, is:

$${[ M ( n ) - M ( p ) ]}_{Observed} = 0.001388449188 u ≡ {m}_{u} - ( 3 {m}_{d} + 2 \sqrt{{m}_{μ} {m}_{d}} - 3 {m}_{u} ) \text{/} {( 2 π )}^{\frac{3}{2}} = {[ M ( n ) - M ( p ) ]}_{Predicted} . \qquad ( 10.1 )$$

Then, we modify all the other relationships accordingly.

The simplest way make this adjustment is to modify the original postulate (4.1) to read:

Mᵤ≡₁²B₀+ε=0.002388170100u+ε, (10.2)

and to then substitute this into (10.1) with ε taken as very small but unknown. This is most easily solvable numerically, and it turns out that ε=−0.000000830773u, which is just over 8 parts in ten million u. That is, substituting ε=−0.000000830773u into (10.2), then using (1.11) to derive the down quark mass, then substituting all of that into (10.1), will make (10.1) exact through all twelve decimal places (noting that experimental errors are in the last two places).

As a consequence, the following critical mass/energies developed earlier become nominally adjusted starting at the sixth decimal place in AMU, and now become (contrast (4.1), (4.3), (4.4), (4.5) and (4.6) respectively):

$$\begin{matrix} {m}_{u} = 0.002387339327 u , & ( 10.3 ) \\ {m}_{d} = 0.005267312526 u , & ( 10.4 ) \\ \sqrt{{m}_{u} {m}_{d}} = 0.003546105236 u , & ( 10.5 ) \\ {B}_{P} = 2 {m}_{u} + {m}_{d} - ( {m}_{d} + 4 \sqrt{{m}_{u} {m}_{d}} + 4 {m}_{u} ) \text{/} {( 2 π )}^{\frac{3}{2}} = 0.008200606481 u , & ( 10.6 ) \\ {B}_{N} = 2 {m}_{d} + {m}_{u} - ( {m}_{u} + 4 \sqrt{{m}_{u} {m}_{d}} + 4 {m}_{d} ) \text{/} {( 2 π )}^{\frac{3}{2}} = 0.010531999771 u . & ( 10.7 )\end{matrix}$$

Additionally, this will slightly alter the binding energies that were predicted earlier. The new results are as follows (contrast (5.1), (6.1) and (7.3) respectively):

₂⁴B_{0Predicted}=0.030373002032u, (10.8)

₂³B_{0Predicted}=0.008320783890u, (10.9)

₁³B_{0Predicted}=0.009099047078u, (10.10)

and, via (10.3) and this adjustment of masses,

₁²B_{0Predicted}=mᵤ=0.002387339327u. (10.11)

In (10.11), we continue to regard the predicted deuteron binding energy ₁²B_{0Predicted} to be equal to the mass of the up quark, but because the mass of the up quark has now been slightly changed because of our substitute postulate, the observed energy, which is ₁²B₀=0.002388170100u, will no longer be exactly equal to the predicted energy (10.11). Rather, we will now have ₁²B₀≠₁²B_{0Predicted}, with a difference of less than one part per million AMU. The precise, theoretical exactitude now belongs to the M(n)−M(p) difference in (10.1). As a bonus, the up and down quark masses now become known to ten-digit precision in AMU, with experimental errors in the 11th and 12th digits, which is inherited from the precision with which the electron, proton and neutron masses are known.

One other point is very much worth noting. With an entirely theoretical, exact expression now developed for the neutron minus proton mass difference via (10.1), we start to target the full, dressed proton and neutron masses themselves. Specifically, it would be extremely desirable to be able to specify the proton and neutron masses as a function of the elementary up, down, and electron fermion masses, as we have here with binding energies. Fundamentally, by elementary algebraic principles, taking each of the proton and neutron masses as an unknown, we can deduce these masses if we have can find two independent equations, one of which contains an exact expression related to the sum of these masses, and the other which contains an exact expression related to the difference of these masses. Equation (10.1) achieves the first half of this objective: for the first time, we now have an exact theoretical expression for the difference between these masses. But we still lack an independent expression related to their sum.

Every effort should now be undertaken to find another relationship related to the sum of these masses. In all likelihood, that relationship, which must inherently explain the natural ratio just shy of 1840 between the masses of the nucleons and the electron, and/or similar ratios of about 420 and 190 involving the up and down masses, will need to emerge from an examination of the amended t'Hooft Lagrangian terms in (3.10) which we have not yet explored, particularly those terms which involve the vacuum Φ. While analyzing binding energies and mass excess and nuclear reactions as we have done here is a very valuable exercise, the inherent limitation is that all of these analyses involve differences. What is needed to obtain the “second” of the desired two independent equations, are sums, not differences (Note: the author lays the GUT foundation for, and then tackles this very problem, in two separate papers published in this same special issue of JMP).

11. Summary and Conclusion for the ²H, ³H, ³He and ⁴He Nuclides

Summarizing our results here, we now have the following theoretical predictions for the binding energies in FIG. 3, with isobar lines shown, and with equation numbers for result referenced for convenience: see FIG. 9.

The mass loss (negative mass excess) discussed in Section 8 which was very helpful to the exercise of examining the solar fusion cycle in Section 9, is simply the negative (positive) of what is shown in FIG. 9. Having just considered the M(n)−M(p) mass difference, it is useful to also look at the difference between the ³H and ³He isobars, A=3 in the above. Given that ³He is the stable nuclide and that ³H undergoes β⁻ decay into ³He, we may calculate the predicted difference in binding energies to be:

$${[ {}_{2}^{3}{B}{}_{0}^{ } - {}_{1}^{3}{B}{}_{0}^{ } ]}_{Predicted} = - 2 {m}_{u} + ( 1 + 2 \text{/} {( 2 π )}^{\frac{3}{2}} ) \sqrt{{m}_{u} {m}_{d}} = - 0.000778263189 u \qquad ( 11.1 )$$

The empirical difference −0.000819982588 u differs from the predicted difference by 0.000041719399u. It is helpful to contrast the above to (the negative of) (10.1) which represents the most elementary β⁻ decay of a neutron into a proton. Similar calculations may be carried out as between the isotopes and isotones in FIG. 9.

The numerical values of these theoretical binding energies in FIG. 9, in AMU, using the recalibrated (10.8) through (10.11), are now predicted to be: see FIG. 10.

These theoretical predictions should be carefully compared to the empirical values in FIG. 3. Indeed, subtracting each entry in FIG. 3 from each entry in FIG. 10, we summarize our results for all of the 1s nuclides in FIG. 11.

FIG. 11 shows how much each predicted binding energy differs from observed empirical binding energies. As has been reviewed, every one of these predictions is accurate to under four parts in 100,000 AMU (³He has the largest difference). Specifically: we have now used the thesis that baryons are resonant cavity Yang-Mills magnetic monopoles with binding energies reflective of their current quark masses to predict the binding energies of the ⁴He alpha to under four parts in one million, of the ³He helion to under four parts in 100,000 and of the ³H triton to under seven parts in one million. Of special import, we have exactly related the neutron minus proton mass difference—which is central to beta decay—to the up and down quark masses. This in turn enables us via the substitute postulate of Section 10 to predict the binding energy for the ²H deuteron most precisely of all, to just over 8 parts in ten million.

These energies as well as the neutron minus proton mass difference do not appear to have ever before been theoretically explained with such accuracy, and each of the foregoing energy predictions is mutually-independent from all the others. So even if any one prediction is thought to be nothing more than coincidence, the odds against five independent predictions on the order of 1 part in 10⁵ or better being mere coincidence exceed 10²⁵ to 1. This is not mere coincidence!

This leads to the conclusion that the underlying thesis that baryons generally, and neutrons and protons especially, are resonant cavity Yang-Mills magnetic monopoles with binding energies determined by their current quark masses, provides the strongest theoretical explanation to date of what baryons are, and of how protons and neutrons confine their quarks and bind together into composite nuclides. The theory of nuclear binding first developed in [1] and further amplified here, establishes a basis for finally “decoding” the abundance of known data regarding nuclear masses and binding energies, and by viewing the proton and neutron as resonant cavities, may lay the foundation for technologically realizing the theoretical promise of nuclear fusion.

Finally, because nucleons are now understood to be non-Abelian magnetic monopoles, this also means that atoms themselves comprise core magnetic charges (nucleons) paired with orbital electric charges (electrons), with the periodic table itself thereby revealing an electric/magnetic symmetry of Maxwell's equations which has heretofore gone unrecognized in the 140 years since Maxwell first published his Treatise on Electricity and Magnetism.

12. Equivalent Development of the ²H, ³H, ³He and ⁴He Binding Energies and the Neutron Minus Proton Mass Difference Using Koide Mass Matrices

In the foregoing development, we have used the thesis that baryons are Yang-Mills magnetic monopoles to develop binding and fusion energies of the ²H, ³H, ³He and ⁴He nuclides and obtain the neutron minus proton mass difference. However, it is possible to employ the Koide mass formula [20], [21] to equivalently and independently derive the very same results. The benefit of this is that this provides a path for similarly developing a scientific foundation for mapping binding and fusion energies for additional heavier nuclides, such as ⁶Li, ⁷Li, ⁷Be, ⁸Be, ¹⁰B, ⁹Be, ¹⁰Be, ¹¹B, ¹¹C, ¹²C and ¹⁴N which will be developed here. This will enable us to apply the technological disclosures in section 9 of applicant's “resonant fusion” technology to specific fusion reactions involving all of these heavier nuclides.

The Koide mass formula provides an extremely precise relationship among the electron (e), muon (μ) and tauon (τ) lepton masses, even though its origins are not fully understood even three decades later. If one defines a diagonalized “Koide matrix” K as:

$${K}_{AB} ≡ ( \begin{matrix}\sqrt{{m}_{1}} & 0 & 0 \\ 0 & \sqrt{{m}_{2}} & 0 \\ 0 & 0 & \sqrt{{m}_{3}}\end{matrix} ) \qquad ( 12.1 )$$

and assigns m₁=mₑ, m₂=m_{μ}, and m₃=m_{τ} to this mass triplet, then Koide's relationship may be written using products of traces (TrK)² and traces of products TrK², as:

$$R = \frac{{( \sqrt{{m}_{e}} + \sqrt{{m}_{μ}} + \sqrt{{m}_{τ}} )}^{2}}{{m}_{e} + {m}_{μ} + {m}_{τ}} = \frac{{( TrK )}^{2}}{{TrK}^{2}} = \frac{{K}_{AA} {K}_{BB}}{{K}_{AB} {K}_{BA}} ≅ \frac{3}{2} . \qquad ( 12.2 )$$

Using mₑ=0.510998928±0.000000011 MeV, m_{μ}=105.6583715±0.0000035 MeV and m_{τ}=1776.82±0.16 MeV from the 2012 PDG data [22], we find using mean experimental mass values that this ratio R=1.500022828, which differs from 3/2 by just over two parts per hundred thousand.

Protons and neutrons and other baryons are known to contain what is also a triplet of quarks, each of which is understood to have an associated “current quark mass.” For the up (u) and down (d) quarks, PDG most recently values these masses at m_{d}=4.8_{-0.3}^{+0.7} MeV and mᵤ=2.3_{-0.5}^{+0.7} Mev. [23]

In this section we shall now see how the Koide matrix (12.1) can also be used to formulate the earlier-presented relationships for the binding and related fusion-release energies of the ²H, ³H, ³He and ⁴He (1s shell) light nuclides as well as for the neutron (N) minus proton (P) mass difference which all comport extremely closely to what is observed experimentally, each independently, and all exclusively as a function of the up and down current quark masses. In all cases, the accuracy attained is even better than that of Koide's original relationship (12.2).

To use a Koide matrix K_{P} akin to (12.1) for a proton (duu), we simply assign the Koide masses to the quark masses via m₁=m_{d}, m₂=m₃=mᵤ. For the neutron (udd) we make alike assignment m₁=mᵤ, m₂=m₃=m_{d} to form a K_{N}. Thus:

$${K}_{PAB} ≡ ( \begin{matrix}\sqrt{{m}_{d}} & 0 & 0 \\ 0 & \sqrt{{m}_{u}} & 0 \\ 0 & 0 & \sqrt{{m}_{u}}\end{matrix} ) ; {K}_{NAB} ≡ ( \begin{matrix}\sqrt{{m}_{u}} & 0 & 0 \\ 0 & \sqrt{{m}_{d}} & 0 \\ 0 & 0 & \sqrt{{m}_{d}}\end{matrix} ) . \qquad ( 12.3 )$$

The non-zero components of the (3×3)(3×3) outer products K_{P}⊗K_{P}=K_{PAB}K_{PCD} and K_{N}⊗K_{N}=K_{N AB}K_{N CD} are mᵤ, m_{d} and \sqrt{mᵤm_{d}}. It is easily deduced as well that the product of traces:

(TrK_{P})²=K_{PAA}K_{PBB}=m_{d}+4\sqrt{mᵤm_{d}}+4mᵤ, (12.4)

(TrK_{N})²=K_{NAA}K_{NBB}=mᵤ+4\sqrt{mᵤm_{d}}+4m_{d}, (12.5)

and also that the trace of the products:

TrK_{P}²=K_{PAB}K_{PBA}=m_{d}+2mᵤ, (12.6)

TrK_{N}²=K_{NAB}K_{NBA}=mᵤ+2m_{d}. (12.7)

The latter (12.6) and (12.7) specify the sum of current quark masses inside a proton and a neutron and are akin to the denominator in Koide's (12.2). The former (12.4) and (12.5) are akin to the numerator in (12.2). The only difference is the index summation.

It is fruitful to start by subtracting proton trace product (12.4) from neutron trace product (12.5), all divided by (2π)^{1.5}, and to then substitute the PDG values m_{d}=4.8_{-0.3}^{+0.7} Mev and mᵤ=2.3_{-0.5}^{+0.7} MeV. We find:

((TrK_{N})²−(TrK_{P})²)/(2π)^{1.5}=3(m_{d}−mᵤ)/(2π)^{1.5}=0.476_{-0.190}^{+0.228} MeV. (12.8)

We see that the expression 3(m_{d}−mᵤ)/(2π)^{1.5} is the same as (1.11) for the electron rest mass mₑ. Indeed, the electron rest mass mₑ=0.510998928 MeV [22] differs from the above by only about 3%. This is well within the wide experimental error bars which are just over 20% for the down mass and just over 50% for the up mass. Also, the above expresses a difference between some energy number (TrK_{N})² associated with a neutron and a like-energy number (TrK_{P})² associated with a proton. Also, neutrons undergo β⁻ decay into protons by emitting an electron and a virtually-massless antineutrino. Given all of the foregoing, we now introduce a first postulate, with no claims attached for the moment, that (12.8) is actually an exact meaningful relationship among the electron, up and down masses, i.e., that (we also show mₑ in atomic mass units (AMU)):

0.510998928 MeV=0.000548579909u=mₑ≡3(m_{d}−mᵤ)/(2π)^{1.5}. (12.9)

This is indeed the same as (1.11), but on the independent foundation of the Koide matrices. We will now proceed to employ this postulate in other relationships which will offer it either contradiction or support.

Next, we note that the lightest mass in the outer products K_{P}⊗K_{P} and K_{N}⊗K_{N} mentioned following (12.3) is mᵤ=2.3_{-0.5}^{+0.7} MeV. We simultaneously note that the deuteron binding energy B (calculated from nuclide masses in [25]) is B(²H)=2.224566 Mev, which is equal to the up quark mass well within PDG's _{-0.5}^{+0.7} MeV error bars. As a second postulate (also to be tested momentarily, making no present claims), just as we did after (1.11), we regard the up quark mass to be either identical to the deuteron binding energy, i.e.:

mᵤ≡B(²H)=2.224566 MeV=0.002388170100u, (12.10)

or to be very close thereto (we shall in the end show as in section 10 why these actually appear to differ, but by less than 1 part per million AMU). In making this postulate, we actually introduce a broader hypothesis that the binding energies of individual nuclides are directly related to the current masses of the quarks which they contain, and that these binding energies can be constructed solely and exclusively from the outer products K_{P}⊗K_{P} and K_{N} ⊗K_{N}, and specifically, as in the (4.9) to (4.11) “toolkit,” from their traces (12.4) to (12.7), their components mᵤ, m_{d} and \sqrt{mᵤm_{d}}, and in some instances a (2π)^{1.5} divisor.

If both these postulates are true, then (12.9) and (12.10) may be combined to deduce a down quark mass valued at:

$${m}_{d} = {( 2 π )}^{\frac{3}{2}} {m}_{e} \text{/} 3 + {m}_{u} = 4.907244 MeV = 0.005268143299 u , \qquad ( 12.11 )$$

well within PDG's m_{d}=4.8_{-0.3}^{+0.7} MeV error bars. This is the same as (4.3), and together with (12.10), it provides us with up and down quark masses specified at least a million times more accurately than those which are presently-listed by PDG. But are these reliable mass values? Specifically, can we interconnect these two postulated masses, which are well within PDG error bars, with other energies or masses which are empirically-known on an independent basis?

First, using the more precise up and down masses (12.10), (12.11) emerging from postulates (12.9), (12.10), let us calculate the differences ΔE between the energies represented by TrK² in (12.6), (12.7), and those represented by (TrK)² in (12.4), (12.5) divided by (2π)^{1.5}. The results are, which are the same as (1.12) and (1.13), are:

ΔE_{P}≡TrK_{P}²−(TrK_{P})²/(2π)^{1.5}=m_{d}+2mᵤ−(m_{d}+4\sqrt{mᵤm_{d}}+4mᵤ)/(2π)^{1.5}=7.640679 MeV=0.008202607332u, (12.12)

ΔE_{N}≡TrK_{N}²−(TrK_{N})²/(2π)^{1.5}=mᵤ+2m_{d}−(mᵤ+4\sqrt{mᵤm_{d}}+4m_{d})/(2π)^{1.5}==9.812358 MeV=0.010534000622u. (12.13)

We note that the average of these two energies is 8.726519 MeV, and that the binding energies of all but the very lightest and heaviest nuclides are in the range between 8 and 9 MeV per nucleon. As before, these represent the latent binding energies of the proton and neutron. From here, we will carry out calculations in AMU rather than MeV to obtain better experimental precision, due to the “relatively poorly known electronic charge.” [24] In general, we use empirical data drawn from [24] or [25] or, if not available at these sources, from [13].

First we consider the alpha particle, which is the ⁴He nucleus. This has Z=2 protons and N=2 neutrons. If we calculate Z=2 times ΔE_{P} in (12.12) plus N=2 times ΔE_{N} in (12.13) and subtract off 2\sqrt{mᵤm_{d}}, and if we then compare the result to the empirical binding energy B of the alpha particle, we find, identically to (5.2) that:

2·ΔE_{P}+2·ΔE_{N}−2\sqrt{mᵤm_{d}}=0.030379212155u

B(⁴He)=0.030376586499u,

Difference: 2.625656×10⁻⁶u (12.14)

These energies differ from one another by less than 3 parts per million AMU. Keeping in mind that the alpha contains two protons and two neutrons, which together in turn house six up and six down quarks, it is also to be noted that (12.14) is fully symmetric under both P↔N and u↔d interchange.

Next, consider the ³He nucleus, the helion. Here, we form TrK_{P}=\sqrt{m_{d}}+2\sqrt{mᵤ}, multiply this by \sqrt{mᵤ}, and compare to the empirical binding energy B. The result, identical to (6.2), is:

\sqrt{mᵤ}TrK_{P}=2mᵤ+\sqrt{mᵤm_{d}}=0.009323342076u

B(³He)=0.009285602824u.

Difference: 3.7739252×10⁻⁵u (12.15)

These differ by less than 4 parts in 10⁵.

Next, we examine the triton, which is the ³H nucleus. Making use of a (2π)^{1.5} divisor, here we find that:

$$4 {m}_{u} - 2 \sqrt{{m}_{μ} {m}_{d}} \text{/} {( 2 π )}^{\frac{3}{2}} = 0.009102256308 u \\ B ( {}^{3} H ) = 0.009105585412 u \\ Difference \text{:} - 3.329104 \times {10}^{- 6} u . \qquad ( 12.16 )$$

These differ by less than 4 parts in one million, and this is identical to (A18).

Thus far we have been examining binding energies, but let's look at fusion-release energies to see if similar close results obtain. First, consider 2P→²H, the fusion of two protons into a deuteron via ₁¹H+₁¹H→₁²H+e⁺+ν+Energy. Here, with E representing the empirical fusion-release energy, we find that:

$$2 \sqrt{{m}_{μ} {m}_{d}} \text{/} {( 2 π )}^{\frac{3}{2}} = 0.000450424092 u \\ E ( 2 P \to {}^{2} H ) = 0.000451141003 u \\ Difference \text{:} - 7.16911 \times {10}^{- 7} u . \qquad ( 12.17 )$$

The difference here is less just over 7 parts in ten million, and this is identical to (A13).

Now consider ²H+P→³H, which entails fusing a deuteron and proton into a triton via ₁¹H+₁²H→₁³H+e⁺+ν+Energy. Here, we find, equivalently to (A3), that:

2mᵤ=0.004776340200u

E(²H+P→³H)=0.004780396215u.

Difference: −4.046015×10⁻⁶u (12.18)

This is a difference just over 4 parts per million.

In fact, the ³H binding energy (12.16) is not independent from (12.17) and (12.18); rather it is derived from (12.17) and (12.18) as shown in the Appendix. But the other very crucial relationship derived from (12.17) and (12.18), which we compare to the observed neutron minus proton mass difference M_{N}−M_{P}, equivalently to (A16), is:

$${m}_{u} - ( 3 {m}_{d} + 2 \sqrt{{m}_{μ} {m}_{d}} - 3 {m}_{u} ) \text{/} {( 2 π )}^{\frac{3}{2}} = 0.001389166099 u \\ {M}_{N} - {M}_{P} = 0.001388449188 u \\ Difference \text{:} 7.16911 \times {10}^{- 7} u . \qquad ( 12.19 )$$

This inherits the accuracy of what we found in (12.17), and appears to describe the neutron minus proton mass difference to just over 7 parts in ten million!

Given these close relations for the light nuclides, let us also sample a heavier nuclide, ⁵⁶Fe which has Z=26 protons and N=30 neutrons, just to gain some confidence that we can also express heavier nuclide binding energies exclusively as a function of up and down quark masses. Similarly to the top line of (12.14), we now calculate Z·ΔE_{P}+N·ΔE_{N} using (12.12) and (12.13), compare this to the empirical ⁵⁶Fe binding energy in MeV, and then calculate the percentage of the latter over the former, to obtain:

26·ΔE_{P}+30·ΔE_{N}=493.028394 MeV

B(⁵⁶Fe)=492.253892 MeV.

B(⁵⁶Fe)/(26·ΔE_{P}+30˜ΔE_{N})=99.842909% (12.20)

This is closely related to the observation after (12.13) that the average of (12.12) and (12.13) is 8.726519 MeV, which is also very close to the binding energies per nucleon of many nuclides in the middle of the periodic table, see (1.14). Clearly then, the binding energies of heavier nuclides can also be closely expressed as functions of the up and down current quark masses.

It turns out after thorough examination that ⁵⁶Fe has the highest B/(Z·ΔE_{P}+N·ΔE_{N}) percentage of all the nuclides in the periodic table and that there is no nuclide which exceeds 100%. The fact that this percentage is always just shy of 100% is a direct experimental confirmation quark confinement, as discussed at (1.14). It is also worth keeping in mind that the contribution of each neutron to any calculation of an energy number E≡Z·ΔE_{P}+N·ΔE_{N} via (12.12) and (12.13), is greater than each proton contribution by about 28.4%, i.e., by a factor of:

$$\frac{Δ {E}_{N}}{Δ {E}_{P}} = \frac{0.010534000622 u}{0.008202607332 u} = 1.284225880325 , \qquad ( 12.21 )$$

and to juxtapose this with the fact that above ⁴He, all stable nuclides either have equal numbers of protons and neutrons, or are neutron-rich. This of course, is (4.8) for the ratio of the latent neutron-to-proton binding energies.

It is also worth noting that as among all of ²H, ³H, ³He and ⁴He, that the alpha, ⁴He, is the only nuclide for which the binding energy (12.14) includes, using Z=2 and N=2, the energy number E≡Z·ΔE_{P}+N·ΔE_{N}. None of ²H, ³H, ³He contains E≡Z·ΔE_{P}+N·ΔE_{N}, and this fully accounts for why the binding energy is very much higher for ⁴He than for ²H, ³H and ³He. This reiterates the “top to bottom” and “bottom to top” discussion of section 5.

Having presented all of the foregoing data, we now return to our second postulate (12.10) which identified the up quark mass mᵤ with the deuteron ²H binding energy. We see that the binding energies for all the other 1s nucleons ³H, ³He, ⁴He, and even the neutron minus proton mass difference itself, as well as the (not independent)²H+p→³H and ²H+p→³H fusion energies and the ⁵⁶Fe binding energy can also be very closely approximated using only the traces (12.4) to (12.7) and components mᵤ, m_{d} and \sqrt{mᵤm_{d}} of the outer products K_{P}⊗K_{P} and K_{N}⊗K_{N} formed from Koide matrices (12.1) to which we assign m₁=m_{d}, m₂=m₃=mᵤ for the proton and m₁=mᵤ, m₂=m₃=m_{d} for the neutron, and the divisor (2π)^{1.5}. These multiple close relationships appear to validate the postulate (12.10) that nuclear binding energies are in fact directly reflective of the up and down current quark masses confined within the nuclide nucleons, wherein the deuteron, as the very smallest composite nuclide, simply derives its binding energy from the very lightest mass, namely that of the up quark. Because the first postulate (12.9) for the relationship among the electron, up and down masses was also integrally involved in deducing all of these binding and fusion energy concurrences, this tends to offer retrospective confirmation that (12.9) does indeed give a correct, physically-meaningful relationship as well. By any objective assessment, the odds against all of these empirical concurrences being wholly coincidental are astronomical.

Retrospectively, noting that the deduced relationships (12.14) to (12.19)—while very close—are still not exact within experimental errors, we are now motivated to withdraw the second postulate (12.10) identifying the up quark mass exactly with the deuteron binding energy, and in its place to offer the substitute postulate that the neutron minus proton mass difference is actually the exact relationship which drives all the others. That is, we replace (12.10) with the substitute postulate that

$${M}_{N} - {M}_{P} = 0.001388449188 u ≡ {m}_{u} - ( 3 {m}_{d} + 2 \sqrt{{m}_{μ} {m}_{d}} - 3 {m}_{u} ) \text{/} {( 2 π )}^{\frac{3}{2}} \qquad ( 12.22 )$$

is an exact relationship. We also regard the first postulate in (12.9) to be confirmed by all of the close relationships (12.14) through (12.20), and so now take (12.9) to be an exact relationship among the electron, up and down masses. We then use (12.9) and (12.22) to recalibrate the up and down quark masses, and all the binding and fusion-release energy relationships, accordingly. This is exactly what we did in section 10.

As a result, the recalibrated quark masses which by definition render (12.22) exact to all decimal places in the empirical M_{N}−M_{P}=0.001388449188 u mass difference, just as in (10.3), (10.4), are:

mᵤ=0.002387339327u, (12.23)

m_{d}=0.005267312526u. (12.24)

As other ways to independently measure quark masses are made more precise beyond the current PDG spreads m_{d}=4.8_{-0.3}^{+0.7} Mev and mᵤ=2.3_{-0.5}^{+0.7} Mev, (12.23), (12.24) provide many decimal places at which these quark mass predictions (12.23), (12.24) can be strengthened or contradicted.

The recalibrated binding energies, contrast (12.14), (12.15) and (12.16) respectively for ⁴He, ³He, ³H, now become, just as in (10.8) through (10.10):

$$\begin{matrix}2 \cdot Δ {E}_{P} + 2 \cdot Δ {E}_{N} - 2 \sqrt{{m}_{u} {m}_{d}} = 0.030373002032 u , & ( 12.25 ) \\ 2 {m}_{u} + \sqrt{{m}_{u} {m}_{d}} = 0.008320783890 u , & ( 12.26 ) \\ 4 {m}_{u} - 2 \sqrt{{m}_{μ} {m}_{d}} \text{/} {( 2 π )}^{\frac{3}{2}} = 0.009099047078 u . & ( 12.27 )\end{matrix}$$

Additionally, because the up and down masses have now been recalibrated by less than one part per million in AMU, the observed ²H deuteron binding energy B(²H)=0.002388170100u is no longer exactly equal to the mass of up quark, but instead differs as shown below, and just as in (10.11):

mᵤ=0.002387339327u

B(²H)=0.002388170100u.

Difference: −8.30773×10⁻⁷u (12.28)

Following recalibration, the accuracy to less than one part per million of the originally-derived neutron minus proton mass difference has migrated instead to a difference of less than one part per million between the up quark mass and the deuteron binding energy. The difference between the binding energies “retrodicted” by (12.25) to (12.28), and those actually observed empirically, is the same as those shown in FIG. 11, with diagonal lines representing nuclear isobars of like A=Z+N, but with the results in this section based strictly on use of Koide-type matrices for protons and neutrons. This close fitting is what retrospectively validates the quark masses (12.23), (12.24), the neutron minus proton mass difference (12.22), and the up and down and electron mass relationship (12.9), upon all of which this fitting is based. Any substantial alteration in these four relationships would adversely affect the fit in FIG. 11.

It is also to be noted that the various relationships above can be combined to derive the earlier (9.8), which expresses the 26.73 MeV of energy empirically-observed to be released during a single solar fusion event whereby four protons are fused into an alpha particle, solely as a function of the up and down quark masses, also to parts per million in AMU. This in turn provides the foundation for catalyzing resonant fusion energy release just as was developed in section 9. The purpose of the foregoing in this section is not to be repetitious, but to show that the same results we found in all the previous sections can be independently obtained via Koide-style mass matrices (12.1) and (12.3). The reason is that this will now enable us to establish resonant fusion relationships and the technological approach to catalyzing resonant fusion for some heavier nuclides as well, and in particular, for ⁶Li, ⁷Li, ⁷Be, ⁸Be, ¹⁰B, ⁹Be, ¹⁰Be, ¹¹B, ¹¹C, ¹²C and ¹⁴N.

13. Binding Energies and Fusion Reactions for ⁶Li, ⁷Li, ⁷Be and ⁸Be

In this section we continue using the Koide matrices (12.1) by developing fusion and binding relationships for the 2s shell nuclides ⁶Li, ⁷Li, ⁷Be and ⁸Be. The first nuclide we consider is ⁶Li. In doing so, we observe, for example from [13], that there are no stable nuclides with A=Z+N=5. One A=5 candidate for possible stability, ⁵He, has a half-life of 700(30)×10⁻²⁴ s and immediately sheds the extra neutron decay into the ⁴He alpha. The other candidate, ⁵Li, has a half-life of 370(30)×10⁻²⁴ s and sheds the extra proton to decay into the ⁴He alpha. If we seek stability, the lightest stable nuclide in the 2s shell is ⁶Li.

Let us therefore now consider the process ₂⁴He+2p→₃⁶Li+e⁺+ν+Energy whereby one fuses an alpha particle with two protons in order to create a stable ⁶Li nuclide plus a positron and neutrino. The energy released during this hypothetical fusion event is:

Energy=₂⁴M+2Mₚ−₃⁶M−mₑ=0.002033478u, (13.1)

where ₂⁴M=4.001506179125u is the observed nuclear weight of the ⁴He alpha, Mₚ=1.007276466812 u is the observed proton mass, ₃⁶M=6.013477055 u is the observed ⁶Li nuclear weight, and the electron mass is given in (12.9).

We saw in the last section that mᵤ, m_{d} and \sqrt{mᵤm_{d}}, which are the nine non-zero components of the outer products K_{P}⊗K_{P}=K_{PAB}K_{PCD} and K_{N}⊗K_{N}=K_{N AB} K_{N CD}, as well as the foregoing divided by the natural number (2π)^{1.5}, are the “energy numbers” based exclusively on the up and down quarks masses that we need to look to, to try to fit the binding and fusion energy data. We again do the same here. It is readily determined that:

9\sqrt{mᵤm_{d}}/(2π)^{1.5}=0.002026396u, (13.2)

is extremely close to (13.1), differing by a mere 7.08153×10⁻⁶ u, that is, about 7 parts per million AMU. Might this be a “significant” relationship, and not merely a close coincidence?

Here, we need to be cautious. The question is whether the coefficient “9” in (13.2) has some physical significance in relation to the Koide matrix (12.1) and/or the physical properties of the “target nuclide” ⁶Li which we are presently considering, and is not merely a fortuitous coincidence. Of course, (12.1) is a 9 component matrix, and its outer products have exactly 9 non-zero components. But the significance of the coefficient “9” is more physically-direct when we consider that ⁶Li contains exactly 9 up quarks and 9 down quarks. That is, “9” is the number of up/down quark pairs contained in a ⁶Li nuclide. So if (13.2) is in fact a theoretical expression to 7 parts per million for the energy released to fuse an alpha plus two protons into a ⁶Li, then this would mean that in order to bind together the ⁶Li nuclide, each of the nine up/down quark pairs in the target ⁶Li nuclide has to give up 1·\sqrt{mᵤm_{d}}/(2π)^{1.5} “dose” of energy. This suggests that perhaps “9” is not a random number but makes some physical sense.

So let us provisionally hypothesize that (13.2) correctly gives the fusion-release energy for the reaction (13.1), by writing:

Energy(₂⁴He+2p→₃⁶Li+e⁺+ν+Energy)=₂⁴M+2Mₚ−₃⁶M−mₑ≡9\sqrt{mᵤm_{d}}/(2π)^{1.5}. (13.3)

As noted, this is accurate to about 7 parts per million. Then let us see if this is backed up by other nuclides.

Now, having “built” a ⁶Li nuclide, let us consider the hypothetical isomeric fusion process ₃⁶Li+p→₄⁷Be+Energy whereby a ⁶Li nuclide is fused with a proton to produce a ⁷Be nuclide. For this event, the energy released is:

Energy=₃⁶M+Mₚ−₄⁷M=0.006018011721u. (13.4)

where we use the empirical values ₃⁶M=6.013477055 u, ₄⁷M=7.014735510362 u, and the proton mass ₃⁶M=6.013477055 u. Comparing to our restricted set of ingredients mᵤ, m_{d} and \sqrt{mᵤm_{d}} and these divided by (2π)^{1.5}, we find that:

18m_{d}/(2π)^{1.5}=0.006019934830u. (13.5)

This differs from (13.4) by 1.92310833848×10⁻⁶ u, or just under 2 parts per million AMU. What might be the significance of the coefficient “18,” to be certain that these are not just coincidental integer multiples? Here, ⁶Li, which is now the “source nuclide” to which we wish to add a proton, contains 18 quarks in total. So (13.5) may be explained on the basis that each of the 18 quarks inside of a ⁶Li nuclide has to give up an energy “dosage” of exactly 1·m_{d}/(2π)^{1.5} in order to bind with a proton and yield a ⁷Be nuclide. That is, each quark in ⁶Li has to give up some energy, precisely defined in relation to the down quark mass, in order to “motivate” the new proton to join the 2s shell and produce a ⁷Be nuclide. This makes some physical sense as well, and especially so because a similar view (nine \sqrt{mᵤm_{d}}/(2π)^{1.5} doses) was used to explain the energy released during the fusion event ₂⁴He+2p→₃⁶Li+e⁺+ν+Energy. In fact, the results in (13.2) and (13.5) appear to supplement one another and greatly reduce the probability of coincidence, because they each, independently, suggest that once we start building heavier nuclides on the stable “base” of an alpha ⁴He nuclide, there are prescribed “dosages” of energy which the existing quarks and/or nucleons need to contribute and which are precisely described (to parts per million) in terms of \sqrt{mᵤm_{d}} for ⁴He→⁶Li and in terms of m_{d} for ⁶Li-⁷Be.

Let us therefore also regard (13.5) to correctly specify the energy in (13.4) to about two parts per million, thus setting:

Energy(₃⁶Li+p→₄⁷Be+Energy)=₃⁶M+Mₚ−₄⁷M≡18m_{d}/(2π)^{1.5}. (13.6)

Now that we have “built” the ⁷Be nuclide, we take note that ⁷Be is comparatively stable, with a half-life of 53.22(6) days after which it will decay into the completely stable ⁷Li nuclide via electron capture. So let us now turn to this β-decay reaction, which is more formally stated as ₄⁷Be+e→₃⁷Li+ν+Energy. Again, as in (13.1) and (13.4) we calculate the associated energy:

Energy=₄⁷M−₃⁷M+mₑ=0.000925280000u (13.7)

using the empirical values ₄⁷M=7.014735510362u, ₃⁷M=7.014358810272u and the electron mass (12.9). Here, using our ingredients mᵤ, m_{d} and \sqrt{mᵤm_{d}} and (2π)^{1.5} divisor, we find:

6mᵤ/(2π)^{1.5}=0.000909485124u. (13.8)

This differs from the empirical number (13.7) by −1.579487551927×10⁻⁵ U, or under two parts per 100,000. Previously we came up with the numbers 9 (up/down pairs in ⁶Li) and 18 (quarks in ⁶Li). Now we come upon the number “6” which is the number of nuclides in ⁶Li. So (13.8) would appear, if meaningful, to say that each nuclide in the underlying ⁶Li nuclide gives up an energy dose of 1·mᵤ/(2π)^{1.5} to facilitate the isotopic beta decay of ⁷Be→⁷Li. This too makes sense in terms of this number not being random, but bearing a genuine physical meaning for the nuclide in question. Together with the result in (13.2) and (13.5), this seems to suggest that energies released to enable fusion or beta decay, at least in the 2s shell, come in discrete doses. For ⁴He→⁶Li the dose is 1·\sqrt{mᵤm_{d}}/(2π)^{1.5} for each up/down quark pair in ⁶Li. For ⁶Li→⁷Be the dose is 1·m_{d}/(2π)^{1.5} for each quark in ⁶Li. Finally, for ⁷Be→⁷Li the dose is 1·mᵤ/(2π)^{1.5} for each nuclide in ⁶Li. Notably, these respectively utilize the three ingredients \sqrt{mᵤm_{d}}/(2π)^{1.5}, m_{d}/(2π)^{1.5} and mᵤ/(2π)^{1.5}. Taken all together, this suggests that the numbers “9,” “18” and “6” which were emerged by comparing these ingredients to empirical data are all meaningful numbers based on physical properties of ⁶Li itself.

So, we now take (13.8) to be a meaningful expression for the energy in (13.7) to under 2 parts per 100,000, and so write:

Energy(₄⁷Be+e→₃⁷Li+ν+Energy)=₄⁷M−₃⁷M+mₑ≡6mᵤ/(2π)^{1.5}. (13.9)

Next, we turn to ⁸Be, which completes the 2s shell, providing 2 protons and 2 neutrons in addition to four nucleons which already subsist in the 1s shell. Despite having complete 1s and 2s shells and no extra nucleons, the ⁸Be isotope has a half-life of 6.7(17)×10⁻¹⁷ s, after which it alpha-decays via ₄⁸Be→₂⁴He+₂⁴He+Energy into two alpha particles. For ⁴He, of course, the binding energy is observed to be B(₂⁴He)=0.030376586499u. The empirical value of the ⁸Be binding energy is observed to be B(₄⁸Be)=0.060654750886u. And, the ⁴He alpha binding energy is fitted to under four parts per million by 2·ΔE_{P}+2·ΔE_{N}−2\sqrt{mᵤm_{d}} as reviewed in (12.14).

It is nothing new to note that the ⁸Be binding energy is almost twice as large as the ⁴He binding energy, and specifically, that the empirical ratio:

B(₄⁸Be)/B(₂⁴He)=1.996759935. (13.10)

So, we know at the outset that if we simply double the ⁴He binding energy and write B(₄⁸Be)≅2×(2·ΔE_{P}+2·ΔE_{N}−2\sqrt{mᵤm_{d}}), we will get a close approximation to under 1%. Certainly then, an expression of the form 4·ΔE_{P}+4·ΔE_{N}−E_{?} should give us the result we want, that is, one would hope that Z·ΔE_{P}+N·ΔE_{N} with Z=4 and N=4, minus some unknown energy E_{?}≅\sqrt{mᵤm_{d}} will give us the ⁸Be binding energy to within at least parts per 100,000, matching the accuracy for the other foregoing results. The question is, how do we determine E_{?} using the same ingredients mᵤ, m_{d} and \sqrt{mᵤm_{d}} and the (2π)^{1.5} divisor?

First, it is physically very important that (13.10) is not equal to 2 but is less than 2 by about 0.32%. Since it appears that physically, stable nuclides are those which tend toward higher rather than lower binding energies, the ratio (13.10) tells us that two ⁴He will have more binding energy in total than one ⁸Be, and for this reason, ⁸Be will split into two ⁴He in order to maximize this total binding energy. That is, there is more binding energy in two separate ⁴He than in a single ⁸Be and apparently nature prefers this. So the very existence of the alpha decay ₄⁸Be→2·₂⁴He as a preferred transition over 2·₂⁴He→₄⁸Be appears to depend on the ratio (13.10) being slightly less than 2. Consequently, this small diminution from 2 needs to be understood and not simply neglected by approximating to B(₄⁸Be)/B(₂⁴He)≅2.

Next, as to “numbers” that would make sense in the same way as “9,” “18” and “6” just above, we note that ⁸Be has A=8 nucleons. So certainly, “8” is a number that would be of interest. Now, we have used the 3-dimensional Gaussian integration number (2π)^{1.5}=15.7496099457 throughout to report close fits between empirical binding data and certain expressions built from of up and down quark masses via products of Koide-type matrices (12.1). But, if an expression like 2\sqrt{mᵤm_{d}} was an ingredient in successfully matching the ⁴He binding energy to parts per million and a 1·\sqrt{mᵤm_{d}}/(2π)^{1.5} energy dose per quark pair in ⁶Li successfully reproduced the ₂⁴He+2p→₃⁶Li+e⁺+ν+Energy reaction also to parts per million, we see that both \sqrt{mᵤm_{d}}/(2π)^{1.5} and \sqrt{mᵤm_{d}} are ingredients that provide suitable energy doses. So because (2π)^{1.5}=15.7496099457≅316, this means that 16·\sqrt{mᵤm_{d}}/(2π)^{1.5}≅\sqrt{mᵤm_{d}}. For a nuclide ⁸Be with 8 nucleons, a coefficient “16” which approximates (2π)^{1.5} in fact becomes physically relevant and not just random.

With this in mind, given that B(₂⁴He)=2·ΔE_{P}+2·ΔE_{N}−2\sqrt{mᵤm_{d}} as seen in (12.14), and given that we need an E_{?}4\sqrt{mᵤm_{d}} for ⁸Be, let us use the close approximation 16·\sqrt{mᵤm_{d}}/(2π)^{1.5}≅\sqrt{mᵤm_{d}} to form another energy number:

B′≡2·ΔE_{P}+2·ΔE_{N}−32·\sqrt{mᵤm_{d}}/(2π)^{1.5}≅B(₂⁴He). (13.11)

that is close to B(₂⁴He) of (12.14), but not exactly the same. Now, let us conduct the gedanken of fusing two ⁴He into one ⁸Be. Of course, this will split into two ⁴He after 6.7(17)×10⁻¹⁷ s, but this is still useful to think about. One of the two ⁴He will have to form the 1s shell. The other will need to overlay “around” the 1s shell and form the 2s shell. Let us suppose that the ⁴He which forms the 1s shell retains the B(₂⁴He) shown in (12.14). But let us suppose that the other ⁴He which goes into the 2s shell instead carries with it energy number (13.11) which is very close to, but not the same as, B(₂⁴He). Accordingly, we now use (13.11) and (12.14) together to construct a hypothesized:

B(₄⁸Be)=4·ΔE_{P}+4·ΔE_{N}−2\sqrt{mᵤm_{d}}−32\sqrt{mᵤm_{d}}/(2π)^{1.5}=0.0606332509u. (13.12)

This differs from the empirical B(₄⁸Be)=0.060654750886u by −2.1500027391×10⁻⁵ u, just over two parts in 100,000. So the accuracy is in the desired range. But does this make sense in other ways, so it is not just a coincidental guess but has physical meaning? First, the ratio:

$$\frac{B ( {}_{4}^{8} Be )}{B ( {}_{2}^{4} He )} = \frac{4 \cdot Δ {E}_{P} + 4 \cdot Δ {E}_{N} - 2 \sqrt{{m}_{u} {m}_{d}} - 32 \sqrt{{m}_{u} {m}_{d}} \text{/} {( 2 π )}^{1.5}}{2 \cdot Δ {E}_{P} + 2 \cdot Δ {E}_{N} - 2 \sqrt{{m}_{u} {m}_{d}}} = 1.9960521522 , \qquad ( 13.13 )$$

compare (13.10), is less than 2 by 0.4%, versus the empirical 0.32% noted earlier, and so will also cause the reaction ₄⁸Be→2·₂⁴He to be energetically favored rather than 2·₂⁴He→₄⁸Be. This a very important prerequisite for (13.12) to be a valid candidate for the ⁸Be binding energy.

Secondly, noting that ⁴He contains 6 up and 6 down quarks and is fully symmetric under u↔d quark interchange, we observe that ⁸Be contains 12 up and 12 down quarks and that (13.12) is also fully symmetric under u↔d quark interchange. Apparently, u↔d invariance is a desirable binding energy symmetry at least for the full-shell nuclides ⁴He and ⁸Be with equal numbers of protons and neutron and hence of up and down quarks.

Third, the number 32=8×4 has a very natural meaning in terms of the energy dosage considerations uncovered in the several lithium fusions just reviewed. Referring to (12.12) and (12.13), we see that 4\sqrt{mᵤm_{d}}/(2π)^{1.5} is an important “energy dose” arising from the Koide matrices applied to protons and neutrons. Given that ⁸Be contains 8 nucleons, one can interpret the (13.12) as saying that each of the 8 nucleons in ⁸Be “contributes” a −4\sqrt{mᵤm_{d}}/(2π)^{1.5} dose of energy to binding energy (13.13), to produce the term −32\sqrt{mᵤm_{d}}/(2π)^{1.5}. And, because this contribution yields the ratio (13.13), our gedanken to fuse 2·₂⁴He→₄⁸Be will last all of 6.7(17)×10⁻¹⁷ s, after which we will witness the physically-preferred decay ₄⁸Be→2·₂⁴He. So (13.12) appears to touch all the bases required to be a credible relationship for ⁸Be binding energy and we shall henceforth employ it as such.

With the foregoing, we now have an expression for ⁸Be binding that is accurate to about 2 parts per 100,000, and we have expressions with similar accuracy for fusion/beta decay energies related to ⁶Li (13.3), ⁷Be (13.6) and ⁷Li (13.9). These fusion/decay energies (13.3), (13.6) and (13.9) may be deductively converted over into binding energies, as shown next.

In general, for a nuclide with Z protons and N neutrons hence A=Z+N nucleons, the binding energy _{Z}^{A}B is related to its atomic weight _{Z}^{A}M according to:

_{Z}^{A}B=Z·M_{P}+N·M_{N}−_{Z}^{A}M. (13.14)

So for the ₃⁶Li, ₄⁷Be and ₃⁷Li binding energies respectively, we need to find:

₃⁶B=3·M_{P}+3·M_{N}−₃⁶M

₄⁷B=4·M_{P}+3·M_{N}−₄⁷M.

₃⁷B=3·M_{P}+4·M_{N}−₃⁷M (13.15)

We first use the results in (13.3), (13.6) and (13.9) for ₃⁶M, ₄⁷M and ₃⁷M to rewrite the above equation set as:

₃⁶B=M_{P}+3·M_{N}+9\sqrt{mᵤm_{d}}/(2π)^{1.5}−₂⁴M+mₑ

₄⁷B=3·M_{P}+3·M_{N}+18m_{d}/(2π)^{1.5}−₃⁶M.

₃⁷B=3·M_{P}+4·M_{N}+6mᵤ/(2π)^{1.5}−₄⁷M−mₑ (13.16)

We then use (13.3) and (13.6) again in the latter two expressions to obtain:

₃⁶B=M_{P}+3·M_{N}+9\sqrt{mᵤm_{d}}/(2π)^{1.5}−₂⁴M+mₑ

₄⁷B=M_{P}+3·M_{N}+18m_{d}/(2π)^{1.5}+9\sqrt{mᵤm_{d}}/(2π)^{1.5}−₂⁴M+mₑ.

₃⁷B=2·M_{P}+4·M_{N}+6mᵤ/(2π)^{1.5}+18m_{d}/(2π)^{1.5}−₃⁶M−mₑ (13.17)

And we then use (13.3) yet again in the final expression to obtain:

₃⁶B=M_{P}+3·M_{N}+9\sqrt{mᵤm_{d}}/(2π)^{1.5}−₂⁴M+mₑ

₄⁷B=M_{P}+3·M_{N}+18m_{d}/(2π)^{1.5}+9\sqrt{mᵤm_{d}}/(2π)^{1.5}−₂⁴M+mₑ.

₃⁷B=4·M_{N}+6mᵤ/(2π)^{1.5}+18m_{d}/(2π)^{1.5}+9\sqrt{mᵤm_{d}}/(2π)^{1.5}−₂⁴M (13.18)

These expressions are now all reduced to contain the alpha nuclear weight ₂⁴M. For this we rewrite (13.14) for Z=2 and N=2 as:

₂⁴M=2·M_{P}+2·M_{N}−₂^{4B.} (13.19)

Substituting (13.19) into all of (13.18), we next obtain:

₃⁶B=M_{N}−M_{P}+9\sqrt{mᵤm_{d}}/(2π)^{1.5}+₂⁴B+mₑ

₄⁷B=M_{N}−M_{P}+18m_{d}/(2π)^{1.5}+9\sqrt{mᵤm_{d}}/(2π)^{1.5}+₂⁴B+mₑ.

₃⁷B=2·(M_{N}−M_{P})+6mᵤ/(2π)^{1.5}+18m_{d}/(2π)^{1.5}+9\sqrt{mᵤm_{d}}/(2π)^{1.5}+₂⁴B (13.20)

Finally, we use the neutron minus proton mass difference (12.22), the up, down and electron relationship (12.9), and the ⁴He binding energy (12.14) with (12.12) and (12.13), and reduce. We then use the quark masses (12.23), (12.24), directly, to obtain:

$${}_{3}^{6} B = 7 {m}_{u} + 6 {m}_{d} - 2 \sqrt{{m}_{u} {m}_{d}} + ( - 10 {m}_{u} - 10 {m}_{d} - 9 \sqrt{{m}_{u} {m}_{d}} ) \text{/} {( 2 π )}^{\frac{3}{2}} = 0.0343364272 u \\ {}_{4}^{7} B = 7 {m}_{u} + 6 {m}_{d} - 2 \sqrt{{m}_{u} {m}_{d}} + ( - 10 {m}_{u} + 8 {m}_{d} - 9 \sqrt{{m}_{u} {m}_{d}} ) \text{/} {( 2 π )}^{\frac{3}{2}} = 0.0403563620 u \\ {}_{3}^{7} B = 8 {m}_{u} + 6 {m}_{d} - 2 \sqrt{{m}_{u} {m}_{d}} + ( 2 {m}_{u} + 2 {m}_{d} - 11 \sqrt{{m}_{u} {m}_{d}} ) \text{/} {( 2 π )}^{\frac{3}{2}} = 0.042105716 u . \qquad ( 13.21 )$$

The respective empirical values are ₃⁶B=0.0343470932u (difference of −1.0666×10⁻⁵ u), ₄⁷B=0.0403651049u (difference of −8.7429×10⁻⁶ u), and ₃⁷B=0.0421302542 u (difference of −2.45378×10⁻⁵ u). So together with ⁸Be from (13.12), we have now developed expressions for all of the 2s nuclide binding energies to small parts per 10⁵ or (for ⁷Be) parts per million.

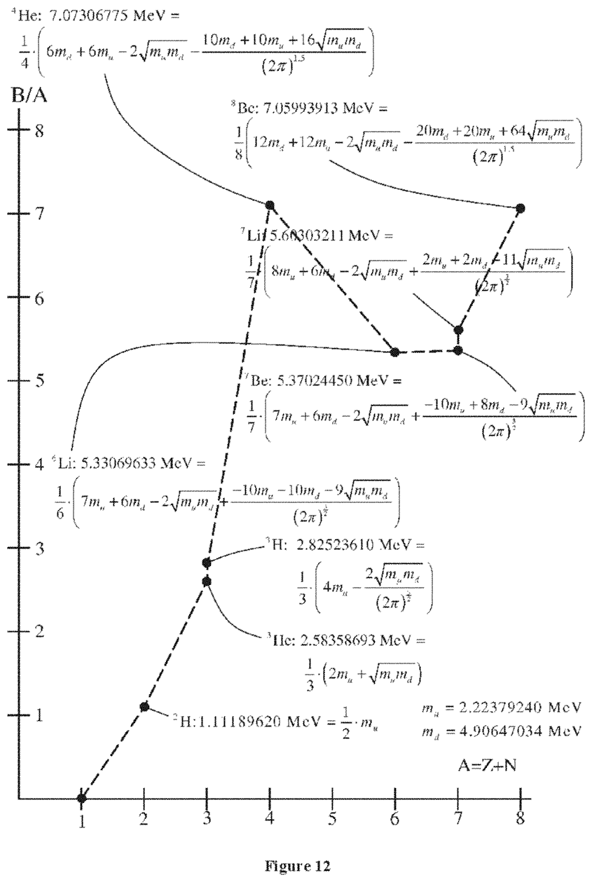

FIG. 12 now summarizes the retrodicted expressions and calculated values for both the 1s and 2s nuclides in the form of the customary chart of binding energy per nucleon, converted from AMU into MeV via 1 u=931.494061 MeV. This familiar curve shows eight of the very lightest elements in the well-known form of a per-nucleon binding energy graph. All of these energies, however, are no longer just empirical, but rather may be calculated strictly from the masses (12.23), (12.24) of the up and down quarks which, when the indicated calculations are performed, will enable a fit to the empirical data to parts per million or low parts per 100,000 in all cases. This provides strong validation that the foregoing approach enables nuclear binding energies to be fitted very precisely at a granular level, based solely as a function of the up and down quark masses. This fit in turn validates the values of masses (12.23), (12.24) via the observed nuclear binding energies which are known much more precisely than any quark mass values derived from deep inelastic scattering.

Also of interest is that the retrodicted binding energy per nucleon of ³H exceeds that of its isobar ³He by 0.24164918 MeV, while the retrodicted binding energy per nucleon of ⁷Li exceeds that of its isobar ⁷Be by the relatively similar 0.23278761 MeV. It is often assumed that separate consideration needs to be given to the electrostatic repulsion of an extra proton which lowers the binding energy of a proton-rich nuclide, e.g. ³He and ⁷Be. What the foregoing shows is that the binding energy difference owing to this electrostatic repulsion is already inherently and integrally built into both the quark masses, and the relationships in FIG. 12 which combine these quark masses to arrive at nuclear binding energies.

Insofar as what we might learn from these results to progress in a granular way to even heavier nuclides, we see that we have essentially “woven” our way through the progression ⁴He→⁶Li→⁷Be→⁷Li in (13.3), (13.6) and (13.9), which weaving was then deductively reflected in the binding energy calculations of (13.14) to (13.21). Part of how we obtain confidence that our results are meaningful not randomly-coincidental, is that we progress carefully in this manner from one nuclide to the next along known fusion or beta-decay routes, and make certain that the coefficients we use at each step to combine the mᵤ, m_{d}, \sqrt{mᵤm_{d}} and (2π)^{1.5} ingredients make sense in relation to the nuclides in question. This way, as we build up heavier shells and nuclides, we know they are being constructed on a carefully-laid foundation.

14. Binding Energies and Fusion Reactions for ¹⁰B, ⁹Be, ¹⁰Be, ¹¹B, ¹¹C, ¹²C and ¹⁴N

We begin this section by considering the ¹⁰B nuclide. For ⁶Li we considered the fusion reaction ₂⁴He+2p→₃⁶Li+e⁺+ν+Energy. We follow a similar route and consider the fusion reaction ₄⁸Be+2p→₅¹⁰B+e⁺+ν+Energy. The energy released during such a fusion event is:

Energy=₄⁸M+2Mₚ−₅¹⁰M−mₑ=0.006921034u, (14.1)

using empirical data ₄⁸M=8.003110780u, ₅¹⁰M=10.010194100 u, Mₚ=1.007276466812u and mₑ=0.000548579909u. We recall from (13.3) that the energy released during ₂⁴He+2p→₃⁶Li+e⁺+ν+Energy was given by 9\sqrt{mᵤm_{d}}/(2π)^{1.5} to about 7 parts per million. Because ⁶Li has A=Z+N=6 nucleons and so has 9=3×A/2 up/down quark pairs, we interpreted this as indicating that each of the nine quark pairs gave up one \sqrt{mᵤm_{d}}/(2π)^{1.5} energy dose during this fusion. Following suit, we observe that ¹⁰B has A=Z+N=10 nucleons, and so contains 15=3×A/2 up/down quark pairs. Expecting some consistency, we construct the factor 15\sqrt{mᵤm_{d}}/(2π)^{1.5} and subtract this from the empirical energy in (14.1) to obtain:

0.006921034u−15\sqrt{mᵤm_{d}}/(2π)^{1.5}=0.003543707u≅\sqrt{mᵤm_{d}}. (14.2)

So apparently there is still some energy that is unaccounted for when we open up the 2p shell with ¹⁰B. However, is the easily seen that the energy calculated in (14.2) differs from \sqrt{mᵤm_{d}} by 2.3983×10⁻⁶ u i.e., by just over two parts per million AMU, as is also shown above. So we use (14.2) together with (14.1) to conclude that:

Energy(₄⁸Be+2p→₅¹⁰B+e⁺+ν+Energy)=₄⁸M+2Mₚ−₅¹⁰M−mₑ=\sqrt{mᵤm_{d}}+15\sqrt{mᵤm_{d}}/(2π)^{1.5}=0.006923432u. (14.3)

This differs from the empirical value (14.1) by the same 2.3983×10⁻⁶ u, or just over two parts per million. So when the stable nuclide ¹⁰B is created by fusing an unstable ⁸Be with two protons, apparently each up/down quark pair in the target ¹⁰B nuclide contributes one energy does of \sqrt{mᵤm_{d}}/(2π)^{1.5}. But in addition, there is an overall energy dose of \sqrt{mᵤm_{d}} as well. Noting that in the 2s shell, the orbital angular momentum is l=0, but that 2p is the first shell in which nucleons have a non-zero l=1, it makes sense, at least preliminarily, to regard this extra \sqrt{mᵤm_{d}} dose that did not appear when we built ⁶Li, as being required to provide the energy needed to sustain one proton and one neutron in n=2, l=1, m=0 states. So we regard the (3×A/2)·\sqrt{mᵤm_{d}}/(2π)^{1.5} energy doses as pairwise contributions by the up and down quarks to sustain binding, and the overall \sqrt{mᵤm_{d}} dose as a contribution to sustain angular momentum.

Equation (14.3) which states that the ₄⁸Be+2p→₅¹⁰B fusion releases a total energy of \sqrt{mᵤm_{d}}+15\sqrt{mᵤm_{d}}/(2π)^{1.5}, contrasted with (13.3) which states that ₂⁴He+2p→₃⁶Li releases a total energy of 9\sqrt{mᵤm_{d}}/(2π)^{1.5}, is compelling validating evidence of this approach, because a) the source nuclides ₄⁸Be and ₂⁴He are similarly-situated in the first two Z=N full neutron and proton shell positions in the periodic table, b) the target nuclides ₅¹⁰B and ₃⁶Li are similarly situated in the first two Z=N positions with a new shell opened for each of protons and neutrons, c) the reactions are like-reactions, d) ₅¹⁰B contains 15 up and 15 down quarks and in the term 15\sqrt{mᵤm_{d}}/(2π)^{1.5}, 15 appearances of each of the up and down masses, e) ₃⁶Li contains 9 up and 9 down quarks and in the term 9\sqrt{mᵤm_{d}}/(2π)^{1.5}, 9 appearances of each of the up and down masses and f) the only difference between these reactions is the further term \sqrt{mᵤm_{d}} for ₄⁸Be+2p→₅¹⁰B, which accounts for l=1 shells which first open up in ₅¹⁰B but are not needed in ₃⁶Li.

Rather than stay inside the n=2 l=1, m=0 states of the 2p shell, let us see if we can strike further into the nuclear binding table by building the ¹⁴N in a similar way. Here, for the first time, we will have protons and neutrons in n=2, l=1, m=±1 states, i.e., with non-zero m magnetic quantum number states. The analogous reaction we wish to consider here, is ₆¹²C+2p→₇¹⁴N+e⁺+ν+Energy. The energy released is:

Energy=₆¹²M+2Mₚ−₇¹⁴M−mₑ=0.011478929u. (14.4)

This uses the empirical data ₆¹²M=11.996708521 u, ₇¹⁴N=13.999233945 and the proton and electron masses. Noting that these elements are both along the Z=N nuclide diagonal and have equal numbers of up and down quarks and that we have thus far utilized a \sqrt{mᵤm_{d}}=0.003546105 u construct which is u↔d symmetric, let us also bring the similarly-symmetric (mᵤ+m_{d})/2=0.003827326 u construct into play. This is about 8% larger than \sqrt{mᵤm_{d}}, but has the appropriate symmetry and so should also be considered especially when working on the Z=N diagonal. Very interestingly, the above energy (14.4) differs from 3·(mᵤ+m_{d})/2 by a mere 3.0490×10⁻⁶ u. We therefore make the association:

Energy(₆¹²C+2p→₇¹⁴N+e⁺+ν+Energy)=₆¹²M+2·Mₚ−₇¹⁴M−mₑ=3·(mᵤ+m_{d})/2=0.011481978u. (14.5)

Apparently, once we start to construct nuclides for which m≠0, nature replaces \sqrt{mᵤm_{d}}, and simply employs three “doses” of (mᵤ+m_{d})/2 to construct ¹⁴N. Perhaps the number “3” representing these doses may be ascribed to the three complete shell levels is, 2s and 2p⁰ (where the superscript “0” indicates m=0) upon which the proton and neutron to create ¹⁴N are overlaid.

Having obtained the relationship (14.3) for ¹⁰B, which is a stable nuclide, let us see if we can branch out from here. First, we work over to ¹⁰B's lighter isotone ⁹Be. The reaction we shall consider is ₄⁹Be+p→₅¹⁰B+Energy, fusing a proton with ⁹Be to produce ¹⁰B for which the binding energy is now known in principle via (14.3). (See (13.14) through (13.21) which show how the binding energy is deduced once nuclear weight is established.) The fusion energy is:

Energy=₄⁹M+Mₚ−₅¹⁰M=0.007070247u, (14.6)

using the empirical values ₄⁹M=9.009987880 u, ₅¹⁰M=10.010194100 u and the proton mass. This differs from 2\sqrt{m_{μ}m_{d}}, by 2.19637×10⁻⁵ u or just over 2 parts per 100,000 AMU, which is within the ranges we have previously taken to be physically meaningful. So we now establish the close relationship:

Energy(₄⁹Be+p→₅¹⁰B+Energy)=₄⁹M+Mₚ−₅¹⁰M=2\sqrt{mᵤm_{d}}=0.007092210u, (14.7)

This binding energy for ⁹Be can now be deduced from this, as will be done shortly below.

The next nuclide we consider branching to from ¹⁰B is the comparatively stable ¹⁰Be, which has a half-life of 1.39×10⁶ years before it decays through β⁻ decay into its isotope ¹⁰B for which we deduced the fusion energy (14.3). Here the reaction is ₄¹⁰Be→₅¹⁰B+e+ν̅+Energy and so the energy relationships are:

Energy=₄¹⁰M−₅¹⁰M−mₑ=0.000596800u. (14.8)

Above, we use the empirical ₄¹⁰M=10.011339480 u, ₅¹⁰M=10.010194100 u and the electron mass. In trying to fit this result, we recall from (12.15) that the binding energy of ³He is retrodicted to under four parts per 100,000 to be B(³He)=\sqrt{mᵤ}(\sqrt{m_{d}}+2\sqrt{mᵤ})=2mᵤ+\sqrt{mᵤm_{d}}. Keeping this in mind, we form three similar mass combinations \sqrt{m_{d}}(\sqrt{m_{d}}+2\sqrt{mᵤ})=m_{d}+2\sqrt{mᵤm_{d}}, \sqrt{m_{d}}(\sqrt{mᵤ}+2\sqrt{m_{d}})=2m_{d}+\sqrt{mᵤm_{d}} and \sqrt{mᵤ}(\sqrt{mᵤ}+2 \sqrt{m_{d}})=mᵤ+2\sqrt{mᵤm_{d}}, as well as the foregoing divided by (2π)^{1.5}. All of these are readily constructed from the square root of an up or down quark mass times the trace of a Koide matrix for the proton or neutron, see, e.g., (12.15). It turns out that the value in (14.8) differs from the final expression (mᵤ+2\sqrt{mᵤm_{d}})/(2π)^{1.5} by −5.0911×10⁻⁶ u, that is, by five parts per million AMU. We take this to be a meaningful relationship, and so write (14.8) as:

Energy(₄¹⁰Be→₅¹⁰B+e+ν̅+Energy)=₄¹⁰M−₅¹⁰M−mₑ=(mᵤ+2\sqrt{mᵤm_{d}})/(2π)^{1.5}=0.000601891u. (14.9)

Now we branch up to ¹¹B via ₅¹⁰B+p+e→₅¹¹B+ν+Energy. The energies are:

Energy=₅¹⁰M+Mₚ+mₑ−₅¹¹M=0.011456647u. (14.10)

Above, we use ₅¹⁰M=10.010194100 u, ₅¹¹M=11.006562500 and the proton and electron masses. It turns out that the above differs from 3·(mᵤ+m_{d})/2 by 2.53311×10⁻⁵ u, or under 3 parts per 100,000. We take this as a meaningful relationship, and so write (14.10) as:

Energy(₅¹⁰B+p+e→₅¹¹B+ν+Energy)=₅¹⁰M+Mₚ+mₑ−₅¹¹M=3·(mᵤ+m_{d})/2=0.011481978u. (14.11)

So as a respective result of (14.3), (14.7), (14.9) and (14.11), it becomes possible to deduce the binding energies of four new nuclides: ¹⁰B, ⁹Be, ¹⁰Be and ¹¹B. Before we explicitly deduce these four binding energies, let us also look atone final branch, this time from ¹¹B to ¹¹C. Carbon-11, which is used to label molecules in PET scans, has a half-life of 20.334(24) min before it β⁺ decays into ¹¹B which we have just uncovered in (14.11) above. This reaction is ₆¹¹C+e→₅¹¹B+ν+Energy, which is represented as:

Energy=₆¹¹M+mₑ−₅¹¹M=0.002128200u. (14.12)

Here we have used ₅¹¹M=11.006562500 and ₆¹¹M=11.008142121 u. Comparing to the usual constructs, we see that 4(2mᵤ+\sqrt{mᵤm_{d}})/(2π)^{1.5} differs by −1.49327×10⁻⁵ u, less than 2 parts in 100,000. So we take this to be meaningful, and rewrite (14.12) as:

Energy(₆¹¹C+e→₅¹¹B+ν+Energy)=₆¹¹M+mₑ−₅¹¹M=8mᵤ/(2π)^{1.5}+4\sqrt{mᵤm_{d}}/(2π)^{1.5}=0.002113267u. (14.13)

Now we explicitly deduce the binding energies for all of ¹⁰B, ⁹Be, ¹⁰Be, ¹¹B and ¹¹C, before we turn separately to ¹²C which completes the 2p⁰ subshell (0 representing m=0). As we are reminded in (13.14), for a nuclide with Z protons and N neutrons hence A=Z+N nucleons, the binding energy _{Z}^{A}B is related to its atomic weight _{Z}^{A}M according to:

_{Z}^{A}B=Z·M_{P}+N·M_{N}−_{Z}^{A}M. (14.14)

So for the ¹⁰B, ⁹Be, ¹⁰Be, ¹¹B and ¹¹C binding energies, we need to find:

₅¹⁰B=5·M_{P}+5·M_{N}−₅¹⁰M

₄⁹B=4·M_{P}+5·M_{N}−₄⁹M

₄¹⁰B=4·M_{P}+6·M_{N}−₄¹⁰M.

₅¹¹B=5·M_{P}+6·M_{N}−₅¹¹M

₆¹¹B=6·M_{P}+5·M_{N}−₆¹¹M (14.15)

We begin by substituting (14.3), (14.7), (14.9), (14.11) and (14.13) into the above, rearranged so that the nuclear masses on the very right of each of the above may be replaced. This yields:

₅¹⁰B=3·M_{P}+5·M_{N}−₄⁸M+\sqrt{mᵤm_{d}}+15\sqrt{mᵤm_{d}}/(2π)^{1.5}+mₑ

₄⁹B=5·M_{P}+5·₅¹⁰M−2\sqrt{m_{μ}m_{d}}.

₄¹⁰B=4·M_{P}+6·M_{N}−₅¹⁰M−mᵤ/(2π)^{1.5}−2\sqrt{mᵤm_{d}}/(2π)^{1.5}−mₑ

₅¹¹B=4·M_{P}+6·M_{N}−₅¹⁰M+3·(mᵤ+m_{d})/2−mₑ

₆¹¹B=6·M_{P}+5·M_{N}−₅¹¹M−8mᵤ/(2π)^{1.5}−4\sqrt{mᵤm_{d}}/(2π)^{1.5}+mₑ (14.16)

Next we substitute for ₅¹⁰M in the second through fourth expressions, and for ₅¹¹M and again for ₅¹⁰M in the final expression. This brings us to:

₅¹⁰B=3·M_{P}+5·M_{N}−₄⁸M+\sqrt{mᵤm_{d}}+15\sqrt{mᵤm_{d}}/(2π)^{1.5}+mₑ

₄⁹B=3·M_{P}+5·M_{N}−₄⁸M−\sqrt{mᵤm_{d}}+15\sqrt{mᵤm_{d}}/(2π)^{1.5}+mₑ.

₄¹⁰B=2·M_{P}+6·M_{N}−₄⁸M+\sqrt{mᵤm_{d}}+13\sqrt{mᵤm_{d}}/(2π)^{1.5}−mᵤ/(2π)^{1.5}.

₅¹¹B=2·M_{P}+6·M_{N}−₄⁸M+3·(mᵤ+m_{d})/2+\sqrt{mᵤm_{d}}+15\sqrt{mᵤm_{d}}/(2π)^{1.5}

₆¹¹B=3·M_{P}+5·M_{N}−₄⁸M+3·(mᵤ+m_{d})/2+\sqrt{mᵤm_{d}}−8mᵤ/(2π)^{1.5}+11\sqrt{mᵤm_{d}}/(2π)^{1.5}+mₑ

Now the foregoing all contain the nuclear weight ₄⁸M of ⁸Be. So now we invert (14.14) specifically for ⁸Be, to write:

₄⁸M=4·M_{P}+4·M_{N}−₄^{8B.} (14.18)

Substituting this into all of (14.17) and reducing, next yields:

₅¹⁰B=(M_{N}−M_{P})+₄⁸B+\sqrt{mᵤm_{d}}+15\sqrt{mᵤm_{d}}/(2π)^{1.5}+mₑ

₄⁹B=(M_{N}−M_{P})+₄⁸B−\sqrt{mᵤm_{d}}+15\sqrt{mᵤm_{d}}/(2π)^{1.5}+mₑ

₄¹⁰B=2(M_{N}−M_{P})+₄⁸B+\sqrt{mᵤm_{d}}+13\sqrt{mᵤm_{d}}/(2π)^{1.5}−mᵤ/(2π)^{1.5}.

₅¹¹B=2(M_{N}−M_{P})+₄⁸B+3·(mᵤ+m_{d})/2+\sqrt{mᵤm_{d}}+15\sqrt{mᵤm_{d}}/(2π)^{1.5}

₆¹¹B=(M_{N}−M_{P})+₄⁸B+3·(mᵤ+m_{d})/2+\sqrt{mᵤm_{d}}−8mᵤ/(2π)^{1.5}+11\sqrt{mᵤm_{d}}/(2π)^{1.5}+mₑ (14.19)

Now we just need to make three final substitutions and reduce: From (12.22):

$${M}_{N} - {M}_{P} = {m}_{u} - ( 3 {m}_{d} + 2 \sqrt{{m}_{μ} {m}_{d}} - 3 {m}_{u} ) \text{/} {( 2 π )}^{\frac{3}{2}} . \qquad ( 14.20 )$$

From combining (13.12) with (12.12) and (12.13) and reducing:

₄⁸B=12mᵤ+12m_{d}−2\sqrt{mᵤm_{d}}−(20m_{d}+64\sqrt{mᵤm_{d}}+20mᵤ)/(2π)^{1.5}. (14.21)

And from (12.9):

mₑ=3(m_{d}−mᵤ)/(2π)^{1.5}. (14.22)

Making the substitutions (14.20) through (14.22) into all of (14.19), reducing, and evaluating using the recalibrated quark masses (12.23) and (12.24) finally yields for ¹⁰B, ⁹Be, ¹⁰Be, ¹¹B and ¹¹C, respectively:

$${}_{5}^{10} B = 13 {m}_{u} + 12 {m}_{d} - \sqrt{{m}_{u} {m}_{d}} - ( 20 {m}_{u} + 20 {m}_{d} + 51 \sqrt{{m}_{u} {m}_{d}} ) \text{/} {( 2 π )}^{1.5} = 0.0694937119 u \\ {}_{4}^{9} B = 13 {m}_{u} + 12 {m}_{d} - 3 \sqrt{{m}_{u} {m}_{d}} - ( 20 {m}_{u} + 20 {m}_{d} + 51 \sqrt{{m}_{u} {m}_{d}} ) \text{/} {( 2 π )}^{1.5} = 0.0624015014 u \\ {}_{4}^{10} B = 14 {m}_{u} + 12 {m}_{d} - \sqrt{{m}_{u} {m}_{d}} - ( 15 {m}_{u} + 26 {m}_{d} + 55 \sqrt{{m}_{μ} {m}_{d}} ) \text{/} {( 2 π )}^{1.5} = 0.0697316901 u \\ {}_{5}^{11} B = \frac{31}{2} {m}_{u} + \frac{27}{2} {m}_{d} - \sqrt{{m}_{u} {m}_{d}} - ( 14 {m}_{u} + 26 {m}_{d} + 53 \sqrt{{m}_{μ} {m}_{d}} ) \text{/} {( 2 π )}^{1.5} = 0.0818155590 u \\ {}_{6}^{11} B = \frac{29}{2} {m}_{u} + \frac{27}{2} {m}_{d} - \sqrt{{m}_{u} {m}_{d}} - ( 28 {m}_{u} + 20 {m}_{d} + 55 \sqrt{{m}_{μ} {m}_{d}} ) \text{/} {( 2 π )}^{1.5} = 0.0788624224 u . \qquad ( 14.23 )$$

Respective empirical values for the above are 0.0695128136 u (Δ=−1.910169×10⁻⁵ u); 0.0624425669 u (Δ=−4.106544×10⁻⁵); 0.0697558829 u (Δ=−2.419278×10⁻⁵ u); 0.0818093296 u (Δ=6.22936×10⁻⁶ u); and finally, 0.0788412603 u (Δ=2.116207×10⁻⁵ u). Now let us finally turn to ¹²C.

Carbon-12 has Z=A=6 and fully fills the 2p⁰ subshell for both protons and neutrons. It contains 18 up and down quarks alike. Like ⁴He and ⁸Be, we expect that the binding energy for ¹²C will be symmetric under u↔d interchange. Therefore, we expect that the only admissible numbers will be \sqrt{mᵤm_{d}} and ½(mᵤ+m_{d}) and multiples and combinations thereof.

Using the proton and neutron latent binding “energy numbers” from (12.12) and (12.13):

ΔEₚ=m_{d}+2mᵤ−(m_{d}+4\sqrt{mᵤm_{d}}+4mᵤ)/(2π)^{1.5}, (14.24)

ΔE_{N}=mᵤ+2m_{d}−(mᵤ+4\sqrt{mᵤm_{d}}+4m_{d})/(2π)^{1.5}, (14.25)

(12.14) shows that the ⁴He alpha particle binding energy is:

₂⁴B=2·ΔE_{P}+2·ΔE_{N}−2\sqrt{mᵤm_{d}} (14.26)

to under 3 parts per million AMU. Similarly, in (13.12) we found that the ⁸Be binding energy is (see the fully-expanded expression (14.21) above):

₄⁸B=4·ΔE_{P}+4·ΔE_{N}−2\sqrt{mᵤm_{d}}−32\sqrt{mᵤm_{d}}/(2π)^{1.5}, (14.27)

to about 2 parts per 100,000 AMU. If we define an energy “dosage” D₁≡½\sqrt{mᵤm_{d}}, then we may write (14.26) in terms of A=Z+N as:

₂⁴B=Z·ΔE_{P}+N·ΔE_{N}−A·D₁ (14.28)

Using this same dosage, (14.27) may be written as:

$${}_{4}^{8} B = Z \cdot Δ {E}_{P} + N \cdot Δ {E}_{N} - \frac{A}{2} {D}_{1} - \frac{A}{2} ( 16 {D}_{1} \text{/} {( 2 π )}^{1.5} ) , \qquad ( 14.29 )$$

recalling that in obtaining (14.29), we took advantage of 16≅(2π)^{1.5}=15.7496099457, see between (13.10) and (13.11). This is was what accounted for the almost immediate alpha-decay of one ⁸Be nucleus into two ⁴H nuclei.

It turns out after some trial and error fitting based on the foregoing, that the ¹²C binding energy may be specified, not using \sqrt{mᵤm_{d}}, but rather, using the other u↔d symmetric construct ½(mᵤ+m_{d}) which differs from \sqrt{mᵤm_{d}} by about 8%, and which has previously appeared in (14.5) for ¹⁴N and (14.11) for ¹¹B. Specifically, it may be calculated that a ¹²C binding energy defined in terms of quark masses as (with the number A=12 being the number of nucleons):

₆¹²B=6·ΔE_{P}+6·ΔE_{N}−(mᵤ+m_{d})−12(mᵤ+m_{d})/(2π)^{1.5}=0.0989087255u (14.30)

will differ from the empirical energy 0.0989397763 u by −3.10508×10⁻⁵ u.

To obtain an “apples-to-apples” comparison with (14.28) and (14.29) to help discern the overall pattern of full-shell Z=N=even elements such as ⁴He, ⁸Be, ¹²C, ¹⁶O, ²⁰Ne, ²⁴Mg, etc., which as we have seen in section 3 here appear to form a “backbone” from which it then becomes possible to branch out to close isotones, isobars and isotopes, let us define another dosage number D₂≡¼(mᵤ+m_{d}). Using this in (14.30) allows us to write:

$${}_{6}^{12} B = Z \cdot Δ {E}_{P} + N \cdot Δ {E}_{N} - \frac{A}{3} {D}_{2} - \frac{A}{4} \cdot ( 16 {D}_{2} \text{/} {( 2 π )}^{1.5} ) , \qquad ( 14.31 )$$

While it is not yet clear what the overall formulation is for _{Z}^{A}B in general for the Z=N=even backbone, (14.28), (14.29) and (14.31) start to give us a sense of what to be looking for. Trying to further fit ¹⁶O, ²⁰Ne and ²⁴Mg, the next three backbone nuclides, may provide a better view of how to propagate this backbone all the way through the nuclide table, and provide the “tree trunk” for then branching out as develop in sections 13 and 14 here, to “map” the complete “nuclear genome” as a function of up and down quark masses to low parts per 100,000 or parts per million AMU.

Finally, with one more data point on the nuclear “backbone” identified in (14.30), let us make us of (14.5) and (14.30) to deduce the ¹⁴N binding energy. This is the first element we are considering in the 2p^{±1} subshell, in which the magnetic quantum number m≠0. We again start with (14.14) which tells us that:

₇¹⁴B=7·M_{P}+7·M_{N}−₇¹⁴M. (14.32)

We next rearrange (14.5) to separate ₇¹⁴M and use this in (14.32), thus:

₇¹⁴B=5·M_{P}+7·M_{N}+3×(mᵤ+m_{d})/2−₆¹²M+mₑ. (14.33)

Then using (14.14) in the inverted form ₆¹²M=6·M_{P}+6·M_{N}−₆¹²B, we rewrite (14.33) as:

₇¹⁴B=(M_{N}−M_{P})+3×(mᵤ+m_{d})/2+₆¹²B+mₑ. (14.34)

Now, we simply use (14.20), (14.30), (14.24), (14.25) and (14.22) in the above and reduce. Using the quark masses (14.23), (14.24), we finally obtain:

₇¹⁴B=39/2mᵤ+37/2m_{d}−(42mᵤ+42m_{d}+50\sqrt{mᵤm_{d}})/(2π)^{1.5}=0.1123277324u. (14.35)

The empirical binding energy is 0.1123557343 u, which differs by 2.800186×10⁻⁵ u. This is our first nuclide which contains protons and neutrons for which m≠0.

The incremental approach of deducing binding energies by “weaving” from one nuclide to other nearby nuclides through the close consideration of fusion and data decay reactions as first elaborated in section 13, appears to be very much re-validated by the results obtained here as well. Additionally this sort of approach gives us confidence that our overall expressions for binding energies are correct, because they are incrementally constructed in this manner, brick by brick or stitch by stitch so to speak, enhancing the probability that the relationships obtained are meaningful, and are not random fortuitous coincidences. As regards nuclear fusion, this extends the range of fusions reaction that one can catalyze via the “resonant fusion” approach first disclosed in section 9.

### REFERENCES

[1] J. R. Yablon, “Why Baryons Are Yang-Mills Magnetic Monopoles,” Hadronic Journal, Vol. 35, No. 4, 2012, pp. 401-468. http://www.hadronicpress.com/issues/HJ/VOL35/HJ-35-4.pdf
[2] G. t'Hooft, “Magnetic Monopoles in Unified Gauge Theories,” Nuclear Physics B, Vol. 79, 1974, pp. 276-284. doi:10.1016/0550-3213(74)90486-6
[3] A. M. Polyakov, “Particle Spectrum in the Quantum Field Theory,” JETP Letters, Vol. 20, 1974, pp. 194-195.
[4] H. C. Ohanian, “What Is Spin?” American Journal of Physics, Vol. 54, No. 6, 1986, pp. 500-505. doi:10.1119/1.14580
[5] F. Halzen and A. D. Martin, “Quarks and Leptons: An Introductory Course in Modern Particle Physics,” John Wiley & Sons, Hoboken, 1984.
[6] T.-P. Cheng and L.-F. Li, “Gauge Theory of Elementary Particle Physics,” Oxford, 1984.
[7] S. Weinberg, “The Quantum Theory of Fields, Volume II, Modern Applications,” Cambridge, 1996.
[8] G. E. Volovok, “The Universe in a Helium Droplet,” Clarendon Press, Oxford, 2003.
[9] H. Georgi and S. Glashow, “Unity of All Elementary-Particle Forces,” Physical Review Letters, Vol. 32, 1974, p. 438. doi:10.1103/PhysRevLett.32.438
[10] http://www.tau.ac.il/˜elicomay/emc.html
[11] J. Beringer, et al., (Particle Data Group), “PR D86, 010001,” 2012. http://pd.lbl.gov
[12] http://physics.nist.gov/cuu/Constants/index.html
[13] http://en.wikipedia.org/wiki/Table_of_nuclides_(complete)
[14] http://library.thinkquest.org/3471/fusion.html
[15]J. Yablon, “Predicting the Binding Energies of the is Nuclides with High Precision, Based on Baryons which Are Yang-Mills Magnetic Monopoles,”, http://vixra.org/abs/1212.0165 (2013)
[16]J. Yablon, “Predicting the Binding Energies of the is Nuclides with High Precision, Based on Baryons which Are Yang-Mills Magnetic Monopoles,” Journal of Modern Physics, Vol. 4 No. 4A, 2013, pp. 70-93. doi: 10.4236/jmp.2013.44A010, http://www.scirp.org/journal/PaperDownload.aspx?paperID=30817 (2013)
[17]J. Yablon, “Fitting the 2H, 3H, 3He, 4He Binding Energies and the Neutron minus Proton Mass Difference to Parts-Per-Million based Exclusively on the Up and Down Quark Masses,” http://vixra.org/abs/1306.0203 (2013)
[18]J. Yablon, “Fitting the 6Li, 7Li, 7Be and 8Be Binding Energies to High Precision based Exclusively on the Up and Down Quark Masses,” http://vixra.org/abs/1306.0207 (2013)
[19]J. Yablon, “Mapping the 10B, 9Be, 10Be, 11B, 11C, 12C and 14N Binding Energies with High Precision based Exclusively on the Up and Down Quark Masses,” http://vixra.org/abs/1306.0223 (2013)
[20]Y. Koide, A Fermion-Boson Composite Model of quarks and leptons, Phys. Lett. B 120 (1983) 161.
[21]Y. Koide, New view of quark and lepton mass hierarchy, Phys. Rev. D 28 (1983) 252.
[22]J. Beringer et al. (Particle Data Group), PR D86, 010001 (2012) http://pdg.lbl.gov/2012/tables/rpp2012-sum-leptons.pdf
[23]J. Beringer et al. (Particle Data Group), PR D86, 010001 (2012) http://pdg.lbl.gov/2012/tables/rpp2012-sum-quarks.pdf
[24]J. Beringer et al. (Particle Data Group), PR D86, 010001 (2012) http://pdg.lbl.gov/2013/listings/rpp2012-list-n.pdf
[25] http://physics.nist.gov/cuu/Constants/index.html
[26] J. Yablon, “Filling the Mass Gap: Chromodynamic Symmetries, Confinement Properties, and Short-Range Interactions of Classical and Quantum Yang-Mills Gauge Theory,” http://vixra.org/abs/1310.0057 (2013)

### APPENDIX—DETAILED DERIVATION OF THE TRITON NUCLIDE BINDING ENERGY AND THE NEUTRON MINUS PROTON MASS DIFFERENCE

To derive the triton binding energy, we start by considering a hypothetical process to fuse a ₁¹H nucleus (proton) with a ₁²H nucleus (deuteron) to produce a ₁³H nucleus (triton), plus whatever by-products emerge from the fusion. Because the inputs ₁¹H and ₁²H each have a charge of +1, and the output ₁³H also has a charge of +1, a positron will be needed to carry off the additional electric charge, and this will need to be balanced with a neutrino. Of course, there will be some fusion energy released. So in short, the fusion reaction we now wish to study is:

₁¹H+₁²H→₁³H+e⁺+ν+Energy (A1)

The question: how much energy is released?

As we can see, this process includes a β⁺ decay. If we neglect the neutrino mass m_{ν}≅0, and since mₑ_{⁺}=mₑ, we can reformulate (A1) using the nuclide masses in FIG. 2, as the empirical relationship:

Energy=₁¹M+₁²M−₁³M−mₑ=0.004780386215u. (A2)

If we then return to our “toolkit” (4.11), we see that 2mᵤ=0.004776340200u. The difference:

Energy−2mᵤ=0.004780386215u−0.004776340200u=−0.000004046015u (A3)

is four parts per million! So, we now regard Energy≅2mᵤ to be very close relationship to the empirical data for the reaction (A1) with energy release (A2). For the deuteron, alpha and helion, our toolkit matched up to a binding energy. But for the triton, in contrast, our toolkit instead matched up to a fusion-release energy. A new player in this mix, which has not heretofore become directly involved in predicting binding energies, is the electron rest mass in (A2). So, based on (A3), we set Energy=2mᵤ, and then rewrite (A2), using ₁¹M=M(p), as:

₁³M_{Predicted}=M(p)+₁²M−2mᵤ−mₑ. (A4)

Now let's reduce. To translate between FIGS. 2 and 3, we of course used:

_{Z}^{A}B₀=Z·₁¹M+N·₀¹M−_{Z}^{A}M (A5)

which relates observed binding energy B₀ in general, to nuclear mass/weight M in general. So we now use (A5) specifically for ₁³B₀ and combine this with (A4) using ₀¹M=M(n), to write:

₁³B_{0Predicted}=1·₁¹M+2·₀¹M−₁³M=2M(n)−₁²M+2mᵤ+mₑ. (A6)

Then, to take care of the remaining deuteron mass ₁²M in the above, we use (A5) a second time, now for ₁²B₀:

₁²B_{0Predicted}=₁¹M+₀¹M−₁²M=M(p)+M(n)−₁²M. (A7)

We then combine (A7) rewritten in terms of ₁²M, with (A6) to obtain:

₁³B_{0Predicted}=M(n)−M(p)+₁²B_{0Predicted}+2mᵤ+mₑ. (A8)

Now all we need is ₁²B_{0Predicted}. But this is just the deuteron binding energy in (5.4). So a final substitution of ₁²B_{0Prediected}=mᵤ into (A8) yields:

₁³B_{0Predicted}=M(n)−M(p)+3mᵤ+mₑ. (A9)

So now, we do have a prediction for the triton binding energy, and it does include the electron rest mass, but it also includes the difference (7.1) between the free neutron and proton masses. It would be highly desirable for many reasons beyond the present exercise to also express this on a completely theoretical basis.

To do this, we repeat the analysis just conducted, but now, we fuse two ₁¹H nuclei (protons) into a single ₁²H nucleus (deuteron). Analogously to (A1), we write:

₁¹H+₁¹H→₁²H++e⁺+ν+Energy, (A10)

and again ask, how much energy? This fusion, it is noted, is the first step of the process by which the sun and stars produce energy, and is the simplest of all fusions, so is interesting from a variety of viewpoints.

As in (A2), we first reformulate (A10) using the nuclide masses in FIG. 2, as the empirical:

Energy=₁¹M+₁¹M−₁²M−mₑ=2M(p)−₁²M−mₑ=0.000451141003u. (A11)

As a point of reference, this is equivalent to 0.420235 MeV, which will be familiar to anybody to who has studied hydrogen fusion. As before, we pore over the “toolbox” in (4.11), including

$${( 2 π )}^{\frac{3}{2}}$$

divisors, to discover that

$$2 \sqrt{{m}_{μ} {m}_{d}} \text{/} {( 2 π )}^{\frac{3}{2}} = 0.000450424092 u .$$

Once again, we see a very close match, specifically:

$$Energy - 2 \sqrt{{m}_{μ} {m}_{d}} \text{/} {( 2 π )}^{\frac{3}{2}} = 0.000451141003 u - 0.000450424092 u = 0.000000716911 u . \qquad ( A12 )$$

Here, the match is to just over 7 parts in ten million, and it is the closest match yet! Apparently, each of the 2 protons contributes a

$$\sqrt{{m}_{μ} {m}_{d}} \text{/} {( 2 π )}^{\frac{3}{2}}$$

energy dose to effectuate the 2p→₁²H fusion into a deuteron. So we take this too to be a meaningful relationship, and use this to rewrite (A11) as:

$$2 \sqrt{{m}_{μ} {m}_{d}} \text{/} {( 2 π )}^{\frac{3}{2}} = 2 M ( p ) - {}_{1}^{2} M - {m}_{e} . \qquad ( A13 )$$

Now we need to reduce this expression. First, using (4.1), namely ₁²B₀=mᵤ, we write (A7) as:

₁²M=M(p)+M(n)−mᵤ. (A14)

Then we combine (A14) with (A13) and rearrange, and also use (1.11), to obtain the prediction:

$${[ M ( n ) - M ( p ) ]}_{Predicted} = {m}_{u} - {m}_{e} - 2 \sqrt{{m}_{μ} {m}_{d}} \text{/} {( 2 π )}^{\frac{3}{2}} = {m}_{u} - ( 3 {m}_{d} + 2 \sqrt{{m}_{μ} {m}_{d}} - 3 {m}_{u} ) \text{/} {( 2 π )}^{\frac{3}{2}} = 0.001389166099 u . \qquad ( A15 )$$

This is an extremely important relationship relating the observed difference (7.1) between the neutron and proton mass M(n)−M(p)=0.001388449188u solely to the up and down (and optionally electron) rest masses. This is useful in a wide array of circumstances, especially between nuclear isobars (along the diagonal lines of like-A which are shown in the figures here) which by definition convert into one another via beta decay. Comparing (A15) with (7.1), we see that:

[M(n)−M(p)]_{Predicted}−[M(n)−M(p)]_{Observed}=0.001389166099u−0.001388449188u=0.000000716911u (A16)

This is the exact same degree of accuracy, to just over 7 parts in ten million AMU, which we saw in (A12). So this is yet another relationship matched very closely by empirical data.

Because of this, we now take (A15) to be a meaningful relationship, and use this in (A9) to write:

$${{B}_{0} ( {}^{3} H )}_{Predicted} = {}_{1}^{3}{B}{}_{0 Predicted}^{ } = 4 {m}_{u} - 2 \sqrt{{m}_{μ} {m}_{d}} \text{/} {( 2 π )}^{\frac{3}{2}} = 0.009102256308 u . \qquad ( A17 )$$

As a result, we finally have a theoretical expression for the binding energy of the triton, totally in terms of the up and down quark masses. The empirical value ₁³B₀=0.009105585412u is shown in FIG. 3, and doing the comparison, we have:

₁³B_{0Predicted}−₁³B₀=0.009102256308u−0.009105585412u=−0.000003329104u (A18)

We see that this result is accurate to just over three parts in one million AMU!

I claim:

1. A resonant nuclear fusion system for resonantly-catalyzing the release of nuclear fusion energy, comprising:
a nuclear fuel;
a high-frequency gamma radiation source producing gamma radiation proximate at least one of the resonant frequencies corresponding to
$${m}_{u} , {m}_{d} , \sqrt{{m}_{u} {m}_{d}} , ( {m}_{u} + {m}_{d} ) \text{/} 2 , {m}_{u} \text{/} {( 2 π )}^{\frac{3}{2}} , {m}_{d} \text{/} {( 2 π )}^{\frac{3}{2}} , \sqrt{{m}_{u} {m}_{d}} \text{/} {( 2 π )}^{\frac{3}{2}} , ( {m}_{u} + {m}_{d} ) \text{/} 2 {( 2 π )}^{\frac{3}{2}} ,$$
integer harmonic multiples of said resonant frequencies, and sums of said resonant frequencies and said integer harmonic multiples, wherein mᵤ is the current rest mass of the up quark and m_{d} is the current rest mass of the down quark; and
said gamma radiation source configured in relation to said nuclear fuel so as to subject said nuclear fuel to said gamma radiation.

2. The system of claim 1, said nuclear fuel comprising an element selected from the group consisting of: ¹H hydrogen, ²H deuterons, ³He hellions, ⁴He alpha particles, ⁶Li lithium nuclei, ⁷Be beryllium nuclei, ⁸Be beryllium nuclei, ¹²C carbon nuclei, ⁹Be beryllium nuclei, ¹⁰Be beryllium nuclei, ¹⁰B boron nuclei, and ¹¹C carbon nuclei.

3. The system of claim 1:
said nuclear fuel comprising ¹H hydrogen; and
said gamma radiation comprising at least one of the resonant frequencies proximate
$$\sqrt{{m}_{μ} {m}_{d}} \text{/} {( 2 π )}^{\frac{3}{2}} and 2 \sqrt{{m}_{μ} {m}_{d}} \text{/} {( 2 π )}^{\frac{3}{2}} ;$$
wherein:
²H deuterons together with nuclear fusion energy are produced from said ¹H hydrogen, by catalyzing the nuclear fusion reaction ₁¹H+₁¹H→₁²H+e⁺+ν+Energy.

4. The system of claim 1:
said nuclear fuel comprising ¹H hydrogen and ²H deuterons; and
said gamma radiation comprising at least one of the resonant frequencies proximate mᵤ, \sqrt{mᵤm_{d}} and the sum mᵤ+\sqrt{mᵤm_{d}}; wherein:
³He helions together with nuclear fusion energy are produced from said ¹H hydrogen and said ²H deuterons, by catalyzing the nuclear fusion reaction ₁²H+₁¹H→₂³He+Energy.

5. The system of claim 1:
said nuclear fuel comprising ³He helions; and
said gamma radiation comprising at least one of the resonant frequencies proximate
$$2 {m}_{u} , 6 {m}_{d} , 4 \sqrt{{m}_{u} {m}_{d}} , 10 {m}_{d} \text{/} {( 2 π )}^{\frac{3}{2}} , 10 {m}_{u} \text{/} {( 2 π )}^{\frac{3}{2}} , 16 \sqrt{{m}_{u} {m}_{d}} \text{/} {( 2 π )}^{\frac{3}{2}}$$
and the sum
$$2 {m}_{u} + 6 {m}_{d} - 4 \sqrt{{m}_{u} {m}_{d}} - ( 10 {m}_{d} + 10 {m}_{u} + 16 \sqrt{{m}_{u} {m}_{d}} ) \text{/} {( 2 π )}^{\frac{3}{2}} ;$$
wherein:
⁴He alpha particles together with nuclear fusion energy are produced from said ³He helions, by catalyzing the nuclear fusion reaction ₂³He+₂³He→₂⁴He+₁¹H+₁¹H+Energy.

6. The system of claim 1:
said nuclear fuel comprising ¹H hydrogen; and
said gamma radiation comprising at least one of the resonant frequencies proximate
$$6 {m}_{d} , {m}_{u} , 2 {m}_{u} , 4 {m}_{u} , \sqrt{{m}_{u} {m}_{d}} , 2 \sqrt{{m}_{u} {m}_{d}} , 4 \sqrt{{m}_{u} {m}_{d}} , 2 {m}_{d} \text{/} {( 2 π )}^{\frac{3}{2}} , 10 {m}_{d} \text{/} {( 2 π )}^{\frac{3}{2}} , 10 {m}_{u} \text{/} {( 2 π )}^{\frac{3}{2}} , 22 {m}_{u} \text{/} {( 2 π )}^{\frac{3}{2}} , 2 \sqrt{{m}_{u} {m}_{d}} \text{/} {( 2 π )}^{\frac{3}{2}} , 4 \sqrt{{m}_{u} {m}_{d}} \text{/} {( 2 π )}^{\frac{3}{2}} , 12 \sqrt{{m}_{u} {m}_{d}} \text{/} {( 2 π )}^{\frac{3}{2}} , 16 \sqrt{{m}_{u} {m}_{d}} \text{/} {( 2 π )}^{\frac{3}{2}}$$
and the sum:
$$( 2 {m}_{u} + 6 {m}_{d} - 4 \sqrt{{m}_{u} {m}_{d}} - \frac{10 {m}_{d} + 10 {m}_{u} + 16 \sqrt{{m}_{u} {m}_{d}}}{{( 2 π )}^{\frac{3}{2}}} ) + 2 ( {m}_{u} + \sqrt{{m}_{u} {m}_{d}} ) + 2 ( 2 \frac{\sqrt{{m}_{μ} {m}_{d}}}{{( 2 π )}^{\frac{3}{2}}} ) + 4 ( {m}_{e} ) = 4 {m}_{u} + 6 {m}_{d} + 4 {m}_{e} - 2 \sqrt{{m}_{u} {m}_{d}} - ( 10 {m}_{d} + 10 {m}_{u} + 12 \sqrt{{m}_{u} {m}_{d}} ) \text{/} {( 2 π )}^{\frac{3}{2}} = 4 {m}_{u} + 6 {m}_{d} - 2 \sqrt{{m}_{u} {m}_{d}} + ( 2 {m}_{d} - 22 {m}_{u} - 12 \sqrt{{m}_{u} {m}_{d}} ) \text{/} {( 2 π )}^{\frac{3}{2}}$$
and addends thereof, wherein mₑ is the rest mass of the electron; wherein:
⁴He alpha particles together with nuclear fusion energy are produced from said ¹H hydrogen, by catalyzing the solar nuclear fusion reaction 4·₁¹H+2e⁻→₂⁴He+γ(12.79 MeV)+2γ(5.52 MeV)+2γ(0.42 MeV)+4γ(e)+2ν.

7. The system of claim 1:
said gamma radiation comprising at least one of the resonant frequencies proximate \sqrt{mᵤm_{d}}/(2π)^{1.5}, 2\sqrt{mᵤm_{d}}/(2π)^{1.5}, 4\sqrt{mᵤm_{d}}/(2π)^{1.5}, 9\sqrt{mᵤm_{d}}/(2π)^{1.5}, 15\sqrt{mᵤm_{d}}/(2π)^{1.5}, m_{d}/(2π)^{1.5}, 18m_{d}/(2π)^{1.5}, mᵤ/(2π)^{1.5}, 6mᵤ/(2π)^{1.5}, 8mᵤ/(2π)^{1.5}, \sqrt{m_{μ}m_{d}}, 2\sqrt{m_{μ}m_{d}}, (mᵤ+m_{d})/2, 3·(mᵤ+m_{d})/2, and the sums (mᵤ+2\sqrt{mᵤm_{d}})/(2π)^{1.5}, \sqrt{mᵤm_{d}}+15\sqrt{mᵤm_{d}}/(2π)^{1.5} and 8mᵤ/(2π)^{1.5}+4\sqrt{mᵤm_{d}}/(2π)^{1.5}.

8. A method for resonantly-catalyzing the release of nuclear fusion energy, comprising subjecting a nuclear fuel to high-frequency gamma radiation proximate at least one of the resonant frequencies corresponding to
$${m}_{u} , {m}_{d} , \sqrt{{m}_{u} {m}_{d}} , ( {m}_{u} + {m}_{d} ) \text{/} 2 , {m}_{u} \text{/} {( 2 π )}^{\frac{3}{2}} , {m}_{d} \text{/} {( 2 π )}^{\frac{3}{2}} , \sqrt{{m}_{u} {m}_{d}} \text{/} {( 2 π )}^{\frac{3}{2}} , ( {m}_{u} + {m}_{d} ) \text{/} 2 {( 2 π )}^{\frac{3}{2}} ,$$
integer harmonic multiples of said resonant frequencies, and sums of said resonant frequencies and said integer harmonic multiples, wherein mᵤ is the current rest mass of the up quark and m_{d} is the current rest mass of the down quark.

9. The method of claim 8, said nuclear fuel comprising an element selected from the group consisting of: ¹H hydrogen, ²H deuterons, ³He hellions, ⁴He alpha particles, ⁶Li lithium nuclei, ⁷Be beryllium nuclei, ⁸Be beryllium nuclei, ¹²C carbon nuclei, ⁹Be beryllium nuclei, ¹⁰Be beryllium nuclei, ¹⁰B boron nuclei, and ¹¹C carbon nuclei.

10. The method of claim 8, further comprising producing ²H deuterons together with nuclear fusion energy from ¹H hydrogen, by subjecting said nuclear fuel comprising said ¹H hydrogen to said gamma radiation comprising at least one of the resonant frequencies proximate
$$\sqrt{{m}_{μ} {m}_{d}} \text{/} {( 2 π )}^{\frac{3}{2}} and 2 \sqrt{{m}_{μ} {m}_{d}} \text{/} {( 2 π )}^{\frac{3}{2}}$$
to catalyze the nuclear fusion reaction ₁¹H+₁¹H→₁²H+e⁺+ν+Energy.

11. The method of claim 8, further comprising producing ³He helions together with nuclear fusion energy from ¹H hydrogen and ²H deuterons, by subjecting said nuclear fuel comprising said ¹H hydrogen and said ²H deuterons to said gamma radiation comprising at least one of the resonant frequencies proximate mᵤ, \sqrt{mᵤm_{d}} and the sum mᵤ+\sqrt{mᵤm_{d}} to catalyze the nuclear fusion reaction ₁²H+₁¹H→₂³He+Energy.

12. The method of claim 8, further comprising producing ⁴He alpha particles together with nuclear fusion energy from ³He helions, by subjecting said nuclear fuel comprising said ³He helions to said gamma radiation comprising at least one of the resonant frequencies proximate
$$2 {m}_{u} , 6 {m}_{d} , 4 \sqrt{{m}_{u} {m}_{d}} , 10 {m}_{d} \text{/} {( 2 π )}^{\frac{3}{2}} , 10 {m}_{u} \text{/} {( 2 π )}^{\frac{3}{2}} , 16 \sqrt{{m}_{u} {m}_{d}} \text{/} {( 2 π )}^{\frac{3}{2}}$$
and the sum
$$2 {m}_{u} + 6 {m}_{d} - 4 \sqrt{{m}_{u} {m}_{d}} - ( 10 {m}_{d} + 10 {m}_{u} + 16 \sqrt{{m}_{u} {m}_{d}} ) \text{/} {( 2 π )}^{\frac{3}{2}}$$
to catalyze the nuclear fusion reaction ₂³He+₂³He→₂⁴He+₁¹H+₁¹H+Energy.

13. The method of claim 8, further comprising producing ⁴He alpha particles together with nuclear fusion energy from ¹H hydrogen, by subjecting said nuclear fuel comprising said ¹H hydrogen to said gamma radiation comprising at least one of the resonant frequencies proximate
$$6 {m}_{d} , {m}_{u} , 2 {m}_{u} , 4 {m}_{u} , \sqrt{{m}_{u} {m}_{d}} , 2 \sqrt{{m}_{u} {m}_{d}} , 4 \sqrt{{m}_{u} {m}_{d}} , 2 {m}_{d} \text{/} {( 2 π )}^{\frac{3}{2}} , 10 {m}_{d} \text{/} {( 2 π )}^{\frac{3}{2}} , 10 {m}_{u} \text{/} {( 2 π )}^{\frac{3}{2}} , 22 {m}_{u} \text{/} {( 2 π )}^{\frac{3}{2}} , 2 \sqrt{{m}_{u} {m}_{d}} \text{/} {( 2 π )}^{\frac{3}{2}} , 4 \sqrt{{m}_{u} {m}_{d}} \text{/} {( 2 π )}^{\frac{3}{2}} , 12 \sqrt{{m}_{u} {m}_{d}} \text{/} {( 2 π )}^{\frac{3}{2}} , 16 \sqrt{{m}_{u} {m}_{d}} \text{/} {( 2 π )}^{\frac{3}{2}}$$
and the sum:
$$( 2 {m}_{u} + 6 {m}_{d} - 4 \sqrt{{m}_{u} {m}_{d}} - \frac{10 {m}_{d} + 10 {m}_{u} + 16 \sqrt{{m}_{u} {m}_{d}}}{{( 2 π )}^{\frac{3}{2}}} ) + 2 ( {m}_{u} + \sqrt{{m}_{u} {m}_{d}} ) + 2 ( 2 \frac{\sqrt{{m}_{μ} {m}_{d}}}{{( 2 π )}^{\frac{3}{2}}} ) + 4 ( {m}_{e} ) = 4 {m}_{u} + 6 {m}_{d} + 4 {m}_{e} - 2 \sqrt{{m}_{u} {m}_{d}} - ( 10 {m}_{d} + 10 {m}_{u} + 12 \sqrt{{m}_{u} {m}_{d}} ) \text{/} {( 2 π )}^{\frac{3}{2}} = 4 {m}_{u} + 6 {m}_{d} - 2 \sqrt{{m}_{u} {m}_{d}} + ( 2 {m}_{d} - 22 {m}_{u} - 12 \sqrt{{m}_{u} {m}_{d}} ) \text{/} {( 2 π )}^{\frac{3}{2}}$$
and addends thereof, wherein mₑ is the rest mass of the electron, to catalyze the solar nuclear fusion reaction 4·₁¹H+2e⁻→₂⁴He+γ(12.79 MeV)+2γ(5.52 MeV)+2γ(0.42 MeV)+4γ(e)+2ν.

14. The method of claim 8, said gamma radiation comprising at least one of the resonant frequencies proximate \sqrt{mᵤm_{d}}/(2π)^{1.5}, 2\sqrt{mᵤm_{d}}/(2π)^{1.5}, 4\sqrt{mᵤm_{d}}/(2π)^{1.5}, 9\sqrt{mᵤm_{d}}/(2π)^{1.5}, 15\sqrt{mᵤm_{d}}/(2π)^{1.5}, m_{d}/(2π)^{1.5}, 18m_{d}/(2π)^{1.5}, mᵤ/(2π)^{1.5}, 6mᵤ/(2π)^{1.5}, 8mᵤ/(2π)^{1.5}, \sqrt{mᵤm_{d}}, 2\sqrt{m_{μ}m_{d}}, (mᵤ+m_{d})/2, 3·(mᵤ+m_{d})/2, and the sums (mᵤ+2\sqrt{mᵤm_{d}})/(2π)^{1.5}, \sqrt{mᵤm_{d}}+15\sqrt{mᵤm_{d}}/(2π)^{1.5} and 8mᵤ/(2π)^{1.5}+4\sqrt{mᵤm_{d}}/(2π)^{1.5}.

15. A high-frequency gamma radiation source apparatus for use in resonantly-catalyzing the release of nuclear fusion energy, said source preconfigured for producing gamma radiation proximate at least one of the resonant frequencies corresponding to
$$\sqrt{{m}_{u} {m}_{d}} \text{/} {( 2 π )}^{\frac{3}{2}} , 2 \sqrt{{m}_{u} {m}_{d}} \text{/} {( 2 π )}^{1.5} , 4 \sqrt{{m}_{u} {m}_{d}} \text{/} {( 2 π )}^{1.5} , 9 \sqrt{{m}_{u} {m}_{d}} \text{/} {( 2 π )}^{1.5} , 12 \sqrt{{m}_{u} {m}_{d}} \text{/} {( 2 π )}^{\frac{3}{2}} , 15 \sqrt{{m}_{u} {m}_{d}} \text{/} {( 2 π )}^{1.5} , 16 \sqrt{{m}_{u} {m}_{d}} \text{/} {( 2 π )}^{\frac{3}{2}} , 6 {m}_{u} \text{/} {( 2 π )}^{1.5} , 8 {m}_{u} \text{/} {( 2 π )}^{1.5} , 10 {m}_{u} \text{/} {( 2 π )}^{\frac{3}{2}} , 22 {m}_{u} \text{/} {( 2 π )}^{\frac{3}{2}} , {m}_{d} \text{/} {( 2 π )}^{\frac{3}{2}} , 2 {m}_{d} \text{/} {( 2 π )}^{\frac{3}{2}} , 10 {m}_{d} \text{/} {( 2 π )}^{\frac{3}{2}} , 18 {m}_{d} \text{/} {( 2 π )}^{1.5} , {m}_{u} , 2 {m}_{u} , 4 {m}_{u} , {m}_{d} , 6 {m}_{d} , \sqrt{{m}_{u} {m}_{d}} , 2 \sqrt{{m}_{u} {m}_{d}} , 4 \sqrt{{m}_{u} {m}_{d}} , ( {m}_{u} + {m}_{d} ) \text{/} 2 , ( {m}_{u} + {m}_{d} ) \text{/} {( 2 π )}^{\frac{3}{2}} , ( {m}_{u} + 2 \sqrt{{m}_{u} {m}_{d}} ) \text{/} {( 2 π )}^{1.5} , ( {m}_{u} + {m}_{d} ) \text{/} 2 , 3 \cdot ( {m}_{u} + {m}_{d} ) \text{/} 2 ,$$
and the sums
$$\sqrt{{m}_{u} {m}_{d}} + 15 \sqrt{{m}_{u} {m}_{d}} \text{/} {( 2 π )}^{1.5} , 8 {m}_{u} \text{/} {( 2 π )}^{1.5} + 4 \sqrt{{m}_{u} {m}_{d}} \text{/} {( 2 π )}^{1.5} , 2 {m}_{u} + 6 {m}_{d} - 4 \sqrt{{m}_{u} {m}_{d}} - ( 10 {m}_{d} + 10 {m}_{u} + 16 \sqrt{{m}_{u} {m}_{d}} ) \text{/} {( 2 π )}^{\frac{3}{2}} , ( 2 {m}_{u} + 6 {m}_{d} - 4 \sqrt{{m}_{u} {m}_{d}} - \frac{10 {m}_{d} + 10 {m}_{u} + 16 \sqrt{{m}_{u} {m}_{d}}}{{( 2 π )}^{\frac{3}{2}}} ) + 2 ( {m}_{u} + \sqrt{{m}_{u} {m}_{d}} ) + 2 ( 2 \frac{\sqrt{{m}_{μ} {m}_{d}}}{{( 2 π )}^{\frac{3}{2}}} ) + 4 ( {m}_{e} ) = 4 {m}_{u} + 6 {m}_{d} + 4 {m}_{e} - 2 \sqrt{{m}_{u} {m}_{d}} - ( 10 {m}_{d} + 10 {m}_{u} + 12 \sqrt{{m}_{u} {m}_{d}} ) \text{/} {( 2 π )}^{\frac{3}{2}} = 4 {m}_{u} + 6 {m}_{d} - 2 \sqrt{{m}_{u} {m}_{d}} + ( 2 {m}_{d} - 22 {m}_{u} - 12 \sqrt{{m}_{u} {m}_{d}} ) \text{/} {( 2 π )}^{\frac{3}{2}}$$
and addends of said resonant frequencies, integer harmonic multiples of said resonant frequencies, and sums of said resonant frequencies and said integer harmonic multiples, wherein mᵤ is the current rest mass of the up quark and m_{d} is the current rest mass of the down quark.
